(19) United States
(12) Patent Application Publication
(10) Pub. No.: US 2025/0098705 A1
(43) Pub. Date: Mar. 27, 2025

(54) A PROCESS FOR PREPARING A FOOD PRODUCT AND THE FOOD PRODUCT

(71) Applicant: KATHOLIEKE UNIVERSITEIT LEUVEN, Leuven (BE)

(72) Inventors: Ivo ROELANTS, Leuven (BE); Wouter MERCKX, Lovenjoel (BE); Mathijs SOOGEN, Lovenjoel (BE)

(21) Appl. No.: 18/729,396

(22) PCT Filed: Jan. 9, 2023
(86) PCT No.: PCT/EP2023/050327

§ 371 Date: Jul. 16, 2024

(30) Foreign Application Priority Data
Jan. 17, 2022 (EP) 22151840.0

(51) Int. Cl. A23J 3/22; A23J 3/04; A23J 3/18; A23L 29/262

(52) U.S. Cl. CPC A23J 3/227; A23J 3/04; A23J 3/18; A23L 29/262

(57) ABSTRACT

A dry food composition of animal origin, non-animal origin or extended meat product origin for reconstitution in a flesh like textured food by instantly rehydrating by cold aqueous liquid, for cold aqueous liquid at <5° C., or ice particles mixing by hand force or a kitchen appliance and cooking into a ready-to-eat flesh like food, is a need in the art fulfilled in that present invention concerns a dry food composition that comprises a dry powder of methylcellulose encapsulated in a protein-fat based encapsulate.

### BACKGROUND OF THE INVENTION

### 1. Field of the Invention

In general, the present invention relates to the field of food compositions and to the field of food additives and to the field of foodstuff used in preparing food compositions and alternative food products useful for human consumption.

Particularly the invention relates to a dry food base for mixed moistening into a flesh like food, to a method for producing said fry food base and to the use of said dry base, for instance in making a flesh like food. The flesh like food composition is formed from mixing the dry mix composition of the invention with cold water, for instance cold water (>0° C.)<5° C.), or ice particles into flesh like food. This way the invention enables formation from a dry instant premix of a non-animal derived protein lipid mass with the mouth feel of fish or meat or it enables formation from a dry instant premix of an hybrid non-animal derived and animal derived protein lipid mass with the mouth feel of fish or meat.

More particularly the invention relates to a dry instant food base for reconstitution in a flesh like food, to a method for producing said dry instant food base and to the use of said dry instant base, for instance in instantly making a flesh like food. The flesh like food composition is formed from mixing the instant dry mix composition of the invention with cold water, for instance cold water (>0)° C.<5° C.), or ice particles into flesh like food. This way the invention enables the from an instant dry food composition premix formation of a non-animal derived protein lipid mass with the mouth feel of fish or meat. This way the invention also enables the from an instant dry food composition premix formation of an hybrid non-animal and animal derived protein lipid mass with the mouth feel of fish or meat.

The present invention provides also a ready-to-cook flesh like food of animal origin, non-animal origin or extended meat product origin or extended seafood product origin (for instance extended fish product origin), this food comprising the mixing product of a preformed particulate dry mix composition or preformed particulate with powder dry mix composition. Such dry mix can comprise a dry form of a freeze thaw curd solid and/or textured protein of plant or animal or extended meat origin. Or the present invention provides a ready-to-cook flesh like food of animal origin, non-animal origin or extended meat product origin, this food being the mixing product of a preformed particulate dry mix composition or preformed particulate with powder dry mix composition with cold water, for instance cold water (>0° C.)<5° C.). Such dry mix can comprise a dry form of a freeze thaw curd solid and/or textured protein of plant or animal or extended meat origin.

It furthermore provides the process of preparing such flesh like food from a dry premix.

Moreover, the present invention provides the use of such flesh like food for cooking of a ready-to-eat food.

Moreover, the present invention provides a ready-to-eat flesh like food of non-animal origin that is a cooked flesh like food comprising the rehydrating by cold water (<5° C., for instance >0° C.<5° C.) or ice particles product of the particulate dry mix composition or the particulate and powder dry mix composition of present invention into a flesh like textured food.

The dry mix composition of present invention for providing a flesh like textured food via reconstitution in a cold aqueous liquid, for cold aqueous liquid at <5° C., or in ice particles can be a packaged dry mix composition or a dry mix composition in a hopper unit of a delivery machine, for instance a vending machine. Such hopper unit usually is with auger transporting mechanism operatively connected at one end to an auger drive mechanism and at the other end via an output or output funnel to a mixing unit

The dry mix composition of present invention for providing a flesh like textured food via reconstitution in a cold aqueous liquid, for cold aqueous liquid at <5° C., or in ice particles can be a packaged dry mix composition or a dry mix composition can be stored in an hopper unit with auger transporting mechanism operatively connected at one end to an auger drive mechanism and at the other end via an output or output funnel to a mixing unit.

The present invention also provides such dry mix composition for reconstitution into a flesh like textured food by mixing with cold aqueous liquid, for cold aqueous liquid at <5° C., or ice particles, which dry mix composition is a packaged dry mix composition stored in a wet store sealable container of the group consisting of a wet store bag, a store brick (for instance a paperboard brick with at least one inside polyethylene and aluminium layer), a plastic closed lid bucket, a glass jar and a tin, so that a portion of the dry mix or all is taken from this packaging or storage compliance and consequently can be reconstituted into a flesh like food product by mixing with cold water (<5° C., for instance >0° C.<5° C.) or ice particles.

Another optional aspect of present invention is embodies in that a dry food mix is provided with freeze thaw curd solid or with freeze thaw alginate cured curd solid. In a specific optional aspect of present invention such dry food mix does not comprise texturized vegetable protein (TVP) or that it is substantially free of, essentially free of, or free of any of TVP.

Moreover, the present invention provides the use of such flesh like food for the preparation of a ready-to-cat food. In another aspect, the present invention provides a cooked a ready-to-eat flesh like food of non-animal origin comprising one of the mixing product mentioned above. In another aspect, the present invention provides a cooked a ready-to-cat flesh like food of non-animal and animal origin comprising one of the mixing product mentioned above.

### 2. Background of the Art

A ready-to-cat food of non-animal foodstuff origin of with a reduced content of non-animal foodstuff origin but with a flesh like texture is becoming very important food in the food industry, as it allows foodstuff of non-animal origin for replacing meat and fish derived foodstuff while providing consumers a meat or fish like mouthfeel experience.

The binding properties of methylcellulose are the result of the cold aqueous hydration and swelling of methylcellulose upon heating, which if critical process steps are followed causes the viscosity of the methylcellulose suspension to increase.

However, foods such as patties that comprise methylcellulose mixed with food ingredients such as TPV, food oil and water do not always have sufficient stable cohesiveness in a cooking process and they are thus vulnerable to des-integration and losing portions during baking. In general one tries to overcome these problem by a process of steps of subjecting interim and/or final preparations to substantial time episodes of cold incubation (resting under cooling) and by adding other gelling substances (such as for instance kappa-carrageenan and/or pre-gelled starches). These problems are accentuated and can easily been experienced in a baking process when no other gelling agents such as starch or pre-gelled starch was add in the patty or when the patty is directly cooked without cold incubation episodes. The patty structure will eventually be maintained. However, these patties are not flesh like and lack the mouthfeel, bite, chewiness (elastic resistance during chewing) juiciness and/or firmness of flesh like texture for instance of fish or meat.

We experienced that mixing methylcellulose powder in dry food bases of total non-animal origin or hybrid animal and non-animal origin for instant for re-moistening and cooking did not provide a satisfactory flesh like food in terms of mouth feel and by texture analysing by a texture analyser (e.g. Lloyd Instruments/Ametek LS1 Texture Analyser & Nexygen+4.1. software package).

By dry encapsulated methylcellulose (for instance in the form of a dry powder) mixed in a dry foodstuff mix or by dry powder of dry capsule particles or capsule granules comprising or encapsulating a composition containing methylcellulose and this spread well in a dry foodstuff mix, we overcame these disadvantages. Dry matters (for instance a powder) of capsule particle comprising an oil-protein composition containing methylcellulose, dry powders of capsule particle comprising a fat-protein composition containing methylcellulose, or dry powders of capsule particle comprising an butter-protein composition containing methylcellulose, when dispersed in a dry foodstuff mix form an instant mix that after rehydrating by cold water (<4° C.) or by snow or by ice particles is reconstituted instantly in a food that is cooked into a food form with a flesh like mouthfeel.

The preformed dry encapsulated methylcellulose, for instance in particulate and powdered form, allowed processing of the foodstuff into a flesh like food without cool incubation of the mixed foodstuff. This ready-to-cook flesh like food directly obtained from the mixing process can instantly be cooked into a ready-to-eat flesh like food if it comprises a substantial amount of TVP, for instance a an 8% to 32% in dry weight to the wet ready-to-cook flesh like food. This ready-to-cook flesh like food directly obtained from the mixing process can instantly be cooked into a ready-to-cat flesh like food if it comprises a substantial amount of dry form of a freeze thaw curd solid, for instance a an 8% to 32% in dry weight to the wet ready-to-cook flesh like food. This even does not need the benefit from addition of gelling starch, such as for instance potato starch or cornstarch, or from pre-gelled starches or kappa-carrageenan. The consumer safety of carrageenans (CGN) remains controversial (David et al., Food. Funct., 9 (2018). pp. 1344-1352. David et al Food. Funct., 10 (2019). pp. 1763-1766; Jiang et al., Carbohydr. Polym., 257 (2021), p. 117642). Of particular concern are the physicochemical properties of commercial CGNs, acceptable levels of human exposure to CGNs, and the potentially adverse effects of CGNs on gut microbiome leading to dysbiosis and inflammation (David et al Food. Funct., 10 (2019). pp. 1763-1766). Surprising, we could replace the TVP by freeze thaw curd solid and/or freeze thaw alginate cured curd solid without jeopardizing the springiness, tenderness, chewiness and juiciness of a flesh like texture.

We also combined dry methylcellulose with freeze dried (Freeze dryer HarvestRight, U.S.A.) and grinded (Thermomix) meat (Angus beef, Iberico pork loin steak. Belgian white blue beef, duck breast fillet and chicken breast fillet) and with freeze dried and grinded fish (salmon (Salmo salar) fillet, steelhead salmon (Oncorhynchus mykiss) fillet). The preformed dry encapsulated methylcellulose mixed into the grinded meat or fish after instant remoistening and instant cooking provided the flesh like texture mouthfeel and instead a same amount of methylcellulose in dry powder mixed into the grinded meat or fish after instant remoistening and instant cooking provided an inferior texture mouthfeel.

The advantageous properties of the instant dry food base comprising the encapsulated methylcellulose base has been observed for high baking stability and good cohesion during cooking during cooking. The mouthfeel in terms of springiness, tenderness, chewiness and juiciness by a panel of six persons and thereafter it was confirmed by a Texture Profile Analysis (TPA).

### SUMMARY OF INVENTION

The object of the present invention is to provide a ready-to-cat food with flesh like texture and of non-animal origin or a ready-to-cat cook food with flesh like texture and of non-animal origin, these food forms comprising freeze thaw curd solid, a preformed encapsulated methylcellulose powder and eventually additional foodstuff such food fat additionally to the fat in the curd. Such additional foodstuff can also concern food protein concentrate, food protein isolate, herbs, spices or aromas, preferably add to the mixture in fine powder form, dry or as water dispersion.

The object of the present invention is also to provide a ready-to-cat food with flesh like texture and of non-animal origin or a ready-to-cat cook food with flesh like texture and of non-animal origin, these food forms comprising textured vegetable protein (TVP), a preformed encapsulated methylcellulose powder and eventually additional foodstuff such food fat additionally to the fat in the curd. Such additional foodstuff can also concern food protein concentrate, food protein isolate, herbs, spices or aromas, preferably add to the mixture in fine powder form, dry or as water dispersion.

The object of the present invention is also to provide a ready-to-cat food with flesh like texture and of non-animal origin or a ready-to-cat cook food with flesh like texture and of non-animal origin, these food forms comprising dried and grinded fish or meat, preferably muscle fish or muscle meat, a preformed encapsulated methylcellulose powder and eventually additional foodstuff such food fat additionally to the fat in the curd. Such additional foodstuff can also concern food protein concentrate, food protein isolate, herbs, spices or aromas, preferably add to the mixture in fine powder form, dry or as water dispersion.

The object of present invention is also providing a process of manufacture such ready-to-cat food with flesh like texture which concerns hand force or machine force mixing of the preformed encapsulated methylcellulose powder with the freeze thaw curd solid. The curd can be the source of food fat and protein. However addition protein can be add as a protein isolate in powder form or as protein concentrate in powder form (dry or in water dispersed) and additional food fat or foot oil can be add. The object is present invention is also providing a process of manufacturing such ready-to-cook food with flesh like texture which process of manufacturing concerns subjecting the ready-to-cook food to heating or cooking.

A further object is providing a method for producing such food form with a raw food material that comprises freeze thaw curd solid and encapsulated methylcellulose powder, whereby the food has a flesh like texture and after cooking or has a mouthfeel, bite, chewiness (elastic resistance during chewing) juiciness and/or firmness of flesh like texture for instance of cooked fish or cooked meat.

In an advantageous embodiment this ready-to-cat cook or a ready-to-cat food comprises freeze thaw alginate cured curd solid. This alginate curing of freeze thaw a curd solid masks an off tone originating from non-animal foodstuff in the curd, such as soy protein, pea protein or wheat protein and it improves the juiciness.

We have now found that using an encapsulated methylcellulose powder or an encapsulated methylcellulose dry particulate base, a ready-to-cook food with a flesh like texture can be produced instantly by mixing the a dry food mix comprising such powder or dry particulate base with dry TVP (when this TVP has a good water absorption capacity), and/or with dried alginate cured respiratory produce and/or with freeze thaw alginate cured curd solid and/or with freeze curd solid. It has advantageous properties of in terms of springiness, tenderness, chewiness and juiciness and a high baking stability and good cohesion during cooking. Surprisingly, we could replace the TVP by freeze thaw curd solid and/or freeze thaw alginate cured curd solid without jeopardizing the springiness, tenderness, chewiness and juiciness of a flesh like texture.

We have now found that using an encapsulated methylcellulose powder or an encapsulated methylcellulose dry particulate base, a ready-to-cook food with a flesh like texture can be produced instantly by mixing the a dry food mix comprising such powder or dry particulate base with grinded dried meat or fish. It has advantageous properties of in terms of springiness, tenderness, chewiness and juiciness and a high baking stability and good cohesion during cooking.

A flesh like textured food can be produced very successfully with a portion of a dry food mix comprising capsule particles (preferably micro- and/or nanoparticles) comprising a composition containing methylcellulose which is taken from a store container and is hand force mixed or machine mixed (even with a kitchen robot) with a portion cold water under 5° C., or with a portion of ice particles or a portion of snow or a mixture thereof.

Furthermore, the dry food mixture comprising capsule particles (preferably micro- and/or nanoparticles) comprising a composition containing methylcellulose can further be stored into a container of the group consisting of a plastic lid sealable bucket, a tin, a glass jar and a store bag.

Some embodiments or objects of the invention are set forth in claim format directly below:
1.A dry food mix for reconstitution into a flesh like textured food characterised in that the dry food mix comprises capsule particles or capsule granules comprising or encapsulating a composition containing methylcellulose or encapsulating a composition containing methylcellulose.
2. The dry food mix according to item 1, whereby the composition of the capsule particles containing or encapsulating the methylcellulose is a composition that comprises, essentially consists of or consists of a fat and protein.
3. The dry food mix according to any one of the items 1 to 2, whereby the methylcellulose in the capsule particles is of 10 to 30 weight percent.
4. The dry food mix according to any one of the items 1 to 2, whereby the fat or a mixture of fats in the capsule particles is of 50 to 75 weight percent.
5. The dry food mix according to any one of the items 1 to 2, whereby the protein or a mixture of proteins in the capsule particles is of 10-33 weight percent.
6. The dry food mix according to any one of the items 1 to 2, comprising a matrix and methylcellulose, wherein the matrix comprises, consist essentially of or consists of fat and protein, wherein the protein:fat by weight ratio is 1:2-10.
7. The dry food mix according to any one of the items 1 to 2, comprising a matrix and methylcellulose, wherein the matrix comprises or consisting of fat and protein, wherein the protein:fat by weight ratio is 1:2-10 and whereby methylcellulose is encapsulated in the matrix material.
8. The dry food mix according to any one of the items 1 to 7, comprising from 10% wt, to 30% wt. of capsule particles.
9. The dry food mix according to any one of the items 1 to 8, whereby capsule particles further comprise an acid.
10. The dry food mix according to any one of the items 1 to 9, whereby capsule particles comprise an antioxidant.
11. The dry food mix according to any one of the items 1 to 10, whereby capsule particles comprise an antibacterial.
12. The dry food mix according to any one of the items 1 to 11, whereby capsule particles comprise an herbal extract.
13. The dry food mix according to any one of the items 1 to 12, whereby capsule particles comprise a spice extract.
14. The dry food mix according to any one of the items 1 to 13, whereby capsule particles comprise a fruit extract.
15. The dry food mix according to any one of the items 1 to 14, whereby the fat, oil or butter comprises an agent selected from the list consisting of phospholipids, lecithin, monoglyceride, amphiphilic peptides, sorbitan monostearate, mono-, di- and/or triacylglycerols, fatty acids, fatty alcohol, wax, phytosterol, and/or combinations thereof.
16. The dry food mix according to any one of the items 1 to 15, whereby the capsule particles or capsule granules comprising or encapsulating a composition containing methylcellulose are in the form of a dry powder.
17. The dry food mix according to any one of the items 1 to 16, whereby the capsule particles or capsule granules comprising or encapsulating a composition containing methylcellulose are at least in part microparticles.
18. The dry food mix according to any one of the items 1 to 17, whereby the capsule particles or capsule granules comprising or encapsulating a composition containing methylcellulose are at least in part nanoparticles.
19. The dry food mix according to any one of the items 1 to 18, whereby the dry food mix is at least in part in powder mass form.
20. The dry food mix according to any one of the items 1 to 19, whereby the dry food mix comprises a powder mass including and also larger then powder particle size food or foodstuff particles.
21. The dry food mix according to any one of the items 1 to 20, whereby the dry food mix comprises particles in a shape of the group consisting chunks, flake, strip, granule and fibre.
22. The dry food mix according to any one of the items 1 to 21, comprising dry freeze thaw alginate cured curd solid.
23. The dry food mix according to any one of the items 1 to 22, comprising an alginate cured respiratory produce.
24. The dry food mix according to any one of the items 1 to 23, comprising TVP.
25. The dry food mix according to any one of the items 1 to 23, that is essentially free of textured vegetable protein (TVP).
26. The dry food mix according to any one of the items 1 to 23, that is substantially free of textured vegetable protein or (TVP).
27. The dry food mix according to any one of the items 1 to 26, characterised that the dry food mix is a premix for flesh like textured food.
28. The dry food mix according to any one of the items 1 to 27, characterised that the dry food mix is a premix for meat-structured protein product.
29. The dry food mix according to any one of the items 1 to 28, characterised that the dry food mix comprises dried grinded meat or dried grinded fish.
30. The dry food mix according to any one of the items 1 to 28, characterised that the dry food mix is a premix consisting essentially of extended meat foodstuff.
31. The dry food mix according to any one of the items 1 to 28, characterised that the dry food mix is a premix consisting essentially of extended fish foodstuff.
32. The dry food mix according to any one of the items 1 to 28, characterised that the dry food mix is based on non-animal foodstuff.
33. A cooked food with a flesh like textured food made by using the dry food mix to any one of items 1 to 32.
34. A cooked food with a flesh like textured food that is the rehydrating, mixing and cooking product of the dry food mix according to any one of the items 1 to 32.
35. The dry food mix according to any one of the items 1 to 34, characterised that the dry food mix is a packaged dry food mix, packaged in a container.
36. The dry food mix according to any one of the items 1 to 34, characterised that the dry food mix is stored in a hopper unit with auger transporting mechanism.
37. The dry food mix according to any one of the items 1 to 34, characterised that the dry food mix is stored in a hopper unit with auger transporting mechanism operatively connected at one end to an auger drive mechanism and at the other end via an output or output funnel to a mixing unit.
38. The dry food mix according to any one of the items 1 to 37, characterised in that it is an instant food mix
39. The preparation of a ready-to-cook food product from a dry food mix according to any one of the items 1 to 38, by mixing of a dry food mix with a portion of cold water at a temperature <5° C., with a portion of snow ice or a portion of small ice particles, for instance particles with as largest diameter <2.5 mm.
40. The preparation of a ready-to-cook food product from a dry food mix according to any one of the items 1 to 38, by hand force mixing of a dry food mix with a portion of cold water at a temperature <5° C., with a portion of snow ice or a portion of small ice particles, for instance particles with as largest diameter <2.5 mm.
41. The preparation of a ready-to-eat food product from a dry food mix according to any one of the items 1 to 38, by 1) mixing of a dry food mix with a portion of cold water at a temperature <5° C., with a portion of snow ice or a portion of small ice particles, for instance particles with as largest diameter <2.5 mm, 2) shaping the moist food form or portion thereof and 3) cooking it in a ready-to-eat flesh like textured food.
42. The preparation of a ready-to-eat food product from a dry food mix according to any one of the items 1 to 38, by 1) mixing of a dry food mix with a portion of cold water at a temperature <5° C., with a portion of snow ice or a portion of small ice particles, for instance particles with as largest diameter <2.5 mm, 2) shaping the moist food form or portion thereof and 3) instantly cooking it in a ready-to-eat flesh like textured food.
43. The preparation of a ready-to-eat food product from a dry food mix according to any one of the items 1 to 38, by 1) mixing of a dry food mix with a portion of cold water at a temperature <5° C., with a portion of snow ice or a portion of small ice particles, for instance particles with as largest diameter <2.5 mm, 2) shaping the moist food form or portion thereof and 3) cooking it in a ready-to-eat meat-structured protein product.
44. The preparation of a ready-to-eat food product from a dry food mix according to any one of the items 1 to 38, by 1) mixing of a dry food mix with a portion of cold water at a temperature <5° C., with a portion of snow ice or a portion of small ice particles, for instance particles with as largest diameter <2.5 mm, 2) shaping the moist food form or portion thereof and 3) instantly cooking it in a ready-to-eat meat-structured protein product.
45. Any one of the previous items 1 to 44, whereby methylcellulose is a blend of a) a methylcellulose 1 with a 2% aqueous viscosity at 20° C. of 82,500-154,000 mPas and of b) a methylcellulose 2 with a 2% aqueous viscosity at 20° C. of 3,000-5,600 mPas.
46. Any one of the previous items 1 to 44, whereby methylcellulose is a blend of a) a methylcellulose 1 with a methoxyl content in the range of 27.5-31.5% and a 2% aqueous viscosity at 20° C. of 82,500-154,000 mPas and of b) a methylcellulose 2 with a methoxyl content in the range of 27.5-31.5% and a 2% aqueous viscosity at 20° C. of 3,000-5,600 mPas.
47. Any one of the previous items 1 to 44, whereby methylcellulose is a blend of a) a methylcellulose 1 with a hydration temperature of 0)−15° C., and of b) a methylcellulose 2 with a hydration temperature of 15-25° C.
48. Any one of the previous items 1 to 44, whereby methylcellulose is a blend of a) a methylcellulose 1 with a 2% aqueous viscosity at 20° C. of 82,500-154,000 mPas and of b) a methylcellulose 2 with a 2% aqueous viscosity at 20° C. of 3,000-5,600 mPas, whereby in the blend methylcellulose 1 is in the range of 10 to 35%, preferably 20 to 30%, yet more preferably 23 to 27% and methylcellulose 2 is in the range of 65 to 85%, preferably 70 to 80%, yet more preferably 73 to 77%.

49. Any one of the previous items 1 to 44, whereby methylcellulose is a blend of a) a methylcellulose 1 with a methoxyl content in the range of 27.5-31.5% and a 2% aqueous viscosity at 20° C. of 82,500-154,000 mPas and of b) a methylcellulose 2 with a methoxyl content in the range of 27.5-31.5% and a 2% aqueous viscosity at 20° C. of 3,000-5,600 mPas, preferably 20 to 30%, yet more preferably 23 to 27% and methylcellulose 2 is in the range of 65 to 85%, preferably 70 to 80%, yet more preferably 73 to 77%.

50. Any one of the previous items 1 to 44, whereby methylcellulose is a blend of a) a methylcellulose 1 with a hydration temperature of 0-15° C., and of b) a methylcellulose 2 with a hydration temperature of 15-25° C., preferably 20 to 30%, yet more preferably 23 to 27% and methylcellulose 2 is in the range of 65 to 85%, preferably 70 to 80%, yet more preferably 73 to 77%.

51. The dry food mix of any of the previous items 1 to 50, whereby except the portion of any one of the group consisting of dry freeze thaw alginate cured curd solid, dry textured vegetable protein, dry alginate cured respiratory produce and dry animal meat particles, the portion of 1) methylcellulose capsule particles and 2) the other foodstuff are in the form of a mixed powder with a mean particle size of 1 mm or less.

52. The dry food mix of any of the previous items 1 to 50, whereby except the portion of any one of the group consisting of dry freeze thaw alginate cured curd solid, dry textured vegetable protein, dry alginate cured respiratory produce and dry animal meat particles, the portion of 1) methylcellulose capsule particles and 2) the other foodstuff are in the form of a mixed powder with a mean particle size of 350 microns or less.

53. The dry food mix of any of the previous items 1 to 50, whereby except the portion of any one of the group consisting of dry freeze thaw alginate cured curd solid, dry textured vegetable protein, dry alginate cured respiratory produce and dry animal meat particles, the portion of 1) methylcellulose capsule particles and 2) the other foodstuff are in the form of a mixed powder with a mean particle size of 50 microns or less.

Some embodiments or objects of the invention are set forth in item format directly below:
1.A food powder consisting essentially of capsule particles or capsule granules comprising or encapsulating a composition containing methylcellulose, whereby the composition of the capsule particles containing the methylcellulose is a composition of a fat and protein.
2. The food powder according to item 1, whereby the fat in the capsule particles is of 50 to 75 weight percent.
3. The food powder according to any of the items 1 to 2, whereby the protein in the capsule particles is of 10-33 weight percent.
4.A powder consisting essentially of capsule particles, whereby the capsule particles or capsule granules comprising or encapsulating a matrix and methylcellulose, wherein the matrix comprises or consists of fat and protein, wherein the protein:fat by weight ratio is 1:2-10.
5. The powder according to items 1 to 4, wherein the matrix comprises or consisting of fat and protein, wherein the protein:fat by weight ratio is 1:2-10 and whereby methylcellulose is encapsulated in the matrix material.
6.Any one of the previous items 1 to 5, whereby methylcellulose is a blend of a) a methylcellulose 1 with a 2% aqueous viscosity at 20° C. of 82,500-154,000 mPas and of b) a methylcellulose 2 with a 2% aqueous viscosity at 20° C. of 3,000-5,600 mPas.
7.Any one of the previous items 1 to 5, whereby methylcellulose is a blend of a) a methylcellulose 1 with a methoxyl content in the range of 27.5-31.5% and a 2% aqueous viscosity at 20° C. of 82,500-154,000 mPas and of b) a methylcellulose 2 with a methoxyl content in the range of 27.5-31.5% and a 2% aqueous viscosity at 20° C. of 3,000-5,600 mPas.
8.Any one of the previous items 1 to 5, whereby methylcellulose is a blend of a) a methylcellulose 1 with a hydration temperature of 0-15° C., and of b) a methylcellulose 2 with a hydration temperature of 15-25° C.
9.Any one of the previous items 1 to 5, whereby methylcellulose is a blend of a) a methylcellulose 1 with a 2% aqueous viscosity at 20° C. of 82,500-154,000 mPas and of b) a methylcellulose 2 with a 2% aqueous viscosity at 20° C. of 3,000-5,600 mPas, whereby in the blend methylcellulose 1 is in the range of 10 to 35%, preferably 20 to 30%, yet more preferably 23 to 27% and methylcellulose 2 is in the range of 65 to 85%, preferably 70 to 80%, yet more preferably 73 to 77%.
10. Any one of the previous items 1 to 5, whereby methylcellulose is a blend of a) a methylcellulose 1 with a methoxyl content in the range of 27.5-31.5% and a 2% aqueous viscosity at 20° C. of 82,500-154,000 mPas and of b) a methylcellulose 2 with a methoxyl content in the range of 27.5-31.5% and a 2% aqueous viscosity at 20° C. of 3,000-5,600 mPas, preferably 20 to 30%, yet more preferably 23 to 27% and methylcellulose 2 is in the range of 65 to 85%, preferably 70 to 80%, yet more preferably 73 to 77%.
11. Any one of the previous items 1 to 5, whereby methylcellulose is a blend of a) a methylcellulose 1 with a hydration temperature of 0-15° C., and of b) a methylcellulose 2 with a hydration temperature of 15-25° C., preferably 20 to 30%, yet more preferably 23 to 27% and methylcellulose 2 is in the range of 65 to 85%, preferably 70 to 80%, yet more preferably 73 to 77%.
12. The food powder of any of the previous items 1 to 11, whereby the methylcellulose capsule particles have a mean particle size of 1 mm or less.
13. The food powder of any of the previous items 1 to 11, whereby the methylcellulose capsule particles have a mean particle size of 350 microns or less.
14. The food powder of any of the previous items 1 to 11, whereby the methylcellulose capsule particles have a mean particle size of 50 microns or less.

Some embodiments or objects of the invention are set forth in item format directly below:
1.A food additive consisting essentially of capsule particles or capsule granules comprising or encapsulating a composition containing methylcellulose, whereby the composition of the capsule particles containing the methylcellulose is a composition of a fat and protein.
2. The food additive according to item 1, whereby the fat in the capsule particles is of 50 to 75 weight percent.
3. The food additive according to any of the items 1 to 2, whereby the protein in the capsule particles is of 10-33 weight percent.
4.A additive consisting essentially of capsule particles, whereby the capsule particles comprising a matrix and methylcellulose, wherein the matrix comprises or consists of fat and protein, wherein the protein:fat by weight ratio is 1:2-10.
5. The additive according to items 1 to 4, wherein the matrix comprises or consisting of fat and protein, wherein the protein:fat by weight ratio is 1:2-10 and whereby methylcellulose is encapsulated in the matrix material.
6.Any one of the previous items 1 to 5, whereby methylcellulose is a blend of a) a methylcellulose 1 with a 2% aqueous viscosity at 20° C. of 82,500-154,000 mPas and of b) a methylcellulose 2 with a 2% aqueous viscosity at 20° C. of 3,000-5,600 mPas.
7.Any one of the previous items 1 to 5, whereby methylcellulose is a blend of a) a methylcellulose 1 with a methoxyl content in the range of 27.5-31.5% and a 2% aqueous viscosity at 20° C. of 82,500-154,000 mPas and of b) a methylcellulose 2 with a methoxyl content in the range of 27.5-31.5% and a 2% aqueous viscosity at 20° C. of 3,000-5,600 mPas.
8.Any one of the previous items 1 to 5, whereby methylcellulose is a blend of a) a methylcellulose 1 with a hydration temperature of 0-15° C., and of b) a methylcellulose 2 with a hydration temperature of 15-25° C.
9.Any one of the previous items 1 to 5, whereby methylcellulose is a blend of a) a methylcellulose 1 with a 2% aqueous viscosity at 20° C. of 82,500-154,000 mPas and of b) a methylcellulose 2 with a 2% aqueous viscosity at 20° C. of 3,000-5,600 mPas, whereby in the blend methylcellulose 1 is in the range of 10 to 35%, preferably 20 to 30%, yet more preferably 23 to 27% and methylcellulose 2 is in the range of 65 to 85%, preferably 70 to 80%, yet more preferably 73 to 77%.
10. Any one of the previous items 1 to 5, whereby methylcellulose is a blend of a) a methylcellulose 1 with a methoxyl content in the range of 27.5-31.5% and a 2% aqueous viscosity at 20° C. of 82,500-154,000 mPas and of b) a methylcellulose 2 with a methoxyl content in the range of 27.5-31.5% and a 2% aqueous viscosity at 20° C. of 3,000-5,600 mPas, preferably 20 to 30%, yet more preferably 23 to 27% and methylcellulose 2 is in the range of 65 to 85%, preferably 70 to 80%, yet more preferably 73 to 77%.
11. Any one of the previous items 1 to 5, whereby methylcellulose is a blend of a) a methylcellulose 1 with a hydration temperature of 0-15° C., and of b) a methylcellulose 2 with a hydration temperature of 15-25° C., preferably 20 to 30%, yet more preferably 23 to 27% and methylcellulose 2 is in the range of 65 to 85%, preferably 70 to 80%, yet more preferably 73 to 77%.
12. The food additive of any of the previous items 1 to 11, whereby the methylcellulose capsule particles have a mean particle size of 1 mm or less.
13. The food additive of any of the previous items 1 to 11, whereby the methylcellulose capsule particles have a mean particle size of 350 microns or less.
14. The food additive of any of the previous items 1 to 11, whereby the methylcellulose capsule particles have a mean particle size of 50 microns or less.
1.A dry food mix for reconstitution into a meat-structured protein product characterised in that the dry food mix comprises capsule particles comprising a composition containing methylcellulose.
2. The dry food mix according to item 1, whereby the composition of the capsule particles containing the methylcellulose is a composition that comprises, essentially consists of or consists of a fat and protein.
3. The dry food mix according to any one of the items 1 to 2, whereby the methylcellulose in the capsule particles is of 10 to 30 weight percent.
4. The dry food mix according to any one of the items 1 to 2, whereby the fat or a mixture of fats in the capsule particles is of 50 to 75 weight percent.
5. The dry food mix according to any one of the items 1 to 2, whereby the protein or a mixture of proteins in the capsule particles is of 10-33 weight percent.
6. The dry food mix according to any one of the items 1 to 2, comprising a matrix and methylcellulose, wherein the matrix comprises, consist essentially of or consists of fat and protein, wherein the protein:fat by weight ratio is 1:2-10.
7. The dry food mix according to any one of the items 1 to 2, comprising a matrix and methylcellulose, wherein the matrix comprises or consisting of fat and protein, wherein the protein:fat by weight ratio is 1:2-10 and whereby methylcellulose is encapsulated in the matrix material.
8. The dry food mix according to any one of the items 1 to 7, comprising from 10% wt, to 30% wt. of capsule particles.
9. The dry food mix according to any one of the items 1 to 8, whereby capsule particles further comprise an acid.
10. The dry food mix according to any one of the items 1 to 9, whereby capsule particles comprise an antioxidant.
11. The dry food mix according to any one of the items 1 to 10, whereby capsule particles comprise an antibacterial.
12. The dry food mix according to any one of the items 1 to 11, whereby capsule particles comprise an herbal extract.
13. The dry food mix according to any one of the items 1 to 12, whereby capsule particles comprise a spice extract.
14. The dry food mix according to any one of the items 1 to 13, whereby capsule particles comprise a fruit extract.
15. The dry food mix according to any one of the items 1 to 14, whereby the fat, oil or butter comprises an agent selected from the list consisting of phospholipids, lecithin, monoglyceride, amphiphilic peptides, sorbitan monostearate, mono-, di- and/or triacyglycerols, fatty acids, fatty alcohol, wax, phytosterol, and/or combinations thereof.
16. The dry food mix according to any one of the items 1 to 15, whereby the capsule particles comprising a composition containing methylcellulose are in the form of a dry powder.
17. The dry food mix according to any one of the items 1 to 16, whereby the capsule particles comprising a composition containing methylcellulose are at least in part micro particles.
18. The dry food mix according to any one of the items 1 to 17, whereby the capsule particles comprising a composition containing methylcellulose are at least in part nanoparticles.
19. The dry food mix according to any one of the items 1 to 18, whereby the dry food mix is at least in part in powder mass form.
20. The dry food mix according to any one of the items 1 to 19, whereby the dry food mix comprises a powder mass including also larger then powder particle size food or foodstuff particles.
21. The dry food mix according to any one of the items 1 to 20, whereby the dry food mix comprises particles in a shape of the group consisting chunks, flake, strip, granule and fibre.
22. The dry food mix according to any one of the items 1 to 21, comprising dry freeze thaw cured curd solid.
23. The dry food mix according to any one of the items 1 to 21, comprising dry freeze thaw alginate cured curd solid.
24. The dry food mix according to any one of the items 1 to 23, comprising an dry alginate cured respiratory produce.
25. The dry food mix according to any one of the items 1 to 24, comprising TVP.
26. The dry food mix according to any one of the items 1 to 24, that is essentially free of textured vegetable protein (TVP).
27. The dry food mix according to any one of the items 1 to 25, comprising dried and grinded meat or dried and grinded seafood, such as fish.
28. The dry food mix according to any one of the items 1 to 25, characterised that the dry food mix is a premix consisting essentially of extended meat foodstuff.
29. The dry food mix according to any one of the items 1 to 25 characterised that the dry food mix is a premix consisting essentially of extended fish foodstuff.
30. The dry food mix according to any one of the items 1 to 25, characterised that the dry food mix is based on non-animal foodstuff.
31. The dry food mix according to any one of the items 1 to 30, characterised that the dry food mix is a premix for meat-structured protein product.
32. The dry food mix according to any one of the items 1 to 31, characterised that the dry food mix is a premix for flesh like textured food.
33. A cooked food with a meat-structured protein product made by using the dry food mix to any one of items 1 to 32.
34. A cooked food with a meat-structured protein product that is the rehydrating, mixing and cooking product of the dry food mix according to any one of the items 1 to 32.
35. The dry food mix according to any one of the items 1 to 34, characterised that the dry food mix is a packaged dry food mix, packaged in a container.
36. The dry food mix according to any one of the items 1 to 34, characterised that the dry food mix is stored in a hopper unit with auger transporting mechanism.
37. The dry food mix according to any one of the items 1 to 34, characterised that the dry food mix is stored in a hopper unit with auger transporting mechanism operatively connected at one end to an auger drive mechanism and at the other end via an output or output funnel to a mixing unit.
38. The dry food mix according to any one of the items 1 to 37, characterised in that it is an instant food mix
39. The preparation of a ready-to-cook food product from a dry food mix according to any one of the items 1 to 37, by mixing of a dry food mix with a portion of cold water at a temperature <5° C., with a portion of snow ice or a portion of small ice particles, for instance particles with as largest diameter <2, 5 mm.
40. The preparation of a ready-to-cook food product from a dry food mix according to any one of the items 1 to 37, by hand force mixing of a dry food mix with a portion of cold water at a temperature <5° C., with a portion of snow ice or a portion of small ice particles, for instance particles with as largest diameter <2, 5 mm.
41. The preparation of a ready-to-eat food product from a dry food mix according to any one of the items 1 to 37, by 1) mixing of a dry food mix with a portion of cold water at a temperature <5° C., with a portion of snow ice or a portion of small ice particles, for instance particles with as largest diameter <2.5 mm, 2) shaping the moist food form or portion thereof and 3) cooking it in a ready-to-eat meat-structured protein product.
42. The preparation of a ready-to-eat food product from a dry food mix according to any one of the items 1 to 37, by 1) mixing of a dry food mix with a portion of cold water at a temperature <5° C., with a portion of snow ice or a portion of small ice particles, for instance particles with as largest diameter <2.5 mm, 2) shaping the moist food form or portion thereof and 3) instantly cooking it in a ready-to-eat meat-structured protein product.
43. The preparation of a ready-to-eat food product from a dry food mix according to any one of the items 1 to 37, by 1) mixing of a dry food mix with a portion of cold water at a temperature <5° C., with a portion of snow ice or a portion of small ice particles, for instance particles with as largest diameter <2.5 mm, 2) shaping the moist food form or portion thereof and 3) cooking it in a ready-to-eat flesh like textured food.
44. The preparation of a ready-to-eat food product from a dry food mix according to any one of the items 1 to 36, by 1) mixing of a dry food mix with a portion of cold water at a temperature <5° C., with a portion of snow ice or a portion of small ice particles, for instance particles with as largest diameter <2.5 mm, 2) shaping the moist food form or portion thereof and 3) instantly cooking it in a ready-to-eat flesh like textured food.
45. Any one of the previous items 1 to 44, whereby methylcellulose is a blend of a) a methylcellulose 1 with a 2% aqueous viscosity at 20° C. of 82,500-154,000 mPas and of b) a methylcellulose 2 with a 2% aqueous viscosity at 20° C. of 3,000-5,600 mPas.
46. Any one of the previous items 1 to 44, whereby methylcellulose is a blend of a) a methylcellulose 1 with a methoxyl content in the range of 27.5-31.5% and a 2% aqueous viscosity at 20° C. of 82,500-154,000 mPas and of b) a methylcellulose 2 with a methoxyl content in the range of 27.5-31.5% and a 2% aqueous viscosity at 20° C. of 3,000-5,600 mPas.
47. Any one of the previous items 1 to 44, whereby methylcellulose is a blend of a) a methylcellulose 1 with a hydration temperature of 0-15° C., and of b) a methylcellulose 2 with a hydration temperature of 15-25° C.
48. Any one of the previous items 1 to 44, whereby methylcellulose is a blend of a) a methylcellulose 1 with a 2% aqueous viscosity at 20° C. of 82,500-154,000 mPas and of b) a methylcellulose 2 with a 2% aqueous viscosity at 20° C. of 3,000-5,600 mPas, whereby in the blend methylcellulose 1 is in the range of 10 to 35%, preferably 20 to 30%, yet more preferably 23 to 27% and methylcellulose 2 is in the range of 65 to 85%, preferably 70 to 80%, yet more preferably 73 to 77%.
49. Any one of the previous items 1 to 44, whereby methylcellulose is a blend of a) a methylcellulose 1 with a methoxyl content in the range of 27.5-31.5% and a 2% aqueous viscosity at 20° C. of 82,500-154,000 mPas and of b) a methylcellulose 2 with a methoxyl content in the range of 27.5-31.5% and a 2% aqueous viscosity at 20° C. of 3,000-5,600 mPas, preferably 20 to 30%, yet more preferably 23 to 27% and methylcellulose 2 is in the range of 65 to 85%, preferably 70 to 80%, yet more preferably 73 to 77%.
50. Any one of the previous items 1 to 44, whereby methylcellulose is a blend of a) a methylcellulose 1 with a hydration temperature of 0-15° C., and of b) a methylcellulose 2 with a hydration temperature of 15-25° C., preferably 20 to 30%, yet more preferably 23 to 27% and methylcellulose 2 is in the range of 65 to 85%, preferably 70 to 80%, yet more preferably 73 to 77%.
51. The dry food mix of any of the previous items 1 to 50, whereby except the portion of any one of the group consisting of dry freeze thaw alginate cured curd solid, dry textured vegetable protein, dry alginate cured respiratory produce and dry animal meat particles, the portion of 1) methylcellulose capsule particles and 2) the other foodstuff are in the form of a mixed powder with a mean particle size of 1 mm or less.
52. The dry food mix of any of the previous items 1 to 50, whereby except the portion of any one of the group consisting of dry freeze thaw alginate cured curd solid, dry textured vegetable protein, dry alginate cured respiratory produce and dry animal meat particles, the portion of 1) methylcellulose capsule particles and 2) the other foodstuff are in the form of a mixed powder with a mean particle size of 350 microns or less.
53. The dry food mix of any of the previous items 1 to 50, whereby except the portion of any one of the group consisting of dry freeze thaw alginate cured curd solid, dry textured vegetable protein, dry alginate cured respiratory produce and dry animal meat particles, the portion of 1) methylcellulose capsule particles and 2) the other foodstuff are in the form of a mixed powder with a mean particle size of 50 microns or less.

Some embodiments or objects of the invention are set forth in item format directly below:
1.A flesh like texture forming dry food composition comprising: a dry food composition having particles that encapsulate a composition containing methylcellulose.
2.An instant flesh like texture forming dry food composition comprising: a dry food composition having particles that encapsulate a composition containing methylcellulose.
3. The food composition according to any one of the previous items 1 and 2, whereby methylcellulose is a blend of a) a methylcellulose 1 with a 2% aqueous viscosity at 20° C. of 82,500-154,000 mPas and of b) a methylcellulose 2 with a 2% aqueous viscosity at 20° C. of 3,000-5,600 mPas.
4. The food composition according to any one of the previous items 1 and 3, whereby methylcellulose is a blend of a) a methylcellulose 1 with a methoxyl content in the range of 27.5 31.5% and a 2% aqueous viscosity at 20° C. of 82,500-154,000 mPas and of b) a methylcellulose 2 with a methoxyl content in the range of 27.5-31.5% and a 2% aqueous viscosity at 20° C. of 3,000-5,600 mPas.
5. The food composition according to any one of the previous items 1 and 4, whereby methylcellulose is a blend of a) a methylcellulose 1 with a hydration temperature of 0-15° C. and of b) a methylcellulose 2 with a hydration temperature of 15-25° C.
6. The food composition according to any one of the previous items 1 and 5, whereby methylcellulose is a blend of a) a methylcellulose 1 with a hydration temperature of 0-15° C. and of b) a methylcellulose 2 with a hydration temperature of 15-25° C., preferably 20 to 30%, yet more preferably 23 to 27% and methylcellulose 2 is in the range of 65 to 85%, preferably 70 to 80%, yet more preferably 73 to 77%.
7. The food composition according to any one of the previous items 1 and 6, whereby methylcellulose is a blend of a) a methylcellulose 1 with a 2% aqueous viscosity at 20° C. of 82,500-154,000 mPas and of b) a methylcellulose 2 with a 2% aqueous viscosity at 20° C. of 3,000-5,600 mPas, whereby in the blend methylcellulose 1 is in the range of 10 to 35%, preferably 20 to 30%, yet more preferably 23 to 27% and methylcellulose 2 is in the range of 65 to 85%, preferably 70 to 80%, yet more preferably 73 to 77%.
8. The food composition according to any one of the previous items 1 and 7, whereby methylcellulose is a blend of a) a methylcellulose 1 with a methoxyl content in the range of 27.5 31.5% and a 2% aqueous viscosity at 20° C. of 82,500-154,000 mPas and of b) a methylcellulose 2 with a methoxyl content in the range of 27.5-31.5% and a 2% aqueous viscosity at 20° C. of 3,000-5,600 mPas, preferably 20 to 30%, yet more preferably 23 to 27% and methylcellulose 2 is in the range of 65 to 85%, preferably 70 to 80%, yet more preferably 73 to 77%.
9. The food composition according to any one of the previous items 1 and 8, whereby the composition of the particles encapsulating methylcellulose is a composition that comprises particles essentially consisting of or consisting of a protein and a substance of the group consisting of a fat, oil and butter.
10. The food composition according to any one of the items 1 to 9, whereby the methylcellulose in the particles encapsulating methylcellulose is of 10 to 30 weight percent.
11. The food composition according to any one of the items 1 to 10, whereby the a substance of the group consisting of a fat, oil and butter or a mixture thereof in the particles encapsulating methylcellulose is of 50 to 75 weight percent.
12. The food composition according to any one of the items 1 to 11, whereby the protein or a mixture of proteins in the particles encapsulating methylcellulose is of 10-33 weight percent.
13. The food composition according to any one of the items 1 to 12, comprising in the methylcellulose encapsulating particles a matrix and methylcellulose, wherein the matrix comprises, consist essentially of or consists of a protein and a substance of the group consisting of a fat, oil and butter, wherein the protein:fat, oil or butter by weight ratio is 1:2-10.
14. The food composition according to any one of the items 1 to 13, comprising in the methylcellulose encapsulating particles a matrix and methylcellulose, wherein the matrix comprises or consisting of protein and fat, oil and butter, wherein the protein:fat, oil or butter or the protein:fat, oil or butter by weight ratio is 1:2-10 and whereby methylcellulose is encapsulated in the matrix material.
15. The food composition according to any one of the items 1 to 14, comprising in the methylcellulose encapsulating particles a matrix and methylcellulose, wherein the matrix comprises or consisting of protein and fat, oil or butter, wherein the fat, oil or butter fraction contains the methylcellulose entrapped by the cross linked protein fraction
16. The food composition according to any one of the items 1 to 15, comprising from 10% wt, to 30% wt. of methylcellulose loaded particles.
17. The food composition according to any one of the items 1 to 16, comprising dry freeze thaw curd solid.
18. The food composition according to any one of the items 1 to 17, comprising dry freeze thaw alginate cured curd solid.
19. The food composition according to any one of the items 1 to 18, comprising a dry alginate cured respiratory produce.
20. The food composition according to any one of the items 1 to 19, comprising textured vegetable protein (TVP).
21. The food composition according to any one of the items 1 to 19, that is essentially free of TVP.
22. The food composition according to any one of the items 1 to 19, that is substantially free of TVP.
23. The food composition according to any one of the items 1 to 22, characterised that the food composition comprises dried grinded meat or dried grinded fish.
24. The food composition according to any one of the items 1 to 23, characterised that the food composition is a premix consisting essentially of extended meat foodstuff.
25. The food composition according to any one of the items 1 to 23, characterised that the food composition is a premix consisting essentially of extended fish foodstuff.
26. The food composition according to any one of the items 1 to 25, characterised in that it is an instant food composition for reconstituted into a flesh like textured food by mixing it with aqueous liquid and subsequently heating it.
27. The food composition according to any one of the items 1 to 22, characterised that the food composition is based on non-animal foodstuff.
28. The food composition according to any one of the items 1 to 26, characterised that the food composition is a premix for meat like-structured protein product.
29. The food composition according to any one of the items 1 to 26, characterised that the food composition is a premix for fish like-structured protein product.
30. The food composition according to any one of the items 1 to 29, characterised that the food composition is a packaged dry food mix, packaged in a container.
31. The food composition according to any one of the items 1 to 29, characterised that the food composition is stored in a hopper unit with auger transporting mechanism.
32. The food composition according to any one of the items 1 to 29, characterised that the food composition is stored in a hopper unit with auger transporting mechanism operatively connected at one end to an auger drive mechanism and at the other end via an output or output funnel to a mixing unit.
33. The food composition according to any one of the items 1 to 32, whereby the particles encapsulating methylcellulose or capsule granules comprising or encapsulating a composition containing methylcellulose are in the form of a dry powder.
34. The food composition according to any one of the items 1 to 33, whereby the particles encapsulating methylcellulose or capsule granules comprising or encapsulating a composition containing methylcellulose are at least in part micro particles.
35. The food composition according to any one of the items 1 to 34, whereby the particles encapsulating methylcellulose or capsule granules comprising or encapsulating a composition containing methylcellulose are at least in part nanoparticles.
36. The food composition according to any one of the items 1 to 35, whereby the food composition is at least in part in powder mass form.
37. The food composition according to any one of the items 1 to 36, whereby the food composition comprises a powder mass including and also larger then powder particle size food or foodstuff particles.
38. The food composition according to any one of the items 1 to 37, whereby the food composition comprises particles in a shape of the group consisting chunks, flake, strip, granule and fibre.
39. The food composition according to any one of the items 1 to 38, whereby particles encapsulating methylcellulose further comprise an acid.
40. The food composition according to any one of the items 1 to 39, whereby particles encapsulating methylcellulose comprise an antioxidant.
41. The food composition according to any one of the items 1 to 40, whereby particles encapsulating methylcellulose comprise an antibacterial.
42. The food composition according to any one of the items 1 to 41, whereby particles encapsulating methylcellulose comprise an herbal extract.
43. The food composition according to any one of the items 1 to 42, whereby particles encapsulating methylcellulose comprise a spice extract.
44. The food composition according to any one of the items 1 to 43, whereby particles encapsulating methylcellulose comprise a fruit extract.
45. The food composition according to any one of the items 1 to 44, whereby the fat, oil or butter comprises an agent selected from the list consisting of phospholipids, lecithin, monoglyceride, amphiphilic peptides, sorbitan monostearate, mono-, di- and/or triacyglycerols, fatty acids, fatty alcohol, wax, phytosterol, and/or combinations thereof.
46. A cooked food with a flesh like textured food made by using the food composition to any one of items 1 to 45.
47. A cooked food with a flesh like textured food that is the rehydrating, mixing and cooking product of the food composition according to any one of the items 1 to 45.
48. The preparation of a ready-to-cook food product from a dry food composition according to any one of the items 1 to 45, by mixing of a dry food composition with a portion of cold water at a temperature <5° C., with a portion of snow ice or a portion of small ice particles, for instance particles with as largest diameter <2.5 mm.
49. The preparation of a ready-to-cook food product from a dry food composition according to any one of the items 1 to 45, by hand force mixing of a dry food composition with a portion of cold water at a temperature <5° C., with a portion of snow ice or a portion of small ice particles, for instance particles with as largest diameter <2.5 mm.
50. The preparation of a ready-to-eat food product from a dry food composition according to any one of the items 1 to 45, by 1) mixing of a dry food composition with a portion of cold water at a temperature <5° C., with a portion of snow ice or a portion of small ice particles, for instance particles with as largest diameter <2.5 mm, 2) shaping the moist food form or portion thereof and 3) cooking it in a ready-to-eat flesh like textured food.
51. The preparation of a ready-to-eat food product from a dry food composition according to any one of the items 1 to 45, by 1) mixing of a dry food composition with a portion of cold water at a temperature <5° C., with a portion of snow ice or a portion of small ice particles, for instance particles with as largest diameter <2.5 mm, 2) shaping the moist food form or portion thereof and 3) instantly cooking it in a ready-to-eat flesh like textured food.
52. The preparation of a ready-to-eat food product from a dry food composition according to any one of the items 1 to 45, by 1) mixing of a dry food composition with a portion of cold water at a temperature <5° C., with a portion of snow ice or a portion of small ice particles, for instance particles with as largest diameter <2.5 mm, 2) shaping the moist food form or portion thereof and 3) cooking it in a ready-to-eat meat-structured protein product.
53. The preparation of a ready-to-eat food product from a dry food composition according to any one of the items 1 to 45, by 1) mixing of a dry food composition with a portion of cold water at a temperature <5° C., with a portion of snow ice or a portion of small ice particles, for instance particles with as largest diameter <2.5 mm, 2) shaping the moist food form or portion thereof and 3) instantly cooking it in a ready-to-eat meat-structured protein product.
54. The food composition of any of the previous items 1 to 45, whereby except the portion of any one of the group consisting of dry freeze thaw alginate cured curd solid, dry textured vegetable protein, dry alginate cured respiratory produce, dry animal meat particles and dry animal meat particles, the portion of 1) methylcellulose particles encapsulating methylcellulose and 2) the other foodstuff are in the form of a mixed powder with a mean particle size of 1 mm or less.
55. The food composition of any of the previous items 1 to 45, whereby except the portion of any one of the group consisting of dry freeze thaw alginate cured curd solid, dry textured vegetable protein, dry alginate cured respiratory produce, dry animal meat particles and dry animal meat particles, the portion of 1) methylcellulose particles encapsulating methylcellulose and 2) the other foodstuff are in the form of a mixed powder with a mean particle size of 350 microns or less.
56. The food composition of any of the previous items 1 to 45, whereby except the portion of any one of the group consisting of dry freeze thaw alginate cured curd solid, dry textured vegetable protein, dry alginate cured respiratory produce, dry animal meat particles and dry animal meat particles, the portion of 1) methylcellulose particles encapsulating methylcellulose and 2) the other foodstuff are in the form of a mixed powder with a mean particle size of 50 microns or less.
57. A method for manufacturing a food composition to any one of items 1 to 45, which comprises preparing methylcellulose loaded particles by 1) mixing an edible fat, oil or butter portion at a temperature above their melting point with methylcellulose or methylcellulose mixture and 2) mixing a protein source or a legume homogenate with water at moderate temperature 60° C.-70° C., preferably 62° C.-67° C., and consequently blending both liquid mixture at an elevated temperature of 82° C.-98° C., preferably 85° C.-95° C., and 3) cooling this mixture. 5) drying this mixture. 5) grinding the mixture to a dry particulate solid. 5) dry mixing the encapsulated methylcellulose with a dry foodstuff of the group consisting of dry freeze thaw curd solid, dry freeze thaw alginate cured curd solid, dry alginate cured respiratory produce, TVP, dried grinded meat and dried grinded fish or a mixture thereof and optionally adding additional dry foodstuff, or food additives.
58. The method of manufacture according to item 57, which comprises preparing methylcellulose loaded particles by 1) mixing an edible fat, oil or butter portion at a temperature above their melting point with methylcellulose or methylcellulose mixture and 2) mixing a protein source or a legume homogenate with water at moderate temperature 60° C.-70° C., preferably 62° C.-67° C., for at least 60 minutes and consequently blending both liquid mixture at an elevated temperature of 82° C.-98° C., preferably 85° C.-95° C. during a time period at that temperature of at least 20 minutes and 3) cooling this mixture. 5) drying this mixture. 5) grinding the mixture to a dry particulate solid. 5) dry mixing the encapsulated methylcellulose with a dry foodstuff of the group consisting of dry freeze thaw curd solid, dry freeze thaw alginate cured curd solid, dry alginate cured respiratory produce. TVP, dried grinded meat and dried grinded fish or a mixture thereof.
59. The method of manufacture according to any one of the items 57 to 58, whereby the legume homogenate is a legume of the group consisting of soybean, pea and chickpeas.
60. The method of manufacture according to any one of the items 57 to 58, whereby the legume homogenate is a protein isolate of the group consisting of pea protein liquor, pea protein concentrate, pea protein isolate (PPI), soy protein liquor, soy protein concentrate, soy protein isolate, faba (fava) bean protein liquor. faba (fava) bean protein concentrate and faba (fava) bean protein isolate.
61. The method of manufacture according to any one of the items 57 to 60, whereby the edible fat, oil or butter portion is from the group consisting of palm fat, canola oil, sunflower oil, coconut fat, stearin fat and a plant butter.

62. The method of manufacture according to any one of the items 57 to 61, whereby additionally encapsulating in the methylcellulose load particles an acid, an antioxidant, an antibacterial, an herbal extract, a spice extract, a fruit extract or a combination thereof.

Recitation of ranges of values herein are merely intended to serve as a shorthand method of referring individually to each separate value inclusively falling within the range, unless otherwise indicated herein, and each separate value is incorporated into the specification as if it were individually recited herein.

Any of the elements, components or features described herein may be combined in any order to arrive at a desired configuration in accordance with the explicitly stated and intended operation of the present invention. Use herein of the transitional phrases “in some embodiments” and “in some instances” is not intended to limit the scope of any particular embodiment to a specific element, component or feature, or set of elements, components or features disclosed therewith. Rather, the intention of all the various embodiments described herein is to provide frameworks of context in which a specific element, component or feature, or a set of elements, components, or features may be comprehended and understood in the context of the inventive concept as a whole. Accordingly, the entirety of the present disclosure is to be understood as a body of interchangeable and modular elements, components and features that may be selected and combined (in accordance with the requisite purview of one having ordinary skill in the art) to achieve a product, composition, system, or method within the context of the inventive concept, as a whole, disclosed herein.

Unless defined otherwise, all technical and scientific terms used herein have the same meaning as is commonly understood by one of ordinary skill in the art to which this disclosure pertains. Definitions may comprise multiple possible meanings as disclosed herein, and a defined term may be used for one meaning selected from among multiple meanings allowed by the definitions of this disclosure. Any limitations to defined terms will be understood to not invalidate the other meanings that compose a definition in other contexts.

“a” The terms “a” and “an” and “the” and similar indefinite or definite articles of language as used herein do not exclude cases where plural articles of language may further apply, unless otherwise indicated herein or clearly contradicted by context.

### DETAILED DESCRIPTION

It is a general practice to mix methylcellulose, dispersed in oil, to the foodstuff and under cold-water conditions for instance using liquid nitrogen. The obtained patties are subjected to an incubation at low temperatures, for instance above 0° C., and under 4° C. It is a common practice to use a mixing process under vacuum conditions. Eventually a preheating step heating after addition of starches or pre-gelled starches is carried out. In some practices, also vacuum mixing has to be used. All these are to achieve a reasonable stability and achieve a fleshy texture.

We experienced that mixing dry methylcellulose powders in a dry food premix (animal based, non-animal based or hybrid animal based, non-animal based) was not suitable for instant moistening and cooking it with baking stability into a food form with a fleshy texture.

But with present invention, we experienced by using dry food mix comprising capsule particles or capsule granules comprising or encapsulating a composition containing methylcellulose and dry TVP (when this TVP has a good water absorption capacity), alginate cured respiratory produce and/or freeze thaw alginate cured curd solid that excellent baking stability and fleshy texture can be reached when such dry food mix was mixed with cold water (<5° C.), snow or small ice particles.

With present invention we experienced that dry food mix comprising capsule particles or capsule granules comprising or encapsulating a composition containing methylcellulose and dry TVP (when this TVP has a good water absorption capacity), alginate cured respiratory produce and/or freeze thaw alginate cured curd solid when mixed with cold water (<5° C.), snow or small ice particles hand force or by a kitchen apparatus results in excellent baking stability of the mixture and a cooked fleshy textured food product with excellent springiness, tenderness, chewiness and juiciness. Surprisingly when TVP was replaced by a curd solid foodstuff, that had been subjected to a freeze and thaw (freeze thaw curd solid), the cooked fleshy textured food product had an excellent springiness, tenderness, chewiness and juiciness even when it was instantly cooked after the mixing a dry food mix comprising capsule particles or capsule granules comprising or encapsulating a composition containing methylcellulose and dry TVP (when this TVP has a good water absorption capacity), alginate cured respiratory produce and/or freeze thaw alginate cured curd solid and cold water (<5° C.), snow or small ice particles. Yet more surprisingly this springiness, tenderness, chewiness and juiciness was even more improved if the TVP was replaced by a curd solid foodstuff, that that had been subjected to a freeze and thaw, partially water removal, incubation with a sodium alginate aqueous solution and a consent incubation in a watery calcium lactate aqueous solution. The thawing and partial water by subjecting the frozen curd solid to microwaving was a suitable process for present invention.

When methylcellulose was dispersed in oil and consequently had force mixed or mixed by a kitchen blender or dough mixer with the other foodstuff under cold-water conditions, whereby TVP was replaced by freeze thaw curd solid the end food failed to cook in a food product with decent springiness, tenderness, chewiness and juiciness or flesh like food. And this was the case even when in the mixing process liquid nitrogen was add as a coolant or even when incubation, for instance above 0° C., and under 4° C. was used on intermediate and/or end products of the mixing process or even when these ware followed by a preheating step before further cold temperature incubation.

The term “binding” as used herein refers to the property of being held together, such as providing chemical or physical association or proximity, providing cohesiveness among entities, providing resistance to separation among entities, or providing energetically favourable interactions among entities that come into spatial proximity. The term further encompasses chemical bonding (i.e. covalent or non-covalent bonds) as used in the art.

The term “adhesiveness” as used herein refers to the property of tending to adhere or remain in association with, such as, for example, between objects, agents, ingredients or molecules. The adhesiveness of a sample may be determined by a Texture Profile Analysis (TPA) parameter that quantifies a material's tendency to adhere to the probe.

The term “agent release system” as used herein refers to dispersed system components that include one or more agents to be released and that protect such agents to be released from degradation or other chemical transformation or interaction with their environment until trigger conditions cause the release of the agents to be released from the dispersed system components.

The term “agent to be released” as used herein refers to a compound that is not an integral part of an agent release system but that is non-covalently bound to an agent release system, for example, via hydrogen bonding, ionic bonding, hydrophilic interaction, electrostatic interaction, ion exchange, metal ion chelation, coordination complex formation, or precipitation (e.g., involving hydroxyl, carboxyl, phosphate, sulphate, or amino groups), or that is physically captured in an agent release system. Examples of agents to be released include but are not limited to colouring agents, color stabilizers, color enhancers, aroma agents, aroma stabilizers, aroma enhancers, taste agents, taste stabilizers, taste enhancers, pH and/or ionic strength adjusting agents, binding agents, transition metals, transition metal complexes, anthocyanins, betanins, chelating agents, antioxidants, anti-microbial agents, metal ions, metal ion complexes, lipids, proteins, amino acids, carbohydrates, edible fibers, essential nutrients. Maillard reaction precursors and other precursor molecules that can specifically or non-specifically interact with each other or other compounds to produce agents that impart or enhance meatlike attributes, biologically active substances, food safe ingredients, non-animal ingredients, animal ingredients, nutritional supplements, seasoning agents, salts, sugars (e.g., ribose, glucose), nucleic acids (e.g., DNA, RNA), microbial biomass, iron-containing molecules (e.g. heme, hemin, porphyrin, leghemoglobin, myoglobin, hemoglobin), cell structures (e.g., chloroplasts), medicinal compounds, nutraceuticals, agents that increase the enjoyment or healthfulness of the meat-like food products provided herein, and mixtures thereof.

The term “agent” as used herein refers to any chemical, biological, or food ingredient entity. Non-limiting examples of an “agent” include ions, minerals, salts, water, solvents, acid, base, compounds, small molecules, organic compounds, inorganic compounds, color agents, flavour/aroma agents, pH and/or ionic strength adjusting agents, binding agents, lipid, molecular complexes (e.g., covalent or non-covalent complexes, supramolecular complexes, self-assembled complexes, inclusion complexes, including covalent or non-covalent complexes that may or may not have a defined structural order), biomolecules, polymers, macromolecules, biomacromolecules, proteins, carbohydrates, polysaccharides, nucleic acids, poly (nucleic acids) (e.g., DNA, RNA), nanoparticles, micro particles, and materials that can be present in any state of matter (e.g., liquid, solid, gas, gel, paste) or mixed states of matter as appropriate for a specified agent. As used herein, an agent can also comprise a complex mixture of chemical, biological, or food ingredient entities, including complex mixtures that can be summarily described as a single entity, such as non-limiting examples including minerals, salt, buffer, lipid (e.g., oils or waxes that may comprise saturated, unsaturated, polyunsaturated fatty acids:waxes that may comprise fractionated or isolated components from any lipid source: glycerides fatty acid esters), emulsion stabilizing agent, gel, juice, polysaccharide (starches, fibers, gums, hydrocolloids), sugar, cell wall material, autolyzed yeast, nutritional yeast, yeast extract, microbial biomass, fermentation products, cells, deactivated cells, cell fractions, chloroplasts, oleosomes, iron-containing molecules (e.g., heme, hemin, porphyrin, leghemoglobin, myoglobin, hemoglobin), protein (e.g., protein isoforms, post-translationally modified proteins, protein isolates, protein concentrates, protein flours), enzyme, nucleic acid, flour, color agents, flavour/aroma agents, pH and/or ionic strength adjusting agent, binding agent, transition agent, acid, base, texturizing agent, cross-linking agent, salt, natural product, synthetic compound, small molecule, macromolecule, molecular complex, inclusion complex, antioxidant, extract, oleoresin, processed (e.g., dried, powdered, crushed, homogenized) plants, and isolated fractions of the aforementioned ingredients.

The term “animal meat” as used herein refers to flesh and tissue derived from skeletal muscle or from other organs (e.g., kidney, heart, liver, gallbladder, intestine, stomach, bone marrow, brain, thymus, lung, tongue), or parts thereof, derived from an animal. The animal meat can be dark or white meat and may include other components such as muscle tissue, fat tissue, organ tissue, bone, and may also further include blood, serum, marrow, and interstitial fluid. Suitable animals from which the animal meat can be derived include but are not limited to cattle, pig, lamb, mutton, horse, poultry' (e.g., chicken, duck, goose, turkey), fowl (any bird species, pigeon, dove, grouse, partridge, ostrich, emu, pheasant, quail), fresh or salt water fish (e.g., catfish, tuna, spearfish, shark, halibut, sturgeon, salmon, bass, cod, musky, pike, bowfin, gar, eel, paddlefish, bream, carp, trout, walleye, snakehead, crappie, sister, mussel, scallop, abalone, squid, octopus, sea urchin, cuttlefish, tunicate, whitefish), crustacean (e.g., crab, lobster, shrimp, barnacle), game animals (e.g., deer, fox, wild pig, elk, moose, reindeer, caribou, antelope, zebra, squirrel, marmot, rabbit, bear, beaver, muskrat, opossum, raccoon, armadillo, porcupine, bison, buffalo, boar, lynx, bobcat, bat), reptiles (e.g., snakes, turtles, lizards, alligators, crocodiles), any insect or other arthropod (e.g., cricket, worm, cockroach, slug), rodent (nutria, guinea pig, rat, mice, vole, groundhog, capybara), kangaroo, whale, and seal. The term refers to any form of meat including whole muscle, cuts, fillets, bone-in meat, trimmed meat, and ground, chopped, shredded, reconstituted, or otherwise processed animal meat. The term encompasses both uncooked, cooking, and cooked forms of animal meat unless otherwise indicated herein or clearly contradicted by context.

The term “binding agent” as used herein refers to an agent that mediates or effects binding. In non-limiting examples, a binding agent may effect binding among entities, agents, ingredients, or a food product composition. Binding agents of the present disclosure are not limited by their mechanism of action and non-limiting examples include agents that effect viscosity, gelling, cross-linking, molecular interactions, covalent bonding, non-covalent bonding, ionic interactions, coacervation, (bio) polymer entanglement, network formation, supramolecular assembly, structuring, and hydrogen bonding, Van Der Waals interactions, and hydrophobic interactions.

The term “bound” as used herein refers to being held in association through chemical or physical bonding. The term is not limited by the mechanism by which chemical or physical association or interaction occurs, and non-limiting examples include hydrogen bonding, ionic bonding, covalent binding, cross-linking, non-covalent binding, reversible covalent bonding, hydrophilic interaction, electrostatic interaction, chelation, metal ion chelation, coordination complex formation, inclusion complexes, coacervation, precipitation. Van Der Waals forces, solvation, hydrophobic interaction, hydrophilic interaction, supramolecular interaction, supramolecular assembly, physical confinement, resistance to diffusion through physical barriers (e.g., sieves, membranes, non-porous materials), resistance to diffusion through chemical barriers (e.g., viscous materials, gels, polymer or biomacromolecule entanglement, solvents), or physical capture in an agent release system.

The term “butter” as used herein is understood to be synonymous with the term “lipid” and may refer in general terms to a lipid or a composition comprising a lipid as a main constituent that retains solid, semi-solid, biphasic, or paste-like properties at ordinary temperatures of use.

“As used herein, the term “carbohydrate” refers to at least a source of carbohydrates such as, but not limited to, monosaccharides, disaccharides, oligosaccharides, polysaccharides or derivatives thereof.

The term “cell wall material” as used herein refers to cell walls and cell wall fragments, including cell walls and cell wall fragments with bound cell membrane and/or bound compounds. Cell wall material is also known in the art under the terms ghosts, hulls, husks, shells, envelopes, debris, refuse, or “ref”.

The term “chewiness” as used herein refers to the sensation of a sustained, elastic resistance from the food, or the degree of applied force needed to overcome resistance to breakdown of food. The chewiness of a food product may be determined and characterized by a human, for instance a human, for instance a human sensory panel. Chewiness may also be measured and quantified as a TPA parameter that is a parameter calculation from gumminess and springiness, which expresses the energy required to chew a test article (e.g., food product) to a state where it overcomes the resistant forces.

The term “cohesiveness” as used herein refers to the property of being held together and resistance to separation. In the context of a food product disclosed herein, the term “cohesiveness” refers to the property of the food product to resist deformation or separation of the component parts upon application of an applied force or energy (e.g., food product handling, processing, cooking, or chewing). The cohesiveness of a food product may be determined and characterized by a human, for instance a human, for instance a human sensory panel. Cohesiveness may also be measured and quantified as a TPA parameter that is a parameter calculation from the area of work during the first compression of a test article (e.g., a food product) and the resistance to a second deformation relative to the resistance of a first compression.

The term “color agent” or “colorants” as used herein refers to an agent that confers color to an object, agent, substance, system, ingredient, or food product, Non-limiting examples of color agents include artificial colours, natural colours, dyes, extracts, juices, isolated compounds, synthetic compounds, pigments, coloured complexes, proteins that impart color or contain chromophores, nanoparticles, agents or entities that scatter light, agents or entities that develop color over time, and food ingredients or other agents that have color that is secondary to an ingredient's or agent's function. The term encompasses color enhancers (i.e., agents that increase a color, color intensity or saturation, color hue, or increase the perception of color) and color stabilizers (i.e., agents that prevent changes in color or the perception of color). Non-limiting examples of color enhancers include co-pigments. pH and/or ionic strength adjusting agents, metal ions, chelating agents, complexes, agents that form complexes with color agents, polyphenols, phenol or polyphenol-containing extracts, and combinations thereof. Non-limiting examples of color stabilizers include antioxidants (e.g., ascorbic acid, fruit and/or vegetable extracts with antioxidant properties). pH and/or ionic strength adjusting agents, carbohydrates, chelating agents, agents that form complexes with color agents, salts, formulation aids (e.g., maltodextrin, gum acacia, guar gum, xanthan gum, konjac gum, starch, modified starch, fiber, modified fiber, methyl cellulose, ethyl cellulose, hydroxypropyl cellulose, protein, protein flour), and combinations thereof.

The term “color” as used herein refers to a combination of hue, saturation, brightness, and lightness of light reflected, absorbed, or emitted by an object. Generally, the term refers to the phenomenon of reflected or emitted light that effects a visual response in an eye or light-responsive receptor, whether biological or non-biological in origin. The color of a food product can be tested and characterized using a visual panel of human sensory experts. Alternatively, the color of a food product can be tested, characterized and quantified using methods in the field of colorimetry.

The term “congealed” as used herein refers to a solid or semi-solid state of matter that has been obtained from a fluid or liquid state of matter by cooling.

The term “cook loss” as used herein refers to the reduction in weight when a food product is cooked. Cook loss may occur due to physical or chemical changes that occur during cooking, including non-limiting examples such as loss of moisture content, loss of lipid content, loss of volatile compounds content, changes in meat-structured protein products, changes in ingredients that change the density of the food product, changes in binding agents (e.g., onset of gelation, loss of gelation, increase in viscosity, decrease in viscosity), changes in water binding capacity, and changes in oil binding capacity. Cook loss may also depend on surface area, volume, density, heat capacity and heat transfer of a food product, and wherein such attributes may further change during a cooking process.

The term “cooked” as used herein refers to either the process of heating a food product or the state of food product after heating. Accordingly, a food product may be cooked to different endpoints or degrees of doneness contingent on the amount of heat or thermal energy applied to the food product during the cooking process. In a non-limiting example for animal meats such as beef, veal, and lamb steaks and roasts, a “rare cooked animal meat” may refer to a piece of animal meat that has obtained a final internal temperature of 50-60° C.; a “medium cooked animal meat” may refer to a piece of animal meat that has obtained a final internal temperature of 60-71° C.; and a “well done cooked animal meat” may refer to a piece of animal meat that has obtained a final internal temperature of 71-80° C.

The term “cooking experience” as used herein refers to the sensory experience of seeing, hearing, and smelling a food product as it is being cooked, including smelling the aroma, hearing the sizzle sound, and seeing the color change a food product produces or undergoes as it is cooked.

The term “crosslinking” as used herein refers to the chemical, biochemical, enzymatic, or chemo-enzymatic formation of covalent bonds between previously separate or independent molecules.

The term “doneness” as used herein refers to the extent that a food product has been cooked. For meat-like food products provided herein, the doneness is the degree to which the meat-like food product has been cooked and obtains one or more similar attributes compared to animal meat at different extents of the cooking process (e.g., attributes for rare cooked animal meat, medium cooked animal meat, well done cooked animal meat). In non-limiting examples, the degree to which a meat-like food product has been cooked may be compared to cooked animal meat for similarity in temperature, final internal temperature, color, color change, appearance, aroma, flavour, texture, texture change, chewiness, gumminess, springiness, cohesiveness, resilience, adhesiveness, hardness, moisture content, juiciness, internal temperature, cook loss, head space GCMS or reduced microbial load.

The dried food, food composition, food product, foodstuff, respiratory produce, pulse curd solid, food additive, curd, freeze thaw alginate cured curd solid, freeze thaw curd solid, legume curd solid, curd solid, alginate cured respiratory produce or bean curd solid of the present invention may be prepared by drying the above-mentioned edible food, food composition, food product, foodstuff, respiratory produce, pulse curd solid, food additive, curd, freeze thaw alginate cured curd solid, freeze thaw curd solid, legume curd solid, curd solid, alginate cured respiratory produce or bean curd solid. As the drying method, any method that is generally used for drying foods can be used, Examples of the method include sun drying, shade drying, freeze drying, air drying (e.g., hot air drying, fluidized bed drying, spray drying, drum drying, or low temperature drying), press drying, reduced pressure drying, microwave drying, and oil heat drying. In particular, a method by air drying (e.g., hot air drying, fluidized bed drying, spray drying, drum drying, or low temperature drying) or freeze drying is preferred because the degree of change in colour tone or flavour inherently possessed by a food, foodstuff, respiratory produce, pulse curd solid, food additive, curd, freeze thaw alginate cured curd solid, freeze thaw curd solid, legume curd solid, curd solid, alginate cured respiratory produce or bean curd solid is small and the scent (e.g., burnt odour) other than the food can be controlled.

The “dry” state in the present invention refers to a state that the water content is about 20 mass % or less and the water activity value is 0.85 or less. In addition, the water content is more preferably 15 mass % or less, more preferably 10 mass % or less, and more preferably 5 mass % or more. The lower limit is not particularly limited and is usually 0.1 mass % or more. Furthermore, the water activity value is preferably 0.80 or less and more preferably 0.75 or less.

As a method for quantitatively measuring water, a method of subjecting a dried food, food composition, foodstuff, respiratory produce, pulse curd solid, food additive, curd, freeze thaw alginate cured curd solid, freeze thaw curd solid, legume curd solid, curd solid, alginate cured respiratory produce or bean curd solid powder to reduced pressure heat drying may be used. Specifically, an appropriate amount of a specimen is placed in a scale container previously adjusted to a constant weight (W0) and is measured to the digit of 0.1 mg (W1). At ordinary pressure, the scale container with the lid removed or the aperture open is put in a reduced pressure electric constant temperature dryer adjusted to a predetermined temperature (more specifically 90° C.). The door is closed, the vacuum pump is operated, and drying is performed at a predetermined degree of reduced pressure for a certain period of time. The vacuum pump is stopped, the pressure is returned to ordinary pressure by sending dry air, the scale container is taken out, the lid is put on the container, and after allowing to cool in a desiccator, the mass is weighed. The drying, cooling, and weighing the mass are repeated until a constant weight (W2, measured to the digit of 0.1 mg) is achieved. The water content (mass %) is determined by the following calculation equation: Water (g/100 g)=(W1−W2)/(W1−W0)×100. W0: mass (g) of the scale container adjusted to constant weight. W1: mass (g) of the scale container containing a specimen before drying, and W2: mass (g) of the scale container containing the specimen after drying.

The water activity value is a numerical value representing the proportion of free water in a food and is used as an indicator of the preservability of a food. Specifically, it is the value obtained by dividing the equilibrium vapour pressure (p) in the headspace on a sample by the vapour pressure (p0) of water at the same temperature, in other words, the value obtained by dividing the equilibrium relative humidity (ERH) in the headspace by 100. The water activity value can be measured with a general water activity measuring device (e.g., “Novasina−LabMaster Neo Aw-meter+awSens-ENS” sold by Novolab NV, employing an electric resistance based (electrolyte based) humidity sensor).

In addition, in the dried food, foodstuff, respiratory produce, pulse curd solid, food additive, curd, freeze thaw alginate cured curd solid, freeze thaw curd solid, legume curd solid, curd solid, alginate cured respiratory produce or bean curd solid powder of the present invention, the crushing method used for pulverization is not particularly limited. The temperature at the time of crushing is not limited either, and any of high-temperature crushing, ordinary-temperature crushing, and low-temperature crushing may be performed. The pressure at the time of crushing is not limited either, and any of high-pressure crushing, ordinary-pressure crushing, and low-pressure crushing may be performed. Examples of the apparatus for such crushing include equipment, such as a blender, a mixer, a mill, a kneader, a grinder, a crusher, and an Attritor mill, and any of these apparatuses may be used. As such an apparatus, for example, a medium stirring mill, such as a dry bead mill and a ball mill (a rolling type, a vibration type, etc.), a jet mill, a high-speed rotary impact type mill (e.g., pin mill), a roll mill, or a hammer mill can be used.

The term “emulsion stabilizing agent” as used herein refers to an agent or substance that stabilizes an emulsion, and is synonymous with the term “emulsifier” that is commonly used in the art. Generally, an “emulsion stabilizing agent” refers to a molecule that concentrates al the interface between the phases of an emulsion, reduces the interfacial tension between the phases, and thus stabilizes the emulsion. Emulsifiers that can stabilize emulsions can be characterized by the Hydrophilic Lipophilic Balance (HLB), which indicates the solubility of the emulsifier. An emulsifier with a high HLB is more soluble in water and promotes 1/w emulsions whereas an emulsifier with a low HLB is more soluble in lipid and promotes water/lipid emulsions.

The term “dry mix” or “dry food mix” as used therein means a dry food product obtained by mixing of dry ingredients to create a “dry” food product or a “dry” food composition or it means the a dry food product or dry food composition obtained by mixing of wet ingredients or wet and dry ingredients and drying this to obtain this “dry” food product or “dry” food composition.

The term “entity” as used herein refers to matter in any type of composition or form.

The term “emulsion” as used herein refers to a mixture of immiscible liquids in which one or more liquid (“dispersed phase(s)”) is dispersed as droplets in another liquid (“continuous phase”). For the purposes of this disclosure, emulsions may further comprise a subset of mixtures of immiscible substances that have obtained semi-solid or solid forms (e.g., by congealing, gelling, cross-linking, viscosifying, or otherwise solidifying an emulsion initially prepared in liquid form) which may be referred to as gelled emulsion, congealed emulsion, solid emulsion, semi-solid emulsion. Non-limiting examples of emulsions include a lipid dispersed phase in a water continuous phase (i.e., lipid in water emulsion. 1/w, also known as an oil in water (o/w) emulsion), or a water dispersed phase in a lipid continuous phase (i.e., water in lipid emulsion, w/1, also known as a water in oil (w/o) emulsion), or double emulsions (1/w/1 or w/1/w), or a Pickering emulsion stabilized by colloidal solids at the liquid interface.

The term “environment” as used herein refers to the surroundings and/or conditions, which a given system (e.g., a chemical, physical, energetic, or thermodynamic system) occupies. As would be understood by one of skill in the art, the environment may comprise the part of the universe that does not include the system or be a defined subcomponent of the universe that does not include the system. In one non-limiting example, an inclusion complex that is defined as a system may have an environment that is the meat-like food product, wherein the exclusion of the inclusion complex system from the environment (defined in this case as a meat-like food product) is assumed.

As used herein, the term “essentially consists of” is understood to allow the presence of additional components in a sample or a composition that do not affect the properties of the sample or the composition. As an illustrative example, a ready-to-cook flesh like food product of non-animal origin and comprising the mixing product of at least 1) preformed encapsulated methylcellulose powder. 2) food oil and with 3) freeze thaw curd solid may include aroma if it essentially consists of an active ingredient the mixing product of at least 1) preformed encapsulated methylcellulose powder. 2) food oil and with 3) freeze thaw curd solid.

As used herein, the term “essentially free of an ingredient” as provided throughout the specification is intended to mean that the composition, when dried to a water content of 10%, comprises less than about 0.05% by weight, less than about 0.01% by weight, or less than about 0.001% by weight of the ingredient, unless specifically indicated otherwise. In some embodiments, a composition “essentially free of an ingredient comprises less than 0.05% by weight, less than 0.01% by weight, or less than 0.001% by weight of the ingredient, when the composition is dried to 10% water content.

The term “extended meat product” as used herein refers to animal meat that is supplemented with additives, including agents, starches, polysaccharides, binding agents, flavour/aroma agents, color agents, protein, lipid, sal butter, sal butter compositions, meat-structured protein products, or meat-like food products. Such additives may be either already present as an intrinsic component of animal meat (e.g., extended ground beef with added beef fat) or not normally present in the meat product (e.g., extended ground beef with a meat-structured protein product that comprises pea protein). Accordingly, the terms “meat filler” and “meat extender” as used in the art will be understood to be synonymous terms for the purposes of this disclosure.

The term “extended fish product” as used herein refers to animal fish that is supplemented with additives, including agents, starches, polysaccharides, binding agents, flavour/aroma agents, color agents, protein, lipid, sal butter, sal butter compositions, fish-structured protein products, or fish-like food products. Such additives may be either already present as an intrinsic component of animal fish (e.g., extended ground beef with added beef fat) or not normally present in the fish product (e.g., extended ground beef with a fish-structured protein product that comprises pea protein). Accordingly, the terms “fish filler” and “fish extender” as used in the art will be understood to be synonymous terms for the purposes of this disclosure.

The term, “fibres” may be insoluble fibres, preferably from cereal, tuber, seed or leguminosas. The term “water content” refers to the content of water based upon the loss on drying method as described in Pharmacopeia! Forum, Vol. 24, No. 1, page 5438 (January-February 1998). The calculation of water content is based upon the percent of weight that is lost by drying.

The term “flavour/aroma agent” as used herein refers to a chemical compound capable of causing a response in the gustatory and/or olfactory system to affect a sensory perception of flavour or aroma. Flavour and/or aroma can be characterized using a panel of human sensory experts. Alternatively, flavour can be characterized or quantified using automated devices, the so called E-tongues, such as, for example, the TS-5000Z taste sensing system (Higuchi USA Inc. Japan), αAstree. Alpha M. O. S (Toulouse, France), and aroma can be characterized or quantified by head space gas chromatography-mass spectrometry (GCMS), using, for example, an automated olfactometer, such as, for example, the Heracles II (Alpha MOS America, Hanover, MD). It will be understood that aroma and taste contribute to the perception of flavour and any such aroma and taste agents will be encompassed by the term “flavour/aroma agent” used herein. As used herein, the term encompasses flavour/aroma enhancers (i.e., agents that enhances the activity of flavour/aroma agents or increases the sensitivity of taste-receptors or olfactory receptors in the gustatory.' system) and flavour/aroma stabilizers (i.e., agents that prevent or reduce the loss of flavour and/or aroma in a food product or any process involving flavour and/or aroma agents [e.g., flavour/aroma production process, meat-like food product production process, process for preparing an agent release system, process for preparing solid fat]). Non-limiting examples of flavour/aroma enhancers include oil-soluble taste/aroma agents, water-soluble taste/aroma agents, nucleotides, guanylic acid, inosinic acid, 5′-ribonucleotide salts, inosine monophosphate, guanosine monophosphate, glutamic acid salts, glycine salts, guanylic acid salts, hydrolysed proteins, hydrolysed vegetable proteins, hydrolysed pea protein, hydrolysed soy protein, fermentation products, fermented proteins, fermented vegetable, fermented fruit, fermented meat, fermented sugar, fermented starch, yeast cultures, autolyzed yeast, yeast extract, deactivated yeast, nutritional yeast, insomniac acid salts, monosodium glutamate, glutamic acid, sodium chloride, salts (e.g., sodium salts, potassium salts, calcium salts), sugars, acids (e.g., lactic acid, malic acid, tartaric acid, citric acid, succinic acid), galacto-oligosaccharides, sorbitol, animal meat taste, animal meat oil, artificial taste agents, aspartamine, fumarate, garlic, garlic flavour, garlic powder, herb taste, malate, mushrooms, mushroom flavour, mushroom extract, natural taste agents, natural smoke extract, natural smoke solution, onion, onion flavour, onion powder, shiitake extract, spice extract, spice oil, sugars, tomatoes, tomato extract, amino acids, precursor molecules that can specifically or non-specifically react with each other or other compounds to produce agents that impart or enhance meat-like taste (e.g., Maillard reaction precursors; non-purified, non-isolated, semi-purified, partially purified, or highly purified forms of heme or hemoproteins [e.g., from plants or microorganisms |; cytochromes; porphyrins; other heterocycles [e.g., corrins, chlorins, bacteriochlorophylls, corphins, bacteriochlorin, isobacteriochlorin]; and derivatives thereof. Non-limiting examples of flavour/aroma stabilizers include antioxidants (e.g., ascorbic acid, fruit and/or vegetable extracts with antioxidant properties), pH and/or ionic strength adjusting agents, carbohydrates, chelating agents, agents that form complexes with flavour/aroma agents, salts, formulation aids (e.g., spray-dried carriers or plating carriers for flavour/aroma agents such as maltodextrin, gum acacia, guar gum, xanthan gum, konjac gum, starch, modified starch, fiber, modified fiber, methyl cellulose, ethyl cellulose, hydroxypropyl cellulose, protein, protein flour), and combinations thereof.

“flesh like textured food” As used herein, the term “flesh like textured food” refers to any foodstuff with a mouthfeel or physical sensations in the mouth that resembles flesh (muscle, fat, and connective tissue) of mammalian, poultry or fish or with a food rheology comparable to flesh (muscle, fat, and connective tissue) of mammalian, poultry or fish or it can be an emulsion product that resembles one or more pieces of natural meat in appearance, texture, and physical structure. As used herein, a flesh like textured food includes meat such as poultry, beef, pork, fish and mixtures thereof. A flesh like textured food may optionally additionally include vegetable protein such as gluten to aid in the achievement of the appearance, texture, and physical structure of meat. A “flesh like textured food” also concerns a fish or meat alternative, fish or meat substitute, mock fish or meat, faux fish or meat, imitation fish or meat, or (where applicable) vegetarian fish or meat or vegan fish or meat. Vegan flesh like textured food is also understood to include a food made from non-meats, without other animal products, such as dairy. In that case, protein from animal source, for instance animal meat protein and/or milk protein, is completely absent. A flesh like textured food product thus also concerns a composition in which meat (i.e. skeletal tissue and non-skeletal muscle from mammals, fish and fowl) and meat by-products (i.e., the non-rendered clean parts, other than meat, derived from slaughtered mammals, fowl or fish) are completely absent or it may include extended food products comprising both meat or meat by-products and plant derived foodstuff. The market for meat imitations includes vegetarians, vegans, and non-vegetarians seeking to reduce their meat consumption for health or ethical reasons, and people following religious dietary laws. Flesh like textured foods typically approximate certain aesthetic qualities (such as texture, flavour & appearance).

The term “food product” as used herein refers to any article or entity' that can be consumed (e.g., eaten, drunk, ingested, transported, diffused, injected) by an organism (e.g., animal, human, plant, microbe) as a source of food. As used herein, the term “food”. “food product” or “food composition” may refer to a product or composition that is intended for ingestion by an animal, including a human, and provides at least one nutrient to the animal or human. The present disclosure is not limited to a specific animal. Typically, the “food”. “food product” or “food composition” is any composition, which an animal, preferably a mammal such as a human, may consume as part of its diet. The food product may be, for example, a nutritionally complete formula (for example an infant formula or a clinical nutrition product), a vegan dairy product, a beverage powder, a dehydrated soup, a dietary supplement, a meal replacement, a nutritional bar, a cereal, a confectionery product or a complete and balanced pet food, e.g, dry pet food composition or wet pet food composition.

As used herein, the term “foodstuff” means any material, substance, additive, ingredient with food or feed value or that that can be used as food, feed or that may be added to food or feed.

The term “form” as used herein as a noun refers to the chemical or physical state of an entity or compositional element of the present disclosure. Commonly, the term “form” is used to describe the chemical or physical state of an entity or composition wherein multiple possibilities may exist that require specification. As non-limiting examples, the term “form” may be used to describe shape, configuration, composition, density, dimensions, volume, size, outline, structure, molecular structure, or isomer. The term “form” will be understood to be applicable to descriptions of matter at a molecular, nanoscale, microscale, macroscale and visible size scales, and encompasses both chemical structure properties (e.g., form of a chemical isomer), as well as physical or chemical matter properties (e.g., form of a hamburger patty). Tire term “form” as used herein as a verb means to constitute or to produce, as in to constitute a shape, configuration, arrangement, or composition.

The term “gel” as used herein refers to a colloidal dispersion with semi-solid or solid phase properties. Commonly, a “gel” will refer to a composition of polymer or biomacromolecule network dispersed within a solvent that yields a material with properties ranging from a viscous liquid to semi-solid or solid. Gels can be reversibly or irreversibly formed depending on the specific composition of the gel, and the conditions (e.g., temperature) and environment (solvent, humidity, storage) in which the gel is present. Gels of the present disclosure may comprise lipogels (i.e., gels prepared from a solvent phase that is a lipid), hydrogels (i.e., gels prepared from a solvent phase that is water), organogels (i.e., gels prepared from a solvent phase that is an organic solvent), aerogels (i.e., gels prepared by drying or removal of a liquid phase with limited shrinkage [e.g., <30% shrinkage in the volume of the liquid/air phase during drying] such that the liquid phase is replace with gas phase), or xerogels (i.e., gels prepared by drying or removal of a liquid phase with significant shrinkage during drying—e.g., >30% shrinkage in the volume of the liquid/air phase).

The term “greasiness” as used herein refers to the qualitative perception of an oil like slickness or slipperiness in a food product regardless of the actual amount of oil present in the product. “Greasiness” can be determined and characterized by a human, for instance a human, for instance a human sensory panel.

The term “gumminess” as used herein is the perception of stickiness and chewiness during the chewing and consumption of a food product. The gumminess of a food product can be determined and characterized by a human, for instance a human sensory panel. Gumminess of a test article (e.g., food product) may also be measured or quantified as a TPA parameter that is a parameter calculation that is a product of the TPA parameters hardness and cohesiveness.

The term “hardness” as used herein refers to the perception of the force required to compress a food product between molars during chewing. Hardness of a food product can be determined and characterized by a human sensory-panel. Hardness may also be measured or quantified as a TPA parameter that is a parameter calculation from the maximum force of the first compression of the food product in either a TPA assay or the compression assay. Variables that can be titrated to modulate the hardness of the meat-like food product provided herein include but are not limited to lipid content, structured protein products with different densities, moisture content, and binding agents with different viscoelastic properties, and pH. To normalize for differences among samples and instrument settings, the term “standardized hardness value” TPA parameter may be used that is the maximum force needed to compress a sample with dimensions of 4 cm diameter and 2 cm thickness on a commercial texture analyser (e.g., Shimadzu EZ-LX Texture Analyser) using a 1 kilo Newton load cell, compression speed at 5 mm/min, a 116 mm diameter compression probe, and a temperature of 21° C., or a Lloyd Instruments/Ametek LS1 with 116 mm diameter aluminium compression plate fixed on the load cell and a base table. The to be tested sample is pressed between the compression plate and the base table and variable parameters are measured and analysed using the Nexygen+4.1. software package.

The terms “including”, ““includes,” “having.” “has,” “with,” or variants thereof are intended to be inclusive but not limiting in a manner similar to the term “comprising”.

The term “juiciness” as used herein refers to the sensation of liquid present in the mouth during chewing and consumption of a food product. Juiciness can be determined and characterized by a human, for instance a human sensory panel. Juiciness may depend on the water and lipid content of a food product and may be quantified by the ratio between the mass of extracted juice and the mass of the cooked sample prior to juice extraction. This ratio, expressed as a percentage is called the “% Juice Cooked Mass” or ‘“JCM”. Another quantitative definition for juiciness is the “oil/water volume” (“OWV”) of the extracted juice, which is the ratio between the extracted oil volume and the extracted water volume. Variables that can be titrated to modulate the juiciness of the meat-like food product provided herein include but are not limited to lipid content and binding agents.

The term “lipid” as used herein refers to a class of organic compounds that are characterized by having limited or no solubility in water. Non-limiting examples of lipids include fats, oils, fatty acids, fatty acid derivatives, fatty acid esters, four-carbon and longer organic alcohols (e.g., butanol, butenol, pentanol, hexanol, etc.), four-carbon and longer organic aldehydes (e.g., butanal, butenal, pentanal, hexanal, etc.), natural oils, waxes, steroids, sterols, phytosterols, glycerides, monoglycerides, diglycerides, triglycerides, phospholipids, phosphatides, choline derived lipids, cerebrosides, hydrocarbons, and some fat-soluble vitamins (e.g., vitamins A. D. E and K). As used herein, a lipid either may refer to a single organic compound or to a mixture of organic compounds that are lipids as commonly observed in sources of lipids used in foods (e.g., canola oil is a lipid that comprises linoleic acid lipid, linolenic acid lipid, oleic acid lipid, etc.). Lipids are added to the vegan food composition in the form of liquid or semi-liquid glyceride shortening from synthesis, or other sources of Archaeplastida origin such as plants, fungi, bacteria or algae. The glycerides could potentially contain unsaturated or saturated long chain acyl radicals ranging from 12 to around 22 carbon atoms. Plant-based lipid sources such as soybean oil, olive oil, canola oil, and others alike are usually used. A food oil concerns such liquid or viscous liquid form of such lipids.

As used herein, the term “fat” refers to any of a group of esters of glycerol and various fatty acids, which are solid at room temperature such as triacylglycerides or triglycerides formed by the esterification reaction of long chain-, medium chain- or short chain-fatty acids with glycerol, a trihydroxy alcohol, or a mixture thereof, in any of solid, liquid or suspension forms, regardless of whether they are obtained from natural plant, fungi, bacteria or algae sources or are made synthetically, so long as they are safe for consumption by mammals, particularly humans.

The term “loaf” as used herein refers to a food product that has been shaped, molded, or formed into a contiguous block of any shape, including either uniform, geometric, non-uniform, or non-geometric dimensions. As used herein, the term “loaf most commonly refers to a form of ground meat products (e.g., ground beef, ground turkey, ground pork) that have been formed into blocks or oblong shaped blocks of meat.

The term “malleability” as used herein refers to the property of a food product to be shaped into various forms without breaking. Variables that can be titrated to modulate the malleability of the meat-like food product provided herein include but are not limited to lipid content, structured protein products with different densities, moisture content, and binding agents with different viscoelastic properties, and pH.

The term “meat” as used herein refers to an edible tissue comprising or characterized by the presence of protein. For the purposes of this disclosure, “meat” will be understood to be of animal origin unless expressly stated otherwise (e.g., a meat-like food product of plant origin may also be characterized as meat if expressly stated).

The term “meat-like” as used herein refers to resemblance to meat. “Meat-like” more particularly refers to a food product that mimics, resembles or performs in a manner similar to an animal-derived meat product in any one or more physical or sensory factors, including pertaining to appearance, taste, texture, mouthfeel (moistness, chewiness, fattiness etc.), aroma, or other physical properties, including structure, texture, storage, handling, and/or cooking.

The term “meat-structured protein product” as used herein refers to a material that comprises a protein network and/or aligned protein fibers that produce meat-like textures. A “meat-structured protein product” with a protein network and/or aligned protein fibers may be further assembled into structures with uniform, non-uniform, irregular, polymorphous, or nanofibrillar arrangements of protein fiber. Accordingly, “meat-structured protein products” may comprise fibrillar protein products, flake-like protein products, sheet-like protein products, spherical-like protein products, or any other form of protein products. Protein fiber networks and/or protein fiber alignments may impart cohesion and firmness whereas open spaces in the protein fiber networks and/or protein fiber alignments may tenderize the meat-structured protein products and provide pockets for capturing water, carbohydrates, salts, lipids, flavour/aroma agents, and other materials that are slowly released during chewing to lubricate the shearing process and to impart other meat-like sensory characteristics. A “meat-structured protein product” of the present disclosure may be prepared using any process or equipment of the art, including non-limiting examples such as from a protein dough after application of mechanical energy (e.g., spinning, agitating, shaking, shearing, pressure, turbulence, impingement, confluence, beating, friction, wave), extrusion, shear-cell processing, radiation energy (e.g., microwave, electromagnetic), thermal energy (e.g., heating, steam texturizing), enzymatic activity (e.g., transglutaminase activity), chemical reagents (e.g., pH and/or ionic strength adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous and/or aligned structure (e.g., by rapid temperature and/or pressure change, rapid dehydration, chemical fixation, redox), and optional post-processing after the fibrous and/or aligned structure is generated and fixed (e.g. hydrating, marinating, drying, colouring). Methods for determining the degree of protein fiber network formation and/or protein fiber alignment are known in the art and include visual determination based upon photographs and micrographic images, as exemplified in U.S. patent publication number 20150296834 published Oct. 22, 2015.

The term “melted lipid release” as used herein refers to the lipid that is in a melted form and separated from the bulk food product during cooking (e.g., lipid that is present on the cooking surface during or after cooking or lipid that is present on the food product during or after cooking).

The term “modified” as used herein refers to a changed property that makes it different from a native or naturally occurring state. As used herein, an agent, chemical compound, substance, material, ingredient, protein, lipid, carbohydrate, plant, animal, fungus, bacteria, organism, or meat-like food product may be “modified” through various means or methods, including non-limiting examples such as mutated, genetic engineering, transfection, crossbreeding, chemical modification, biochemical modification, enzymatic modification, altered growing conditions and medium, or transplanting to different growth environments.

The term “modified plant butter” as used herein refers to sal butter that has been altered in composition (e.g., fractionated, enriched in a chemical compound, lessened in a chemical compound, purified, mixed with a chemical compound additive), chemical structure (e.g., via chemical synthesis, semi-synthesis, biochemical synthesis, enzymatic synthesis, or bioengineering), physicochemical properties, functional properties, and/or material properties (e.g., texture profile, hardness, crystal structure, crystal form, melting point, viscosity) beyond the scope allowed for variation in the plant butter obtained by standard processes. The term “plant butter” as used herein is a an oil of plant origin with a melt/freeze point temperature above 25° C., for instance cocoa butter, Illipe butter, Kokum butter, Ucuuba butter, Cupuaçu butter, Sal butter, Bacuri butter, Kpangnan butter, Mango butter, Murumuru butter, Tucuma butter, Shea butter, Shea Nilotica butter or Kombo butter.

The term “moisture content” and its acronym “MC” as used herein refer to the amount of water present in a test article or composition of the present disclosure (e.g., an agent, compound, material, substance, ingredient, protein, carbohydrate, lipid, meat-structured protein product, or meat-like food product). Commonly, “moisture content” may be calculated as percentage change in mass following the evaporation of water from a sample.

The term “mouthfeel” as used herein refers to the overall perception and sensory experience of a food product in the mouth during chewing and consumption, which stems from the combination of many characteristics (e.g., texture, chewiness, cohesiveness, malleability, density, hardness, springiness, elasticity, juiciness, dryness, shape, particle size, graininess, fattiness, moistness) that culminate to provide a sensory experience. The “mouthfeel” of a food product can be determined and characterized using a panel of human sensory experts.

The terms “optional” or “optionally” mean that the feature or composition may or may not be present, or that an event or circumstance may or may not occur, and that the description includes instances in which a particular feature or composition is present and instances in which the feature or composition is absent, or instances in which the event or circumstance occurs and instances in which the event or circumstance does not occur.

The term “origin” as used herein refers to a source and includes sources that are subsequently derived through any possible method, process, or change (e.g., in a non-limiting example, a meat-structured protein product of a plant origin would mean that the meat-structured protein product was ultimately derived from a plant and not necessarily taken directly from a plant). As used herein, commonly the term “origin” is used to describe or characterize the source of an entity, including agent, compound, substance, ingredient, mixture, protein, carbohydrate, lipid, natural product, organism, plant, animal, fungus, or bacteria, or meat-like food product, so as to indicate where how the entity was obtained.

As used herein, the term “package” is meant to include any pre-portioned foodstuff within an enclosing packaging soft or rigid, for instance a bag, box or cartridge, of any material, in particular an airtight packaging, e.g. plastic, aluminium, recyclable and/or biodegradable packaging, and of any shape and structure.

The terms “pH and/or ionic strength adjusting agent” as used herein refers to an agent or compound that raises or lowers the pH and/or the ionic strength of a solution. For example, in water the pH and/or ionic strength adjusting agent can have an acidic (less than seven in water) pH (“acidic pH and/or ionic strength adjusting agent”) or a basic (more than 7 in water) pH (“basic pH and/or ionic strength adjusting agent”). A pH and/or ionic strength-adjusting agent can be characterized by a dissociation constant (i.e., acid dissociation constant Ka and base dissociation constant Kb) and pH can be measured by methods known in the art, including but not limited to use of a pH meter, a pH strip, a colorimetric kit, conductance, total dissolved solids, or titration.

As used herein, the term “plasticizer” refers to a compound that increases the plasticity or fluidity of the material to which it is added. Typically, the plasticizer of the invention is a “food grade plasticizer” which is a plasticizer approved to be used in foods. Advantageously, the plasticizer is a non-aqueous plasticizer; typically, said plasticizer has a water content of less than 20% (w/w). Advantageously the plasticizer may be a polyhydroxy alcohol (such as glycerol, sorbitol, ethylene glycol, polyethylene glycol propyleneglycol, butanediol, polyethyleneglycol and mixture thereof), a starch hydrolysate (such as a glucose syrup), a carboxylic acid and mixture thereof.

The terms “pptr”, “ppb”, “ppm”, “ppt” and “pph” as used herein refer to parts per trillion (pptr), billion (ppb), million (ppm), thousand (ppt) and hundred (pph) respectively.

The term “precursor” as used herein refers to a molecule, agent, or composition that can chemically react, transform, or interact with another molecule to produce a different molecule, agent, or composition. In certain contexts of the present disclosure, a “precursor flavour” or “precursor molecule” represents a flavour or molecule that reacts, transforms, or interacts with another molecule to give a product flavour or molecule that will impart a meat-like property to a food product.

As used herein, the term “processed food” refers to a food, which is significantly modified from its natural state, as by mechanical alteration (such as grinding or chopping), combination with other food products or additives, and/or cooking. As used herein. “processed food” excludes foods, which substantially maintain their natural state after processing. For example, fresh produce may be washed, sorted, coated or treated, and packaged, but remain substantially in its natural state after processing, and would not be considered a “processed food” for the purpose of this disclosure. A “processed food” also refers to an extract of food. The “extract” refers to the resultant solid or liquid material from an extraction. Indeed, an extract obtained from animal origins (such as meat or fish) or vegetal origins, such extract may be soluble or insoluble carbohydrates, proteins, fibres, fat, or combinations thereof. The processed food may comprise oil or fat particles, and particularly preferred is vegetable oil or fat, especially that used in the form of sunflower oil. The processed food may also comprise particles of an inorganic salt. Calcium or magnesium salts are preferred. The processed food may comprise an insoluble material, for example an insoluble organic or inorganic salt.

The term “food additives” preferably includes agents, starches, polysaccharides, binding agents, flavour/aroma agents, color agents, protein, lipid, sal butter, sal butter compositions, simulated meat flavourings such as pork flavour, pepperoni flavour, smoke powder, chicken flavour, beef flavour, seafood flavour, savoury flavourings (e.g., onion, garlic), vitamins (such as vitamins B12) and mixtures thereof.

The term “protein type” as used herein refers to any defining characteristic of a protein, including the origin of the protein (e.g., plant origin, fungal origin, or animal origin), or a physicochemical property of the protein (e.g., soluble or non-soluble), and the type of processing applied to a protein (e.g., texturized, dehydrated, hydrated).

The term “protein” as used herein refers to a macromolecule comprising a polymeric form of amino acids of any length, or any chemically modified (e.g. post-translationally, microbially, enzymatically, synthetically) macromolecule comprising a polymeric form of ammo acids or ammo acid derivatives of any length. As used herein, proteins can be of synthetic or biological origin, including biosynthetic, bioengineered, and recombinant proteins, or non-natural proteins produced from a biological origin, and may further comprise isolated, fractionated, enriched, purified, and non-purified forms. The term “protein” further encompasses such macromolecules with higher-level organization and folding (i.e., secondary, tertiary, quaternary structures or folds), covalent or non-covalent complexes (e.g., protein-protein complexes, disulphide bridges, protein-organelle complexes, protein lipid complexes, protein polysaccharide complexes, protein DNA or RNA complexes, protein small molecule complexes, protein synthetic material complexes), as well as macromolecules that are partially folded, disordered, unfolded, or otherwise folded in a non-native state (i.e., occurring differently than found in nature). Unless further specified, the term “protein” can be understood to refer to the protein content (i.e., one or more proteins) within any mixture of components without regard to purity of the specified protein in a mixture of components.

The term “resilience” as used herein refers to the perception of how a food product resists changes in shape and structure during chewing and consumption. The “resilience” of a food product can be determined and characterized by a human, for instance a human sensory panel. Resilience may also be measured or quantified as a TPA parameter that is calculated by dividing the upstroke energy of the first compression by the down stroke energy of the first compression.

“sal butter” The term “sal butter” as used herein is synonymous with the terms “sal fat” and “Shores butter” and refers to a mixture of lipids obtained from Shores robusts or a genetic variant thereof (e.g., a variant obtained by breeding or genetic engineering of Shores robusta). The term “sal butter emulsion” as used herein refers to a colloidal mixture derived from immiscible liquids in which one or more liquids (“dispersed phase(s)”) are dispersed in another liquid (“continuous phase”), wherein the emulsion comprises sal butter, and wherein the emulsion may be present in a liquid, semi-solid, or solid state (e.g., by congealing, gelling, drying, or otherwise solidifying the initially formed liquid emulsion).

The term “shelf life” as used herein refers to the duration for which a food product can be stored without specified attributes or characteristics or quality becoming unsuitable for consumption. Accordingly. “shelf life” acceptability may be based on subjective criteria by a human, for instance a human sensory panel.

The term “sizzle” as used herein refers to the sound of hissing, spattering, sputtering, and or crackling sound that is produced when two or more liquids come into contact on a hot surface when one (or more) liquids are hotter than the other liquid(s) boiling point(s). The interaction results in some liquid or liquids quickly boiling, displacing the other liquid or liquids and producing a sound. The sizzle sound of a food product can be measured and quantified by analysing the pitch, timbre, loudness, timing, and other auditory characteristics of audio recordings or spectrograms derived therefrom. Variables that can be titrated to modulate the sizzle sound of the meat-like food product provided herein include but are not limited to lipid content and water content.

As used herein, the term “static heating” refers to a heating step without any stirring or shearing of the dough to be heated. An example of static heating may be oil frying, microwaving, or by using an oven, or a hot plate. Typically, the heating step is carried out at a temperature between 120 to 160° C. during 1 minute to 1 hour, typically. 10 min to 30 mn. The duration of the heating step can be adapted by the man skilled in the art depending on the volume of mixed proteins to be heated.

The term “structure” when used herein as a verb refers to providing order, arrangement, support, or stability to a specified form of matter. The terms “structure” or “structured” when used herein as a noun refers to an entity of the present disclosure (e.g., agent, substance, ingredient, lipid, gel, system, meat-structured protein product, or food product) that is the product of reversible or irreversible changes in chemical, physical, or energy properties. Such changes may be characterized by one or more of the following non-limiting examples: reduced degrees of freedom of molecular motion, reduced molecular motion, increased viscosity of the structured agent, decreased followability, reduced liquid-like phase properties, increased solid like phase properties, increased solid-state packing, reduced entropy, increased molecular order, increased symmetry, increased molecular alignment, increased fibrillar alignment, increased hardness, increased intermolecular interactions, increased intramolecular interactions, increased energetically-stabilizing molecular interactions, or increased melting point.

The term “structuring agent” as used herein refers to an agent that when added to an entity of the present disclosure (e.g., agent, substance, ingredient, lipid, gel, system, meat structured protein product, or food product) confers structure to the resulting composition. Commonly, a structuring agent will be applied to a bulk material phase, such as a lipid phase, water/aqueous phase, or a material phase. In instances where an enzyme is the “structuring agent” for a lipid phase, the term “lipid-structuring enzyme” may be used.

The term “substantially aligned” as used herein refers to an arrangement of protein fibers such that a significant percentage of fibers (i.e., >25%) are contiguous to each other at less than an average 60° angle when viewed in a representative two-dimensional cross section taken parallel to the fiber length. Methods for determining the degree of protein fiber alignment and three-dimensional protein network are known in the art and include visual determination based upon photographs and micrographic images, as disclosed in U.S. Utility application Ser. No. 14/687,803, filed on Apr. 15, 2015.

It should be also noted that the term “substantially free of an ingredient” as provided throughout the specification is intended to mean that the composition, when dried to a water content of 10%, comprises less than about 0.5% by weight, less than about 0.4% by weight, less than about 0.3% by weight, less than about 0.2% by weight, or less than about 0.1% by weight, of an ingredient unless specifically indicated otherwise. In some embodiments, a composition “substantially free of an ingredient comprises less than 0.5% by weight, less than 0.4% by weight, less than 0.3% by weight, less than 0.2% by weight, or less than 0.1% by weight of the ingredient, when the composition has been dried to a 10% water content.

The term “Texture Profile Analysis” and its acronym “TPA” as used herein refer to the evaluation of textural properties of a material by subjecting the material to a controlled force from which a deformation curve of its response is generated.

The term “texture” as used herein refers to mechanical characteristics of a food product that are correlated with sensory-′ perceptions of the food product.

The term “tissue engineered meat” as used herein is synonymous with the term “lab grown meat” and refers to meat that has been created, produced, or engineered through biological processes conducted in non-natural environments such as bioreactors, fermentation chambers, culture chambers, and other biological growth media or containers regardless of scale or size of the growth environment.

The term “uncooked” as used herein refers to not having been healed in preparation for consumption.

The term “use versatility” as used herein refers to the diverse possibilities in which a food product can be prepared or consumed. With reference to animal meat, such possibilities include but are not united to preparing and consuming animal meat in different forms such as meatballs, meat loafs, burgers, or meat sauces.

The term “variants” as used herein refers to a change or deviation from a standard state or form. In the context of this disclosure, a “variant” may further refer to a genetic or phenotypic alternative to naturally occurring organisms, plants, animals, fungi and bacteria.

The term “volume fraction” as used herein refers to a dimensionless quantity that expresses the composition of a mixture by dividing the volume of a constituent of the mixture by the volume of all constituents of the mixture prior to mixing.

The term “glycosyl” as used herein refers generally to any carbohydrate, including monosaccharides, disacchandes, oligosaccharides, and polysaccharides, including stereochemical and anomeric isomers, including either open chain or cyclic carbohydrates. As used herein, the term “glycosyl” may be a chemical substructure or substituent of a molecule, as is often found in glycolipids, glycopeptides, glycosylated small molecules, and glycosylated synthetic molecules.

The term “system” as used herein refers to a composition that is defined, either in empirical or theoretical terms, as being distinct from an environment that the composition of the system occupies.

An “alginate cured respiratory produce” is a respiratory produce where of whereof water is removed by drying, squeeze, pulling, salting out or sucking and that consequently is impregnated by an aqueous liquid with soluble or solubilized alginate or a salts of alginic acid, for instance an alginate salt such as sodium alginate and that consequently is rendered water-insoluble by addition of an aqueous liquid with a divalent ions, preferably the fast action calcium divalent ions for the formation calcium alginate through the addition of aqueous calcium chloride, calcium chloride or calcium lactate.

As used herein, the term “bean curd solid”, refers to a curd solid from bean curd, for instance from soybean, chickpea, lentil, smooth pea, mung bean or faba (fava) bean. This can be prepared by a heat protein denaturation or linearization step and protein coagulating from emulsion and then pressing the resulting curds into a solid. The coagulant aid can be divalent ions for instance from MgSO₄, CaSO₄, CaCl₂, C6H₁₀CaO₆. For present invention, such solid preferably has a medium firmness.

“Carbohydrate sources” may include one or more of sugars, starches, gums, pectins and fibres, and may include monosaccharides, disaccharides, polysaccharides and oligosaccharides and mixtures of two, three or four thereof, and be in any suitable form, such as milled, ground or powdered. The carbohydrate source may be obtained from a single or multiple plant sources. Some suitable examples may include any one, or a mixture of two or more of starch (e.g. potato, rice, wheat, corn, oat, pea, cassava), resistant starch, for example, retrograded starch, high amylose starch (e.g, having at least about 40, 45, 50, 55, 60, 65, 70, 75, 80, 85, 90 or 95% amylose content, such as Hylon V, Hylon VII, Hi-Maize 1043, Hi-Maize 240, Hi-Maize 260, Novelose 330, Novelose, 240, Novelose 260) pectin, fructans (e.g, inulins) beta-glucan, carrageenan (iota, kappa, lambda), maltodextrin, methyl cellulose, alginate, guar gum, xanthan gum, gum carboxymethyl cellulose, locust bean gum, gellan gum, cellulose, hemicellulose, gums, flour (e.g. milled or ground from a grain, legume or tuber, such as wheat, rice, corn, oat, rye, barley, quinoa, amaranth, potato, carrot) and edible fibre such as oat bran, wheat bran rice bran, barley bran corn bran, and carrot fibre. In some embodiments, the carbohydrate source, or the barrel mixture, does not contain, or does not substantially contain (e.g, less than about 5, 4, 3, 2, or 1% (w/w)) an edible fibre. The carbohydrate source may be obtained from the native or naturally occurring plant, or a genetically modified or mutated plant, or mixtures thereof. In still other embodiments, the carbohydrate source may comprise, synthetic (e.g. chemically esterified) or biosynthetically generated monosaccharides, disaccharides, polysaccharides and oligosaccharides molecules. In some embodiments, the carbohydrate source contains a reducing sugar group. i.e. having a free carbonyl group able to participate in reaction with amino groups in the protein source to form Maillard reaction products. The carbohydrates source, for example pectin or starch, or the protein-carbohydrate mixture or blend may be supplemented with additional amounts of one or more reducing sugars (such as one or more mono-di- or trisaccharides or oligosaccharides). Some further examples of reducing sugars, which may be added to the main carbohydrate source or sources, or separately into the extruder mixture, include glucose, galactose, fructose, glyceraldehyde, ribose, xylose, cellobiose, maltose, isomaltose, lactose and maltotriose. In some embodiments, carbohydrate source has been mechanically or chemically treated prior to mixing with the protein source, for example to increase the number of reducing carbonyl groups. Suitable pre-treatment process may include microfluidization, ultrasound treatment or high-pressure extrusion. For example, starch may be mechanically or chemically treated to increase the content of resistant starch, for example, from a low amylose starch, having an amylose content of less than about 25-30%, to an amylose content of at least about 50-80%. In some embodiments the carbohydrate source may be an esterified carbohydrate, such as high methoxy pectin, with about >50% degree of esterification, as well as low methoxy pectin (about <50% degree of esterification, or substituted fatty acids starch esters, e.g. acetylated, propionated or butylated starches with various degrees of substitution. The protein-carbohydrate blend or mixture may contain the protein source and the carbohydrate source in a suitable weight ratio that affords the desired property of the extruded food ingredient. Some examples of protein source: carbohydrate source ratios (w/w) for use in the present disclosure include about 50:50, 55:45, 60:40, 65:35, 70:30, 75:25, 80:20, 85:25, 90:10, 92:8, 94:6, 95:5, 96:4, 98:2. In some embodiments, the protein-carbohydrate blend or mixture is one or more of soy protein liquor, soy protein concentrate, soy protein isolate, pea protein liquor, pea protein concentrate, pea protein isolate and one or more of pectin, gum, starch or fibre, in a protein source: carbohydrate source w/w ratio of about 90:10, 91:9, 92:8, 93:7, 94:6, 95:5, 96:4, 97:3, 98:2 or 99:1. In some further embodiments, the total protein content on a dry weight basis, e.g., of the combined protein and carbohydrate sources, is at least about 70%, or 75% (w/w) protein on a dry weight basis, preferably at least about 80% (w/w) protein, or at least 83-85% (w/w) protein, or at least 90% (w/w) protein, such as about 91% (w/w), or about 92% (w/w), or about 93% (w/w), or about 94% (w/w), or about 95% (w/w), or about 96% (w/w), or about 97% (w/w), or about 98% (w/w), or about 99% (w/w). The present invention provides a ready-to-cook flesh like food product of non-animal origin, this food product comprising the mixing product of preformed encapsulated methylcellulose powder with freeze thaw curd solid and optionally food fat of non-animal origin additionally to the fat in the curd. Alternatively, the present invention provides a ready-to-cook flesh like food product of non-animal origin that essentially consists of the mixing product of preformed encapsulated methylcellulose powder and freeze thaw curd solid and optionally food fat additionally to the fat in the curd. It furthermore provides the process of preparing such flesh like food product. Moreover, the present invention provides the use of such flesh like food product for cooking of a ready-to-cat food product. Moreover, the present invention provides a ready-to-cat flesh like food product of non-animal origin that is a cooked flesh like food product comprising the mixing product of preformed encapsulated methylcellulose powder and freeze thaw curd solid of non-animal origin and optionally food fat of non-animal origin additionally to the fat in the curd. According to the present invention there is also provided that the freeze thaw curd solid is a freeze thaw alginate cured curd solid. In another aspect, the present invention provides that the flesh like food product of non-animal origin does not comprise texturized vegetable protein (TVP) or that it is substantially free of, essentially free of, or free of any of TVP. Moreover, the present invention provides the use of such flesh like food product for the preparation of a ready-to-cat food product. In another aspect, the present invention provides a cooked a ready-to-cat flesh like food product of non-animal origin comprising one of the mixing product mentioned above. The present invention furthermore provides a ready-to-cook flesh like food product of non-animal origin that comprises the mixture product of a least preformed encapsulated methylcellulose powder, food oil and freeze thaw curd solid and such food product that does not comprise texturized vegetable protein (TVP) or that is substantially free of, essentially free of, or free of any of TVP. In another aspect, the present invention provides a process for preparing such ready-to-cook flesh like food product. Moreover, the present invention provides the use of such flesh like food product for the preparation of a ready-to-cat food product. In another aspect, the present invention provides a cooked a ready-to-cat flesh like food product of non-animal origin that comprises the mixing product of a preformed encapsulated methylcellulose powder, and a food oil and freeze thaw curd solid and that does not comprise texturized vegetable protein (TVP) or that is substantially free of, essentially free of, or free of any of TVP. In addition, it furthermore provided the process for preparing such ready-to-cat flesh like food product. The present invention also provides a ready-to-cook flesh like food product of non-animal origin or provided that that it is further heat processed or cooked a ready-to-cat flesh like food product of non-animal origin that is composition comprising the mixing product of a preformed encapsulated methylcellulose powder mixed with a food oil and with a freeze thaw alginate cured curd solid and it furthermore provided the process for preparing such flesh like food product, for instance a proteinaceous flesh like textured food. By using this inventive system, it is possible to provide a ready-to-cat flesh like food product of non-animal origin. It comprises the mixing product of a preformed encapsulated methylcellulose powder mixed, food oil and freeze thaw alginate cured curd solid that is further heated or cooked until it is ready-to-cat. We demonstrated that such ready-to-cook flesh like food product of non-animal origin ready-to-cat flesh like food product of non-animal origin can be prepared without texturized vegetable protein (TVP) or that is substantially free of, essentially free of, or free of any of TVP, and yet holds the springiness, tenderness, chewiness and juiciness of a flesh like texture. In an embodiment, the ready-to-cook flesh like food product of non-animal origin according to the present invention comprises the mixing product of 1) a preformed encapsulated methylcellulose powder mixed and 2) food oil and 3) freeze thaw alginate cured curd solid and this without texturized vegetable protein (TVP) or being substantially free of, essentially free of, or free of any of TVP. It furthermore provides the process for preparing such flesh like food product. It was found that this ready-to-cook flesh like food product of non-animal origin according to the present invention can be cooked into a ready-to-cat flesh like food product with the appeal of a cooked meat or fish. The present invention thus furthermore provides a cooked a ready-to-cat flesh like food product of non-animal origin that is a composition comprising the mixing product of a preformed encapsulated methylcellulose powder mixed with a food oil and with a freeze thaw alginate cured curd solid and such without a texturized vegetable protein (TVP) or being substantially free of, essentially free of, or free of any of TVP. This object of the present invention is achieved by means heating or cooking the ready-to-cook flesh like food product of non-animal origin that comprises the mixing product of 1) a preformed encapsulated methylcellulose powder mixed and 2) food oil and 3) freeze thaw alginate cured curd solid and this without texturized vegetable protein (TVP). This mixing process, here above described, can be hand force mixed, for instance by a gloved hand or a hand that hold a mixing kitchen compliance, or it can be machine mixed, for instance by a kitchen compliance. It was also found that these ready-to-cook flesh like food product of non-animal origin or ready-to-cook flesh like food product of non-animal origin of present invention can furthermore can have in the mixing product also add powders, solutions or powder dispersion of other foodstuff, such as protein, carbohydrate, salt, herbs or aromas and yet not jeopardize the flesh like texture. By using a proteinaceous curd solid and/or adding, proteinaceous in the mixture it is possible by the method of present invention to prepare a proteinaceous flesh like textured food without animal derived ingredients. Such flesh like textured food can be prepared as a proteinaceous food product comprising a protein content more than 10% for instance in the range of 10% to 25%.

As used herein the term “cellulosic material”, refers to a material comprising cellulose or consisting essentially of cellulose, such as methylcellulose.

As used herein, the term “curd solid” refers to a curd shaped, preferably by pressing, in a solid watery mass or it refers to a food prepared by an heat protein denaturation or linearization step and consequent protein coagulating from emulsion, for instance of a pulse or a legume, and then pressing the resulting curds into a solid. The solid curd can take different states of firmness. In an advantageous embodiment, the firmness the curd is medium firm. In an advantageous embodiment, the device according to the present invention such curd has a water content between 65-85%, a protein content between 10-30%, a fat content between 5 and 15%, a carbohydrate content below 2% and a fibre content below 2%. The fat content of such curd can be adjusted before the coagulation process or thereafter before forming it in a solid watery mass. It is for instance obtainable by subjecting flours or protein fractions of pulses such as beans, lentils, and peas or vegetable leaves in water to high speed blending and consequently to a heating step, from, and then pressing the resulted curds into solid curd. The coagulant aid can be divalent ions for instance from MgSO₄, CaSO₄, CaCl₂, C6H₁₀CaO₆.

“Curd”, used in present application, means a precipitate of soluble in protein fat emulsion of a produce or a flour or protein oil fractions such protein fat emulsion, preferably of a non-animal product or of a non-animal food protein. The curd is prepared by coagulating the soluble from a protein oil emulsion. In an advantageous embodiment, the fraction of poorly soluble protein is solubilised, for instance by acid-alkali- and/or heat-induced denaturation and hydrolysis. The curd is further formed by heat coagulated, which process can be aided by addition of crosslinking enzyme, e.g. transglutaminase, or by polyvalent ions, or by pH adjustment to shift away from the isoelectric point of the concerned protein in the emulsion.

The term “fish-like” as used herein refers in more specific manner to resemblance to fish tissue and for instance not mammalian meat. More particularly it refers to a food product that mimics, resembles or performs in a manner similar to a fish-derived meat product in any one or more physical or sensory factors, including pertaining to appearance, taste, texture, mouthfeel (moistness, chewiness, fattiness etc.), aroma, or other physical properties, including structure, texture, storage, handling, and/or cooking.

“Food oil” Food oil is the liquid, usually viscous liquid form of lipids. Some oils suitable for presents invention make up a significant fraction of worldwide edible oil production. Coconut oil is a cooking oil, with medical and industrial applications as well. Extracted from the kernel or meat of the fruit of the coconut palm. Common in the tropics and unusual in composition, with medium chain fatty acids dominant. Corn oil is one of the principal oils sold as salad and cooking oil. Canola oil is the most sold cooking oil all around the world, used as a salad and cooking oil, both domestically and industrially. Also used in fuel industry as bio-fuel. Cottonseed oil is used as a salad and cooking oil, both domestically and industrially. Olive oil is used in cooking, cosmetics, soaps, and as a fuel for traditional oil lamps. Palm oil is the most widely produced tropical oil. Popular in West African and Brazilian cuisine. Also used to make biofuel. Peanut oil (Groundnut oil) is a clear oil with some applications as a salad dressing, and, due to its high smoke point, especially used for frying. Rapeseed oil, including Canola oil is one of the most widely used cooking oils. Safflower oil, until the 1960s used in the paint industry is now mostly as a cooking oil. Sesame oil is cold pressed as light cooking oil or hot pressed for a darker and stronger flavour. Soybean oil is produced as a by-product of processing soy meal and sunflower oil, a common cooking oil, also used to make biodiesel. Nut oils, which are generally used in cooking for their flavour, are also suitable for present invention. They comprise any one of the following. Almond oil, which is used as an edible oil. Beechnut oil, from Fagus sylvatica nuts, which is a well-regarded edible oil in Europe, used for salads and cooking. Brazil nut oil which contains 75% unsaturated fatty acids composed mainly of oleic and linolenic acids, as well as the phytosterol, beta-sitosterol, and fat-soluble vitamin E. Extra virgin oil can be obtained during the first pressing of the nuts, possibly for use as a substitute for olive oil due to its mild, pleasant flavour. Cashew oil which somewhat comparable to olive oil. Hazelnut oil, which is mainly used for its flavour. Macadamia oil, which has a mild nutty flavour and a high smoke point. Mongongo nut oil (or manketti oil), from the seeds of the Schinziophyton rautanenii, a tree which grows in South Africa and which is high in vitamin E. Pecan oil which is valued as a food oil. Pine nut oil, which is sold as a gourmet cooking oil and where for there is medicinal interest as an appetite suppressant. Pistachio oil, which is a strongly flavoured oil with a distinctive green color. Walnut oil, which is used for its flavour. The seeds yield oils suitable for present invention. Watermelon seed oil, extracted from the seeds of Citrullus vulgaris, which is used in cooking in West Africa. Seeds from the members of the Cucurbitaceae, which include gourds, melons, pumpkins, and squashes, are noted for their oil content, but little information is available on methods of extracting the oil. In most cases, the plants are grown as food, with dietary use of the oils as a by-product of using the seeds as food. Bitter gourd oil, from the seeds of Momordica charantia, which are high in α-Eleostearic acid. Of current research interest for its potential anti-carcinogenic properties. Bottle gourd oil, extracted from the seeds of the Lagenaria siceraria, which are seed as an edible oil. Buffalo gourd oil, from the seeds of the Cucurbita foetidissima and with their a vine with a rank door. Butternut squash seed oil, from the seeds of Cucurbita moschata, which has a nutty flavour and is used for salad dressings, marinades, and sautéing. Egusi seed oil, from the seeds of Cucumeropsis mannii naudin, which is particularly rich in linoleic acid. Pumpkin seed oil, which is a specialty cooking oil, produced in Austria. Slovenia and Croatia and is mostly in salad dressings. Watermelon seed oil, pressed from the seeds of Citrullus vulgaris, which is a traditionally used in cooking in West Africa. Also suitable for present invention are the typical food supplement oils (or “nutraceuticals”), for their nutrient content or purported medicinal effect. For instance borage seed oil, blackcurrant seed oil, and evening primrose oil all have a significant amount of gamma-linolenic acid (GLA) (about 23%, 15-20% and 7-10%, respectively) with positive health effects. This food supplement oils include: Açai oil, from the fruit of several species of the Açai palm (Euterpe) grown in the Amazon region: Black seed oil, pressed from Nigella sativa seeds which has a long history of medicinal use, including in ancient Greek. Asian, and Islamic medicine, as well as being a topic of current medical research; Blackcurrant seed oil, from the seeds of Ribes nigrum, which is used as a food supplement and which is high in gamma-linolenic, omega-3 and omega-6 fatty acids; Borage seed oil, from the seeds of Borago officinalis; Evening primrose oil, from the seeds of Oenothera biennis which the most important plant source of gamma-linolenic acid, particularly because it does not contain alpha-linolenic acid: Flaxseed oil (called linseed oil when used as a drying oil), from the seeds of Linum usitatissimum which is high in omega-3 and lignans and which can be used medicinally. A good dietary equivalent to fish oil. Easily turns rancid. Other edible oils suitable for present invention are the following: Amaranth oil, from the seeds of grain amaranth species, including Amaranthus cruentus and Amaranthus hypochondriacus, which are high in squalene and unsaturated fatty acids. Apricot oil, similar to almond oil, which it resembles. Apple seed oil, which are high in linoleic acid. Argan oil, from the seeds of the Argania spinose, which is a food oil from Morocco. Avocado oil which is an edible oil used primarily in the cosmetics and pharmaceutical industries and which has an unusually high smoke point of 266° C. Babassu oil, from the seeds of the Attalea speciosa, which is similar to, and used as a substitute for, coconut oil. Ben oil, extracted from the seeds of the Moringa oleifera which is high in behenic acid and an extremely stable edible oil. Borneo tallow nut oil, extracted from the fruit of species of genus Shorea which is used as a substitute for cocoa butter, for instance under the form of sal butter, or Illipe butter. Cape chestnut oil, also called yangu oil. Carob pod oil (Algarroba oil), from carob, with an exceptionally high essential fatty acid content. Cocoa butter (also known as Theobroma oil) from the cacao plant, which is used in the manufacture of chocolate. Cocklebur oil, from species of genus Xanthium, with similar properties to poppy seed oil, similar in taste and smell to sunflower oil. Cohune oil, from the Attalea cohune (cohune palm). Coriander seed oil, from coriander seeds, which used in a wide variety of flavouring applications and has shown promise for use in killing food-borne bacteria, such as E. coli. Date seed oil, extracted from date pits. Its low extraction rate and lack of other distinguishing characteristics make it an unlikely candidate for major use. Dika oil, from Irvingia gabonensis seeds, native to West Africa, which is used to make margarine. False flax oil made of the seeds of Camelina sativa considered promising as a food or fuel oil. Grape seed oil which is used for cooking and salad oil. Hemp oil, a high quality food oil. Kapok seed oil, from the seeds of Ceiba pentandra, used as an edible oil.—Kenaf seed oil, from the seeds of Hibiscus cannabinus, which is an edible oil similar to cottonseed oil, with a long history of use. Lallemantia oil, from the seeds of Lallemantia iberica, discovered at archaeological sites in northern Greece. Mafura oil, extracted from the seeds of Trichilia emetic and used as an edible oil in Ethiopia. Marula oil, extracted from the kernel of Sclerocarya birrea and used as an edible oil with a light, nutty flavour and with a fatty acid composition is similar to that of olive oil. Meadow foam seed oil, which is highly stable oil, with over 98% long-chain fatty acids. Mustard oil (pressed) which is used in India as a cooking oil. Niger seed oil which is obtained from the edible seeds of the Niger plant, which belongs to the genus Guizotia of the family Asteraceae. Okra seed oil, from Abelmoschus esculentus. Composed predominantly of oleic and linoleic acids. The greenish yellow edible oil has a pleasant taste and door. Papaya seed oil, which is high in omega-3 and omega-6, similar in composition to olive oil. Perilla seed oil, which is high in omega-3 fatty acids and is used as an edible oil. Persimmon seed oil, extracted from the seeds of Diospyros virginiana with its dark, reddish-brown color, similar in taste to olive oil. Nearly equal content of oleic and linoleic acids. Pequi oil, extracted from the seeds of Caryocar brasiliense and used as a highly prized cooking oil. Pili nut oil, which is extracted from the seeds of Canarium ovatum and is as an edible oil. Pomegranate seed oil, from Punica granatum seeds, which is very high in punicic acid. Poppy seed oil, which is already long used for cooking. Pracaxi oil, extracted from the seeds of Pentaclethra macroloba, which is similar to peanut oil, but has a high concentration of behenic acid. Prune kernel oil, which marketed as a gourmet cooking oil. Quinoa oil, similar in composition and use to corn oil. Ramtil oil which is pressed from the seeds of the one of several species of genus Guizotia abyssinica (Niger pea). Rice bran oil which is a highly stable cooking and salad oil, suitable for high-temperature cooking.—Royle oil, pressed from the seeds of Prinsepia utilis. Sacha inchi oil, from the Peruvian Amazon, which is high in behenic, omega-3 and omega-6 fatty acids. Sapote oil, which used as a cooking oil in Guatemala. Seje oil, from the seeds of Jessenia bataua which is used in South America as an edible oil, similar to olive oil, as well as for soaps and in the cosmetics industry. Shea butter, which is used as a substitute for cocoa butter. Terramara oil, from the seeds of the arugula (Eruca sativa), which is used as a (pungent) edible oil after aging to remove acridity. Tea seed oil (Camellia oil), which is widely used as a cooking oil. Thistle oil, pressed from the seeds of Silybum marianum, which is a good source of special fatty acids, carotenoids, tocopherols, phenol compounds and natural anti-oxidants, as well as for generally improving the nutritional value of foods. Tigernut oil (or nut-sedge oil) which is pressed from the tuber of Cyperus esculentus, which has the properties similar to soybean, sunflower and rapeseed oils and is used in cooking. Tobacco seed oil, which is from the seeds of Nicotiana tabacum and other Nicotiana species and which is edible if purified. Tomato seed oil, generally from the waste seeds generated from processing tomatoes and which is used as a cooking oil. Wheat germ oil, which is high in vitamin E and octacosanol. Beside cocoa butter, other plant butters useful, because of their melt point, for flesh like texture food are op the group consisting Illipe nutter, Kokum nutter, Ucuuba butter, Cupuaçu butter, Sal butter, Bacuri butter, Kpangnan butter, Mango butter, Murumuru butter, Tucuma butter, Shea butter, Shea Nilotica butter and Kombo butter.

As used herein, the term “freeze thaw alginate cured curd solid” refers to a freeze thaw curd solid that has been impregnated by divalent ion cross-linked alginate, such as calcium alginate or magnesium alginate or that comprises divalent ion cross-linked alginate, such as calcium alginate or magnesium alginate. A freeze thaw alginate cured curd solid is obtainable from a freeze thaw curd solid or freeze thaw curd solid whereof water has been removed by drying, squeeze, pulling, salting out or sucking is impregnated by an aqueous liquid with soluble or solubilized alginate or a salts of alginic acid, for instance an alginate salt such as sodium alginate and that consequently is rendered water-insoluble by addition of an aqueous liquid with a divalent ions, preferably the fast action calcium divalent ions for the formation calcium alginate through the addition of aqueous calcium chloride, calcium chloride or calcium lactate.

As used herein, the term “freeze thaw curd solid”, refers to a solid curd whereby the formation of the water phase into ice crystals or ice nucleation of water therein has been induced, for instance by freezing, preferably at a slow freezing rate, and consequently the ice crystals are transformed to fluid, preferably liquid, for instance by thawing. Part or most of the water is removed by heating, drying or pressing.

As used herein, the term “ice nucleating agent” or “ice nucleator” refers to compounds, particles or surfaces that can promote ice formation, and initiate ice nucleation at a higher temperature when they are added into aqueous systems. As the purpose of the ice nucleating agents is to promote ice formation, the ice-nucleating agent does not include random or environmental contaminants, e.g., dust or soot. When an ice-nucleating agent is added to water, the ice nucleation temperature will increase as a result. While the precise manner in which an ice-nucleating agent accomplishes nucleation is not well understood, it is generally believed that ice-nucleating agents organize water molecules in an ice like fashion, creating water molecule aggregates that are sufficiently large to nucleate at relatively higher temperatures. The ice-nucleating agent can effectively promote ice formation. In some embodiments, the ice nucleating agent in a sufficient amount can increase the ice nucleation temperature by at least 1° C., 2° C., 3° C., 4° C., 5° C., 6° C., 7° C., 8° C., 9° C., 10° C., 11° C., 12° C., 13° C., 14° C., 15° C. 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., or 38° C. In some embodiments, the ice-nucleating agent in a sufficient amount can increase the ice nucleation temperature to over −10° C., −9° C., −8° C., −7° C., −6° C., −5° C., −4° C. . . . 3° C., −2° C., or −1° C. In some embodiments, the sufficient amount refers to 0.001 mg, 0.005 mg. 0.01 mg. 0.05 mg. 0.1 mg. 0.5 mg, 1 mg. 5 mg, or 10 mg that are tested in 0.5 ml, 1 ml, or 1.5 ml pure water. Thus, in some embodiments. 0.01 or 0.1 mg of the ice-nucleating agent as described herein can increase ice nucleation temperature of 0.5 ml pure water to over −6° C., or −5° C. It comprises nucleation protein (INP) from ice nucleation active (INA) bacteria capable of catalyzing the formation of ice crystals, such as InaZ from Pseudomonas syringae (U.S. Pat. No. 6,151,902) or nucleation protein InaV from Pseudomonas syringae. FEBS Letters. 414 (3), 590-594 and INA a select number of bacteria including Pseudomonas fluorescens, Pseudomonas viridiflava, Pseudomonas chlorooraphis, Pseudomonas putida and Pseudomonas antarctica, Panteola agglomerans, Erwinia herbicola, Erwinia ananas, Erwinia uredovrora, Xanthomonas campestris pv. translucens, and Xanthomonas campestris, (Maki, L. R., et al. Applied Microbiology. 28:456-459; Arny, D. C., et al., Nature 262:282-84; Lindow S. E. et al. (1978a). Applied Environmental Microbiology 36:831-838; Lindow S. E. D. C. Arny and C. D. Upper (1978b) Phytopathology 68:523-527; Kaneda, T. (1986). Applied Environmental Microbiology 52:173-178; Newton, D., and A. C. Haward (1986). Australasian Plant Pathology 15:71-73; Kim, H. K., et al. Plant Disease 71:994-997; and Obata, H., et al. Cryobiology 38:131-139).

As used herein, the term “legume curd solid”, refers to a curd solid from a legume (plant in the family Fabaceae (or Leguminosae), for instance of the group consisting of Phaseolus, Pisum, Vigna, Cajanus, Lens, Cicer, Vicia, Arachis, Glycine, Macrotyloma, Mucuna, Lupinus, Ceratonia, Canavalia, Cyamopsis, Lablab, Psophocarpus, Clitoria, Lathyrus, Trifolium, Medicago, Melilotus and Tamarindus.

“Meat-like” refers to a food product that mimics, resembles or performs in a manner similar to an animal-derived meat product in any one or more physical or sensory factors, including pertaining to appearance, taste, texture, mouthfeel (moistness, chewiness, fattiness etc.), aroma, or other physical properties, including structure, texture, storage, handling, and/or cooking.

“Methylcellulose (MC)” is a methyl ester of cellulose that preferably contains 27.5-31.5% of the methoxy groups. MC is soluble in water, and its aqueous solution exhibits thermal gelation properties. A wide range of viscosity grades (5-75,000 cP at 2%) corresponding to average molecular weight range of 10,000-220,000 Da are available commercially. A typical structure of MC with DS value of 1.75 corresponding to 29.1 wt. % methoxyl content. A preferred methylcellulose suitable for the use according to present invention has a viscosity at 10 S⁻¹ (at 5° C.) in mPa·s for c=2% in the range of 19,000-25,000 and a degree of substitution (D.S.) or average number of substituent groups attached to the ring hydroxyls of 1.4-1.95. Another preferred methylcellulose suitable for the use according to present invention has 2% aqueous viscosity at 20° C., in mPa·s for c=2% in the range of 82,500-154,000 and a degree of substitution (D.S.) or average number of substituent groups attached to the ring hydroxyls of 1.5-1.9. The methylcellulose has preferably a Methoxy (methoxy group; MeO) substitution of 27-32%. Blends of such methylcellulose with different characteristics can made and also fall under the term “Methylcellulose” as used herein.

As used herein, the term “non-animal food protein” refers to protein that is not derived from animals. It can refer to protein that is from cereal such as wheat, corn, barley, oats or rice or protein from pseudocereals such as amaranth, quinoa, buckwheat or chia or protein from legumes or their pulses such as pea, soybeans, faba beans, lupins or lentils or protein from tubers such as cassava (Manihot esculenta Crantz), yam (Dioscorea spp.), sweet potato (Ipomoea batatas L.), potato (Solanum spp.) and edible aroids (Colocasia spp, and Xanthosoma sagittifolium) or protein from oilseeds such as rapeseed, cottonseed, peanut, sunflower and hemp seed or fungal or algal protein from edible fungi or algae.

As used herein, the term “non-animal product” refers to a product-comprising foodstuff that is not derived from animals. Such foodstuff can be of Archaeplastida origin, including photoautotrophic red algae, green algae, land plants or of macroalgae origin, including the Chlorophyta (green algae), Phacophyceae (brown algae), Phacothamniophyceae, Chrysophyceae (gold algae) or Cyanobacteria, or of the fungal origin, for instance yeasts or mushrooms.

As used herein, the term “pea”, refers to a legume or a pulse from the Pisum species for instance of the group consisting of Pisum sativum arvense (field pea). Pisum sativum elatius (wild pea) or Pisum sativum macrocarpon (sugar pea).

As used herein. “protein concentrate” refers to the powder form, containing less than 80% by weight protein on a dry weight basis, for example, about 65%, 68-70% or 72-73% or about 75%, by weight protein.

The term “protein dough” as used herein refers to a blend of dry ingredients comprising a protein (e.g., a “dry mix”; protein flours, protein concentrates, proteins isolates, synthetic protein, recombinant protein, or dried protein extract) and liquid ingredients (“liquid mix”: e.g., water or juice, and all other ingredients added with water or juice) from which a meat-structured protein product is produced through the application of mechanical energy (e.g. Spinning, agitating, shaking, shearing, pressure, turbulence, impingement, confluence, beating, friction, wave), radiation energy (e.g., microwave, electromagnetic), thermal energy (e.g., heating, steam texturizing), enzymatic activity (e.g., transglutaminase activity), chemical reagents (e.g., pH adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous structure (e.g., by rapid temperature and/or pressure change, rapid dehydration, chemical fixation, or change in redox state).

As used herein. “protein isolate” refers to the powder form, containing at least 80% weight protein on a dry weight basis, for example about 81, 82, 83, 84, 85, 86, 87, 88, 89, 90, 91, 92, 93 94 or 95% weight protein. For instance, an example of process of generating protein isolate is extracting the protein from the soybeans starts with the dehulling, or decortication of the seeds. The seeds are then treated with solvents such as hexane in order extract the oil from them. The oil-free soybean meal is then suspended in water and treated with alkali to dissolve the protein while leaving behind the carbohydrates. The alkaline solution is then treated with acidic substances in order to precipitate the protein, before being washed and dried. The removal of fats and carbohydrates, results in a product that has a relatively neutral flavour. The protein source may be obtained from a native or naturally occurring plant, or a genetically modified or mutated plant, or mixtures thereof. In still other embodiments, the protein source may comprise synthetic or biosynthetically generated protein or polypeptide molecules. In some preferred embodiments, the protein source, whether a single protein source or a mixture of protein sources, has an overall protein content of at least 70% (w/w) protein on a dry weight basis, such as at least about 71, 72, 73, 74, 75, 76, 77, 78 or 79% (w/w) protein. In further embodiments, the overall protein content of the protein source is at least 80% (w/w) protein on a dry weight basis, such as at least about 81, 82, 83, 84, 85, 86, 87, 88, 89 90, 91, 92, 93, 94, or 95% (w/w). In some embodiments, the protein source consists of or comprises a protein liquor.

As used herein. “protein liquor” refers to an aqueous protein concentrate slurry obtained from the protein extraction or fractionation process

Some examples of “protein sources” for the food composition of present application include pea protein liquor, pea protein concentrate, pea protein isolate (PPI), soy protein liquor, soy protein concentrate, soy protein isolate, faba (fava) bean protein liquor, faba (fava) bean protein concentrate, faba (fava) bean protein isolate, lupine protein liquor, lupine protein concentrate, lupine protein isolate. Other protein sources may include those obtained (e.g, in dry powder or liquor form) from nuts, seeds, vegetables and beans, algae, and microbial and fungal sources, e.g., peanuts, potato, rice, hemp, sunflower, flaxseed, wheat, corn, sorghum, chickpea, barley, quinoa, maca, and fungal protein from Fusarium Venenatum. In some embodiments, one or more proteins sources may be hydrolysed. In some embodiments, one or more protein sources may be non-hydrolysed. Soy protein is considered a “complete protein” as it contains all of the essential amino acids that are crucial for proper human growth and development and therefore mainstream used in vegan food products. Plant derived protein sources can be obtained by various means that may include dehulling and milling the beans or legumes to afford a flour or flakes, and subsequent extraction and/or precipitation steps to substantially fractionate the oils and fats, carbohydrate and protein components, to afford an extract or liquor concentrate in aqueous slurry form, comprising the protein fraction. Subsequent drying (e.g. spray drying) of the extract or liquor affords a powder form of the protein fraction, which may be referred to as a protein concentrate or protein isolate, depending on the protein content as discussed below. In some embodiments the protein source consists of or comprises a dry powder protein concentrate or protein isolate.

“pulse curd solid” As used herein, the term “pulse curd solid”, refers to a curd solid from a pulse or pulses, the seeds or fruits from a legume (plant in the family Fabaceae (or Leguminosae), for instance of the group consisting of beans, soybeans, peas, chickpeas, peanuts, lentils, lupines, mesquite, carob, tamarind, alfalfa, and clover.

As used herein, the term “ready-to-cook food product” or “ready-to-cook food product” refers to a hydrated food (for instance having more than 50% (w/w) water content, between 60 to 70%, preferably 62 to 68%, more preferably 65% of water content) and has a flesh like textured already before subjecting it to cooking.

As used herein, the term “ready-to-cook proteinaceous food product” or “ready-to-cook proteinaceous food product” refers to a hydrated proteinaceous food (for instance having more than 50% (w/w) water content, between 60 to 70%, preferably 62 to 68%, more preferably 65% of water content) and has a flesh like textured already before subjecting it to cooking.

As used herein, the term “ready-to-eat flesh like textured food” refers to a flesh like textured food which can be eaten as is.

As used herein, the term “ready-to-cat food product” refers to a hydrated flesh like textured food (for instance having more than 50% (w/w) water content, between 60 to 70%, preferably 62 to 68%, more preferably 65% of water content) and optionally cooked foodstuff (for instance with the same procedure such as meat e.g. at a temperature between 30 to 200° C. during 1 minute to 1 hour) or a foodstuff comprising a hydrated and optionally cooked (with the same procedure such as meat e.g. at a temperature between 30 to 200° C. during 1 minute to 1 hour).

As used herein, the term “ready-to-mix food product” or “ready-to-mix food form” refers to a premix of “foodstuff” ready to be mixed with cold water <5° C., or with crushed ice or snow ice to hydrate into a hydrated flesh like textured food (for instance having more than 50% (w/w) water content, between 60 to 70%, preferably 62 to 68%, more preferably 65% of water content) and optionally cooked foodstuff (for instance with the same procedure such as meat e.g. at a temperature between 30 to 200° C. during 1 minute to 1 hour) or a foodstuff comprising a hydrated and optionally cooked (with the same procedure such as meat e.g. at a temperature between 30 to 200° C. during 1 minute to 1 hour).

As used herein, the term “ready-to-mix food proteinaceous form” or “ready-to-mix food proteinaceous product” refers to a premix of proteinaceous foodstuff ready to be mixed with cold water <5° C., or with crushed ice or snow ice to hydrate into hydrated proteinaceous flesh like textured food (for instance having more than 50% (w/w) water content, between 60 to 70%, preferably 62 to 68%, more preferably 65% of water content) and optionally cooked foodstuff (with the same procedure such as meat e.g. at a temperature between 30 to 200° C. during 1 minute to 1 hour) or a foodstuff comprising a hydrated and optionally cooked (for instance with the same procedure such as meat e.g. at a temperature between 30 to 200° C. during 1 minute to 1 hour).

As used herein, the term “ready-to-cat food proteinaceous form” or “ready-to-cat food proteinaceous product” refers to a hydrated proteinaceous flesh like textured food (for instance having more than 50% (w/w) water content, between 60 to 70%, preferably 62 to 68%, more preferably 65% of water content) and optionally cooked foodstuff (with the same procedure such as meat e.g. at a temperature between 30 to 200° C. during 1 minute to 1 hour) or a foodstuff comprising a hydrated and optionally cooked (for instance with the same procedure such as meat e.g. at a temperature between 30 to 200° C. during 1 minute to 1 hour).

As used herein a “container” is an enclosure configured to hold or contain a dry food formulation, a dry food containing enclosure, and can be a structure with or without a lid.

As used herein a “powder mass” is referred to an agglomeration of powder particles or agglomerate having irregular geometries such as width, diameter, and length.

As used herein, the term “ready-to-eat proteinaceous flesh like textured food” refers to a proteinaceous flesh like textured food which can be eaten as is.

A “respiratory produce” is a complete or part (such as organs, tissues) of a living system that has a respiration metabolism. This produce can be from plants, macro-algae or fungi.

As used herein, the term “Textured vegetable protein” or “TVP” refers to a high-protein, porous or fibrous foodstuff typically prepared the heat shear process of extrusion. For example a typical protein ratios of such high protein foodstuff range from 40 to 80% protein and a typical fat content of such foodstuff ranges from five to 12% when the loss on drying is in a range of 8 to 12%. Such TVP can be from a paste of defatted vegetable seeds, such as soy, wheat, oats, or oil seeds or protein isolates or from protein concentrates. Soy TVP, pea TVP and wheat TVP are the most commonly used types, beside the many new TVP in development from other protein rich feedstock of non-animal foodstuff. Typically, such TVP are obtainable from raised temperature shear processes such as by extrusion cooking or in an extrusion for instance twin screw extrusion process.

The protein source may be obtained from a native or naturally occurring plant, or a genetically modified or mutated plant, or mixtures thereof. In still other embodiments, the protein source may comprise synthetic or biosynthetically generated protein or polypeptide molecules.

In some preferred embodiments, the protein source, whether a single protein source or a mixture of protein sources, has an overall protein content of at least 70% (w/w) protein on a dry weight basis, such as at least about 71, 72, 73, 74, 75, 76, 77, 78 or 79% (w/w) protein. In further embodiments, the overall protein content of the protein source is at least 80% (w/w) protein on a dry weight basis, such as at least about 81, 82, 83, 84, 85, 86, 87, 88, 89 90, 91, 92, 93, 94, or 95% (w/w).

In some embodiments, the protein source consists of or comprises a protein liquor. As used herein. “protein liquor” refers to an aqueous protein concentrate slurry obtained from the protein extraction or fractionation process

Carbohydrate sources may include one or more of sugars, starches, gums, pectins and fibres, and may include monosaccharides, disaccharides, polysaccharides and oligosaccharides and mixtures of two, three or four thereof, and be in any suitable form, such as milled, ground or powdered. The carbohydrate source may be obtained from a single or multiple plant sources. Some suitable examples may include any one, or a mixture of two or more of starch (e.g. potato, rice, wheat, corn, oat, pea, cassava), resistant starch, for example, retrograded starch, high amylose starch (e.g, having at least about 40, 45, 50, 55, 60, 65, 70, 75, 80, 85, 90 or 95% amylose content, such as Hylon V. Hylon VII. Hi-Maize 1043, Hi-Maize 240, Hi-Maize 260, Novelose 330, Novelose, 240, Novelose 260) pectin, fructans (e.g, inulins) beta-glucan, carrageenan (iota, kappa, lambda), maltodextrin, methyl cellulose, alginate, guar gum, xanthan gum, gum carboxymethyl cellulose, locust bean gum, gellan gum, cellulose, hemicellulose, gums, flour (e.g. milled or ground from a grain, legume or tuber, such as wheat, rice, corn, oat, rye, barley, quinoa, amaranth, potato, carrot) and edible fibre such as oat bran, wheat bran rice bran, barley bran corn bran, and carrot fibre. In some embodiments, the carbohydrate source, or the barrel mixture, does not contain, or does not substantially contain (e.g, less than about 5, 4, 3, 2, or 1% (w/w)) an edible fibre.

The carbohydrate source may be obtained from the native or naturally occurring plant, or a genetically modified or mutated plant, or mixtures thereof. In still other embodiments, the carbohydrate source may comprise, synthetic (e.g. chemically esterified) or biosynthetically generated monosaccharides, disaccharides, polysaccharides and oligosaccharides molecules.

In some embodiments, the carbohydrate source contains a reducing sugar group. i.e., having a free carbonyl group able to participate in reaction with amino groups in the protein source to form Maillard reaction products. The carbohydrates source, for example pectin or starch, or the protein-carbohydrate mixture or blend may be supplemented with additional amounts of one or more reducing sugars (such as one or more mono-di- or trisaccharides or oligosaccharides). Some further examples of reducing sugars, which may be added to the main carbohydrate source or sources, or separately into the extruder mixture, include glucose, galactose, fructose, glyceraldehyde, ribose, xylose, cellobiose, maltose, isomaltose, lactose and maltotriose.

In some embodiments, carbohydrate source has been mechanically or chemically treated prior to mixing with the protein source, for example to increase the number of reducing carbonyl groups. Suitable pre-treatment process may include micro fluidisation, ultrasound treatment or high-pressure extrusion. For example, starch may be mechanically or chemically treated to increase the content of resistant starch, for example, from a low amylose starch, having an amylose content of less than about 25-30%, to an amylose content of at least about 50-80%. In some embodiments the carbohydrate source may be an esterified carbohydrate, such as high methoxy pectin, with about >50% degree of esterification, as well as low methoxy pectin (about <50% degree of esterification, or substituted fatty acids starch esters, e.g. acetylated, propionated or butylated starches with various degrees of substitution.

The protein-carbohydrate blend or mixture may contain the protein source and the carbohydrate source in a suitable weight ratio that affords the desired property of the extruded food ingredient. Some examples of protein source: carbohydrate source ratios (w/w) for use in the present disclosure include about 50:50, 55:45, 60:40, 65:35, 70:30, 75:25, 80:20, 85:25, 90:10, 92:8, 94:6, 95:5, 96:4, 98:2. In some embodiments, the protein-carbohydrate blend or mixture is one or more of soy protein liquor, soy protein concentrate, soy protein isolate, pea protein liquor, pea protein concentrate, pea protein isolate and one or more of pectin, gum, starch or fibre, in a protein source: carbohydrate source w/w ratio of about 90:10, 91:9, 92:8, 93:7, 94:6, 95:5, 96:4, 97:3, 98:2 or 99:1.

In some further embodiments, the total protein content on a dry weight basis, e.g., of the combined protein and carbohydrate sources, is at least about 70%, or 75% (w/w) protein on a dry weight basis, preferably at least about 80% (w/w) protein, or at least 83-85% (w/w) protein, or at least 90% (w/w) protein, such as about 91% (w/w), or about 92% (w/w), or about 93% (w/w), or about 94% (w/w), or about 95% (w/w), or about 96% (w/w), or about 97% (w/w), or about 98% (w/w), or about 99% (w/w).

The present invention provides a ready-to-cook flesh like food product of non-animal origin or of extended meat product origin or extended seafood product origin (for instance extended fish product origin), this food product comprising the mixing product of preformed encapsulated methylcellulose powder with freeze thaw curd solid and optionally food fat of non-animal origin additionally to the fat in the curd. Alternatively, the present invention provides a ready-to-cook flesh like food product of non-animal origin that essentially consists of the mixing product of preformed encapsulated methylcellulose powder and freeze thaw curd solid and optionally food fat additionally to the fat in the curd. It furthermore provides the process of preparing such flesh like food product. Moreover, the present invention provides the use of such flesh like food product for cooking of a ready-to-cat food product.

Moreover, the present invention provides a ready-to-eat flesh like food product of non-animal origin or of extended meat product origin or extended seafood product origin (for instance extended fish product origin) that is a cooked flesh like food product comprising the mixing product of preformed encapsulated methylcellulose powder and freeze thaw curd solid of non-animal origin and optionally food fat of non-animal origin additionally to the fat in the curd. According to the present invention there is also provided that the freeze thaw curd solid is a freeze thaw alginate cured curd solid.

In another aspect, the present invention provides that the flesh like food product of non-animal origin does not comprise texturized vegetable protein (TVP) or that it is substantially free of, essentially free of, or free of any of TVP. Moreover, the present invention provides the use of such flesh like food product for the preparation of a ready-to-cat food product. In another aspect, the present invention provides a cooked a ready-to-eat flesh like food product of non-animal origin comprising one of the mixing product mentioned above.

The present invention furthermore provides a ready-to-cook flesh like food product of non-animal origin that comprises the mixture product of a least preformed encapsulated methylcellulose powder, food oil and freeze thaw curd solid and such food product that does not comprise texturized vegetable protein (TVP) or that is substantially free of, essentially free of, or free of any of TVP. In another aspect, the present invention provides a process for preparing such ready-to-cook flesh like food product. Moreover, the present invention provides the use of such flesh like food product for the preparation of a ready-to-cat food product. In another aspect, the present invention provides a cooked a ready-to-cat flesh like food product of non-animal origin that comprises the mixing product of a preformed encapsulated methylcellulose powder, and a food oil and freeze thaw curd solid and that does not comprise texturized vegetable protein (TVP) or that is substantially free of, essentially free of, or free of any of TVP. In addition, it furthermore provided the process for preparing such ready-to-eat flesh like food product.

The present invention also provides a ready-to-cook flesh like food product of non-animal origin or provided that that it is further heat processed or cooked a ready-to-eat flesh like food product of non-animal origin that is composition comprising the mixing product of a preformed encapsulated methylcellulose powder mixed with a food oil and with a freeze thaw alginate cured curd solid and it furthermore provided the process for preparing such flesh like food product, for instance a proteinaceous flesh like textured food. By using this inventive system, it is possible to provide a ready-to-cat flesh like food product of non-animal origin. It comprises the mixing product of a preformed encapsulated methylcellulose powder mixed, food oil and freeze thaw alginate cured curd solid that is further heated or cooked until it is ready-to-eat. We demonstrated that such ready-to-cook flesh like food product of non-animal origin ready-to-cat flesh like food product of non-animal origin can be prepared without texturized vegetable protein (TVP) or that is substantially free of, essentially free of, or free of any of TVP and yet holds the springiness, tenderness, chewiness and juiciness of a flesh like texture.

In an embodiment, the ready-to-cook flesh like food product of non-animal origin according to the present invention comprises the mixing product of 1) a preformed encapsulated methylcellulose powder mixed and 2) food oil and 3) freeze thaw alginate cured curd solid and this without texturized vegetable protein (TVP) or being substantially free of, essentially free of, or free of any of TVP. It furthermore provides the process for preparing such flesh like food product. It was found that this ready-to-cook flesh like food product of non-animal origin according to the present invention can be cooked into a ready-to-eat flesh like food product with the appeal of a cooked meat or fish. The present invention thus furthermore provides a cooked a ready-to-cat flesh like food product of non-animal origin that is a composition comprising the mixing product of a preformed encapsulated methylcellulose powder mixed with a food oil and with a freeze thaw alginate cured curd solid and such without a texturized vegetable protein (TVP) or being substantially free of, essentially free of, or free of any of TVP. This object of the present invention is achieved by means heating or cooking the ready-to-cook flesh like food product of non-animal origin that comprises the mixing product of 1) a preformed encapsulated methylcellulose powder mixed and 2) food oil and 3) freeze thaw alginate cured curd solid and this without texturized vegetable protein (TVP).

In an embodiment, the ready-to-cook flesh like food product of extended meat product origin or extended seafood product origin (for instance extended fish product origin) according to the present invention comprises the mixing product of 1) a preformed encapsulated methylcellulose powder mixed and 2) food oil and 3) dried and grinded meat or seafood (preferably fish). It furthermore provides the process for preparing such flesh like food product. It was found that this ready-to-cook flesh like food product of extended meat product origin or extended fish product origin according to the present invention can be cooked into a ready-to-cat flesh like food product with the appeal of a cooked meat or fish.

This mixing process, here above described, can be hand force mixed, for instance by a gloved hand or a hand that hold a mixing kitchen compliance, or it can be machine mixed, for instance by a kitchen compliance.

It was also found that these ready-to-cook flesh like food product of non-animal origin or of extended meat product origin or extended seafood product origin (for instance extended fish product origin) of present invention can furthermore can have in the mixing product also add powders, solutions or powder dispersion of other foodstuff, such as protein, carbohydrate, salt, herbs or aromas and yet not jeopardize the flesh like texture.

By using a proteinaceous curd solid and/or adding, proteinaceous in the mixture it is possible by the method of present invention to prepare a proteinaceous flesh like textured food without animal derived ingredients. Such flesh like textured food can be prepared as a proteinaceous food product comprising a protein content more than 10% for instance in the range of 10% to 25%.

The texture analyser used for present invention is a Lloyd Instruments/Ametek LS1 is used with 116 mm diameter aluminium compression plate fixed on the load cell and a base table with processing of the variable parameters measured by the Nexygen+4.1, software package was used to measure parameters of Hardness1. Hardness2. Cohesiveness, Chewiness. Resilience and Springiness. Hardness1 is the maximum force of the 1st compression. This hardness value is the peak force that occurs during the first compression. Hardness2 is the maximum force of the 1st compression. This hardness value is the peak force that occurs during the second compression. Chewiness is calculated as Gumminess*Springiness. Gumminess is mutually exclusive with Chewiness since a product would not be both a semi-solid and a solid at the same time. Gumminess applies only to semi-solid products and is Hardness*Cohesiveness (which is Area 2/Area 1). Cohesiveness is the area of work during the second compression divided by the area of work during the first compression. It is how well the product withstands a second deformation relative to its resistance under the first deformation. Resilience is calculated by dividing the upstroke energy of the first compression by the down stroke energy of the first compression. Resilience is how well a product “fights to regain its original height”. Resilience is measured on the withdrawal of the first penetration, before the waiting period is started. Resilience can be measured with a single compression: however, the withdrawal speed must be the same as the compression speed. Springiness is expressed as a ratio or percentage of a product's original height. Springiness is measured several ways, but most typically, by the distance of the detected height during the second compression divided by the original compression distance. Springiness is how well a product physically springs back after it has been deformed during the first compression and has been allowed to wait for the target wait time between strokes. The spring back is measured at the down-stroke of the second compression. In some cases an excessively long wait time will allow a product to spring back more than it might under the conditions being researched (e.g. you would not wait 60 seconds between chews).

### EXAMPLES

### Example 1: Curd Solid of Soybean

To prepare a curd solid of soybean, dry soybeans are put in a bowl with small bottom holes and rinsed under tap. They are consequently transferred into a bowl without bottom holes and filtered water is add until the water covered the soybeans with a layer of about 8 cm to further soak the soy beans at room temperature (about 27° C.) for 8 hours. A 170 gram of dry soybeans will weigh about 397 grams after soaking (and measures about 532 ml).

When the soybeans split apart in two halves by a mild squeeze on between the fingers, the halves are flat with an even buttercup yellow colour and they could easily been broken crosswise the soybeans are considered sufficiently soaked and ready for the next step. If the surfaces are concave and/or darker in the middle than at the edge and if halves bend in a rubbery manner, we soaked longer soak longer until the previous condition is reached. If the soybeans are readily soaked, the soaking water is discard.

A Thermomix® TM6 (Vorwerk Wuppertal. Germany) is used grind soaked beans and water to a silky thick mixture and to cook the soybean slurry. The soybeans (397 grams soaked soybeans) are grinded in about 473 ml water whereby the blender speed of the Thermomix TM6 (Vorwerk Wuppertal. Germany) in grind function, rotation is gradually increased to a Speed 10 (10,200 rpm) and kept so for about 2 minutes. The Thermomix TM6 (Vorwerk Wuppertal, Germany) mixing bowl is rinsed with about 118 ml water and this is joined with the thick, smooth, ivory white puree of the grinding process in a Thermomix TM6 (Vorwerk Wuppertal. Germany) mixing bowl with about 1183 ml water heated to about 90° C., and this mixed with the ground soybeans is brought to boil by raising the temperature while mixing at speed 1 (100 rpm). This mixture is cooked while stirring at speed 1 for <6 minutes and until a foam resembles softly whipped egg whites forms and begins to rise. Then the heating is turned off and the mass is kept stirring at speed 1 until the foam deflated.

This hot mixture is pour into pressing cloth, laying on a colander while waiting until the fluid part passed through the cloth. When the content is slightly cooled, the cloth is gathered up a twisted into a sack and pressed against the colander to extract more fluid. The pressing cloth comprising solids is opened again and the solids are spread out and about 118 ml is stirred with this mass and consequently the cloth is twisted closed again and additional emulsion is wrung out again.

The collected fluid emulsion is add to a Thermomix TM6 (Vorwerk Wuppertal. Germany) bowl and gentle simmered at a temperature of 110° C., and a stirring speed 1 until bubbles percolated at the surface and consequently at 90° C., for 5 minutes. Consequently this emulsion is cooled while stirring a speed 1 and at a temperature of about 80° C. In the meantime, we solved the gypsum (calcium sulphate) crystals and nigari (magnesium chloride) crystals in a little water to make a fluid. 4.2 grams of gypsum (calcium sulphate) crystals and 4.2 grams of nigari (magnesium chloride) crystals per 1893 ml of the emulsion is added to this emulsion at 80° C. This gypsum (calcium sulphate) crystals and nigari (magnesium chloride) fluid is add in 3 additions to the warm emulsion which is blitzed for 10 seconds on speed 3 (500) rpm) where after the mixture is left for at least 20 minutes to coagulate. A spoon is used to sprinkle another third of the gypsum (calcium sulphate) crystals and nigari (magnesium chloride) fluid onto the surface of the emulsion. The Thermomix TM6 (Vorwerk Wuppertal. Germany) bowled is covered the pot and left untouched for 3 minutes. Then the remaining third of the gypsum (calcium sulphate) crystals and nigari (magnesium chloride) fluid is sprinkled on the coagulating emulsion and a wooden spoon is used to gently stir back and forth across the topmost 2 cm of the coagulating emulsion or about 20 seconds. The Thermomix TM6 (Vorwerk Wuppertal. Germany) bowel is covered again an left untouched for about 6 minutes and the surface of the coagulating emulsion is by de wooden spoon gently stirred again for about 20 seconds to further distribute the gypsum (calcium sulphate) crystals and nigari (magnesium chloride) and complete the curdling and find white soybean curds and pale yellow soybean whey. In the meantime, a thin, lightweight cloth for draining fluids lines a block mold drainer with drainage holes at the bottom of the middle strainer and shaping the fat, protein, fibre mass is placed in a rimmed baking sheet with the liner cloth inside, letting its edges drape over the side. Some of this whey is removed from the Thermomix TM6 (Vorwerk Wuppertal. Germany) bowel and the curds are put into a block mold drainer with drainage holes at the bottom of the middle strainer. Pressure for is induced to the block of soybean curd to squeeze out excess water and this until the curds are down to half their original thickness. The just pressed curd solid is removed while in cold water (<5° C., for instance >0° C.)<5° C.).

### Example 2: Freeze Thaw Curd Solid of Soybean

A freeze thaw curd solid of soybean is prepared from a soybean curd solid (Fat 6.7%, carbohydrate 1.3%, protein 13% and salt <0.01%) by gradual cooling of a curd solid of soybean to −18° C., and 24 h later subjected to thaw and heating by microwaving for 20 min at 900 Watt in a glass container. The heat thawing process removed part of the water phase. Further water is removed by pressing it out.

### Example 3: Freeze Thaw Alginate Cured Curd Solid of Soybean

A freeze thaw alginate cured curd solid is produced by impregnating the freeze thaw curd solid of soybean at room temperature in a 2% sodium alginate aqueous solution for 6 hours and subsequently impregnating these solids at room temperature in a calcium lactate aqueous solution for 30 minutes. The sodium alginate solution is produced by stirring in water at 2 rpm in a Thermomix® TM6 (Vorwerk Wuppertal. Germany) Finally the soy bean curd solid is subjected to a oven drying at 65° C. until a 10% water content.

### Example 4: A Powder of Methylcellulose Encapsulated in an Fat (Palm Fat)—Protein Matrix (Example 4a) and an Oil-Protein (Soy Protein Isolate) Matrix without Methylcellulose Example 4b

The encapsulated methylcellulose: Mixture A: 420 gram of palm fat (Upfield Europe BV) is melted at 65° C., and 104 gram of methylcellulose (25% MC 100TS (Shinetsu) & 75% MC 4,000 (Shinetsu) is mixed in therein (Thermomix at speed 2=200 rotations per minute). Mixture B: 100 gram of soy protein isolate (Holland & Barrett) is mixed for 1 minute in 600 gram water with pH 7 at 65° C. (Thermomix Speed 5=2,000 rotations per minute) and kept while mixing for 120 min. at 65° C. (Thermomix at speed 2=200 rotations per minute). Mixture A and Mixture B are joined and mixed at 90° C., for 20 min (Thermomix at speed 2=200 rotations per minute). This mixture is frozen, freeze dried (Freeze dryer HarvestRight. U.S.A.) and dry grinded in a Thermomix speed 10 (10,200 rotations per minute).

TABLE 1

| with MC | | % |
|---|---|---|
| SPI* | 100 | 16.03 |
| MC** | 104 | 16.67 |
| fat | 420 | 67.31 |
| Total | 624 | 100 |

*= is the soy protein isolate,
**= is the methylcellulose

The oil-protein matrix without methylcellulose: Product C: 420 gram of palm fat (Upfield Europe BV) is melted at 65° C. Mixture D: 100 gram of soy protein isolate (Holland & Barrett) is during 1 minute mixed in water with pH 7 at 65° C. (Thermomix Speed 5=2,000 rotations per minute) and kept while mixing for 120 min. at 65° C. (Thermomix at speed 2=200 rotations per minute). Product C and Mixture D are joined and mixed at 90° C., for 20 min. This mixture is frozen, freeze dried (Freeze dryer HarvestRight. U.S.A.) and dry grinded in a Thermomix speed 10 (10,200 rotations per minute).

TABLE 2

| without MC | | % |
|---|---|---|
| SPI | 100 | 19.23 |
| fat | 420 | 80.77 |
| Total | 520 | 100 |

* = is the soy protein isolate

Gelling test on the encapsulated methylcellulose premix powder: 1 gram of the above prepared encapsulated MC powder (example 4a) is joined with 30 ml tap water in a test tube in a test tube and after sealing and vigorous handshaking: the tube is left 15 min at room temperature upstanding in a rack. There are four condition a) tap water, b) tap water with NaCl (3.5%), c) tap water with protease enzyme hydrolysed mycoprotein (3.5%) and d) tap water with an acetic acid (1%). The powder forms a strong gel at the surface of the aqueous fluid in the test tube. There is no observable difference in gel strength indicating that the salt, hydrolysed protein oligopeptides or acetic acid does not affect the gel strength forming. The dry oil-protein matrix without methylcellulose, when subjected to the same tube test, does not for a strong gel on the water phase.

### Example 5

Simple food product formulation comprising 1) dry premix of protein/oil encapsulated MC, 2) wheat protein TVP and 3) other foodstuff as a ready-to-moist food product (I). To mix and hydrate this ready-to-moist food product (I) into a ready-to-cook paste (II). In addition, cook this ready-to-cook paste (II) into a ready-to-use food product foodstuff (III). MC is encapsulated in a palm fat-soy protein matrix.

A well-mixed ready-to-moist dry foodstuff mixture: The ready-to-moist food composition (I) is prepared based on the following different feedstock. 1) 14 gram (26.6% of the ready-to-moist food composition, being 10.6% of the hydrated ready-to-cook food product) fibrous wheat TVP (Lory® Tex Fibres SCM 110 of Crespel & Deiters GmbH & Co. KG), 2) 14 gram (26.6% of the ready-to-moist food composition, being 10.6% of the hydrated ready-to-cook food product) textured wheat protein TVP flakes (BeneoPro W-Tex of Beneo-Orafti S. A.), 3) 16 gram of the methylcellulose encapsulated in an oil-protein matrix powder (based on palm fat & soy protein isolate) prepared according to Example 4a (30.4% of the ready-to-moist food composition, being 12, 1% of the hydrated ready-to-cook food product). 4) 5 gram (9.5% of the ready-to-moist food composition, being 3.8% of the hydrated ready-to-cook food product) potato fibre (Emfibre KF 200 of Emsland Group (Emsland-Stärke GmbH)). 5) 0.5 gram shitake powder (0.9% of the ready-to-moist food composition, being 0.4% of the hydrated ready-to-cook food product). 6) 0.3 gram (0.6% of the ready-to-moist food composition, being 0.2% of the hydrated ready-to-cook food product) yeast extract (Biospringer umami of Lesaffre). 7) 0.2 gram (0.4% of the ready-to-moist food composition, being 0.2% of the hydrated ready-to-cook food product) Butter Buds (non-dairy concentrated dairy flavours (non-dairy Asia & non-dairy parmesan of Butter Buds Inc.) and 8) 2.7 gram (5.1% of the ready-to-moist food composition, being 2.0% of the hydrated ready-to-cook food product) fat powder (Vana-Crema 65D of Ingrizo). See Table 3.

TABLE 3

| with MC encapsulation | gram | gram | % of the | % of the |
|---|---|---|---|---|
| in palm fat - soy | in dry | in wet | dry premix | wet paste |
| protein capsules | premix | paste | composition | composition |
| fibrous wheat TVP | 14 | 14 | 26.6 | 10.6 |
| textured wheat | 14 | 14 | 26.6 | 10.6 |
| protein TVP flakes | | | | |
| Protein/oil | 16 | 16 | 30.4 | 12.1 |
| encapsulated MC | | | | |
| Potato fibre | 5 | 5 | 9.5 | 3.8 |
| Shitake powder | 0.5 | 0.5 | 0.9 | 0.4 |
| Yeast extract powder | 0.3 | 0.3 | 0.6 | 0.2 |
| Fat powder Vana-Crema | 2.7 | 2.7 | 5.1 | 2.0 |
| 65D | | | | |
| Butter Buds | 0.2 | 0.2 | 0.4 | 0.2 |
| water | 0 | 80 | 0.0 | 60.3 |
| TOTAL | 52.7 | 132.7 | 100 | 100 |

fibrous wheat TVP = Lory ® Tex Fibres SCM 110 of Crespel & Deiters GmbH & Co. KG
textured wheat protein TVP flakes = BeneoPro W-Tex of Beneo-Orafti S.A.)
potato fibre = Emfibre KF 200 of Emsland Group (Emsland-Starke GmbH))
yeast extract = Biospringer umami of Lesaffre)
Butter Buds = non-dairy concentrated dairy flavours (non-dairy Asia & non-dairy parmesan of Butter Buds Inc.)
fat powder = Vana-Crema 65D of Ingrizo)

52.7 gram of the premix of the fibrous wheat TVP, the textured wheat protein TVP flakes, potato fibre, shitake powder, yeast extract (Biopringer Umami of Lesaffre) and Butter Buds, MC protein/oil encapsulated dry powder premix and fat powder (I)+0.05 gram of a fifty-fifty lycopene/carotene mix (Beta-carotene red BF10 WDP & lycopene BF5 WDP of San-Ei Gen) is hand force mixed with 80 gram cold water (>0° C.<5° C.) into a ready-to-cook paste (II) foodstuff mixtures. This wet product has the appeal of a fleshy textured food product.

One-half of the wet food product (FIG. 1) is instantly (without incubation at a low temperature (for instance <5° C.)) cooked in a pan on an induction cooker. (FIGS. 2a & b). The cooked fleshy textured food product has a cooked meat appeal based on springiness, tenderness and chewiness. The other half of the wet ready-to-cook food product is incubated for 2 hours in a refrigerator (<4° C.)) and thereafter cooked in a pan on an induction cooker. This slightly improved the cooked meat appeal based on springiness, tenderness, chewiness and juiciness.

### Example 6

Simple food product formulation of dry premix with protein/oil matrix (palm fat & soy protein isolate) without methylcellulose but free (not capsulated) methylcellulose in this premix and with wheat protein TVP a as a ready-to-moist food product (I) to wet mix and hydrate this premix (I) into a ready-to-cook paste (II) and cook this paste (II) into a ready-to-use end product foodstuff (III).

A well-mixed dry foodstuff mixture, the ready-to-moist food composition (I) is prepared based on the following different feedstock (table 4): 1) 14 gram (26.6% of the ready-to-moist food composition, being 10.6% of the hydrated ready-to-cook food product) fibrous wheat TVP (Lory®) Tex Fibres SCM 110 of Crespel & Deiters GmbH & Co. KG). 2) 14 gram (26.6% of the ready-to-moist food composition, being 10.6% of the hydrated ready-to-cook food product) textured wheat protein TVP flakes (BeneoPro W-Tex of Beneo-Orafti S. A.). 3) 16 gram of the oil-protein powder matrix but without methylcellulose prepared according to Example 4b (30.4% of the ready-to-moist food composition, being 12.1% of the hydrated ready-to-cook food product), 4) 5 gram (9.5% of the ready-to-moist food composition, being 3.8% of the hydrated ready-to-cook food product) potato fibre (Emfibre KF 200 of Emsland Group (Emsland-Stärke GmbH)), 5) 0.5 gram (0.9% of the ready-to-moist food composition, being 0.4% of the hydrated ready-to-cook food product) shitake powder. 6) 0.3 gram (0.6% of the ready-to-moist food composition, being 0.2% of the hydrated ready-to-cook food product) yeast extract (Biospringer umami of Lesaffre), 7) 0.2 gram (0.4% of the ready-to-moist food composition, being 0.2% of the hydrated ready-to-cook food product) Butter Buds (non-dairy concentrated dairy flavours (non-dairy Asia & non-dairy parmesan of Butter Buds Inc.) and 2.7 gram (5.1% of the ready-to-moist food composition, being 2% of the hydrated ready-to-cook food product) of methylcellulose (25% MC 100TS (Shinetsu) & 75% MC 4,000 (Shinetsu).

TABLE 4

| without MC | | | | |
|---|---|---|---|---|
| encapsulation, the | | | | |
| dry powdered palm fat - | gram | gram | % of the | % of the |
| soy protein isolate | in dry | in wet | dry premix | wet paste |
| is not loaded with MC. | premix | paste | composition | composition |
| fibrous wheat TVP | 14 | 14 | 26.6 | 10.6 |
| textured wheat protein | 14 | 14 | 26.6 | 10.6 |
| TVP flakes | | | | |
| Protein/oil dry premix | 16 | 16 | 30.4 | 12.1 |
| Potato fibre | 5 | 5 | 9.5 | 3.8 |
| Shitake powder | 0.5 | 0.5 | 0.9 | 0.4 |
| Yeast extract powder | 0.3 | 0.3 | 0.6 | 0.2 |
| Methylcellulose* | 2.7 | 2.7 | 5.1 | 2.0 |
| Butter Buds | 0.2 | 0.2 | 0.4 | 0.2 |
| water | 0 | 80 | 0.0 | 60.3 |
| TOTAL | 52.7 | 132.7 | 100 | 100 |

*= methylcellulose (25% MC 100TS (Shinetsu) & 75% MC 4000 (Shinetsu)
fibrous wheat TVP = Lory ® Tex Fibres SCM 110 of Crespel & Deiters GmbH & Co. KG
textured wheat protein TVP flakes = BeneoPro W-Tex of Beneo-Orafti S.A.)
potato fibre = Emfibre KF 200 of Emsland Group (Emsland-Starke GmbH))
yeast extract = Biospringer umami of Lesaffre)
Butter Buds = non-dairy concentrated dairy flavours (non-dairy Asia & non-dairy parmesan of Butter Buds Inc.)

52.7 gram of the well mixed (in Thermomix TM6 (Vorwerk Wuppertal, Germany) reverse function speed 3=500 rpm during 10 min.) dry foodstuff mixture (table 4) of 1) the methylcellulose (MC), 2) the premix of the fibrous wheat TVP, 3) the textured wheat protein TVP flakes, 4) potato fibre, shitake powder, 5) yeast extract (Biopringer Umami of Lesaffre), 6) Butter Buds, 7) the protein/oil dry powder premix but without MC (I)+8) 0.05 gram of a fifty-fifty lycopene/carotene mix (Beta-carotene red BF10 WDP & lycopene BF5 WDP of San-Ei Gen) is hand force mixed with 80 gram cold water (>0° C.<5° C.) into a ready-to-cook paste (II) foodstuff mixtures. This wet product have the appeal of a fleshy textured food product.

One-half of the wet food product (FIG. 1) is instantly shaped and instantly (without incubation at a low temperature (for instance <4° C.)) cooked in a pan on an induction cooker. (FIGS. 2a & b). The cooked food product does not have a cooked meat appeal based on springiness, tenderness, chewiness and juiciness. It resulted in a patty with unpleasant bite. The other half of the wet ready-to-cook food product is incubated for 2 hours in a refrigerator (<4° C.)) and thereafter shaped and cooked in a pan on an induction cooker. It yet does not have the desired flesh like structure (a patty without flesh structure bite, lacking flesh like springiness, tenderness, chewiness).

### Example 7

Simple formulation of a premix of foodstuff (table 5) and methylcellulose in liquid vegetable oil (canola oil) or of premix of foodstuff (table 5), methylcellulose and liquid vegetable oil (canola oil) according state of the art into ready-to-cook food product (II) and cooking this ready-to-cook food product (II) into a ready-to-use end product foodstuff (III).

Two ready-to-cook food product are made with the foodstuff, the portions and proportions of table 5, but on a different state of the art preparation method, except that the TVP is not pre-hydrated and/or high shear emulsifying with cold water is not carried out.

TABLE 5

| without MC | gram | gram | % of the | % of the |
|---|---|---|---|---|
| encapsulation - MC is | in dry | in wet | dry premix | wet paste |
| premixed in canola oil | premix | paste | composition | composition |
| fibrous wheat TVP | 28 | 28 | 26.6 | 10.5 |
| textured wheat protein | 28 | 28 | 26.6 | 10.5 |
| TVP flakes | | | | |
| Soy protein isolate | 6.2 | 6.2 | 5.9 | 2.3 |
| canola oil | 25.8 | 25.8 | 24.5 | 9.7 |
| Potato fibre | 10 | 10 | 9.5 | 3.8 |
| Shitake powder | 1 | 1 | 0.9 | 0.4 |
| Yeast extract powder | 0.6 | 0.6 | 0.6 | 0.2 |
| Methylcellulose* | 5.4 | 5.4 | 5.1 | 2.0 |
| Butter Buds | 0.4 | 0.4 | 0.4 | 0.2 |
| water | 0 | 160 | 151.7 | 60.3 |
| TOTAL | 105.4 | 265.4 | 252 | 100 |

*= methylcellulose (25% MC 100TS (Shinetsu) & 75% MC 4000 (Shinetsu))
fibrous wheat TVP = Lory ® Tex Fibres SCM 110 of Crespel & Deiters GmbH & Co. KG
textured wheat protein TVP flakes = BeneoPro W-Tex of Beneo-Orafti S.A.)
potato fibre = Emfibre KF 200 of Emsland Group (Emsland-Starke GmbH))
yeast extract = Biospringer umami of Lesaffre)
Butter Buds = non-dairy concentrated dairy flavours (non-dairy Asia & non-dairy parmesan of Butter Buds Inc.).

1) Half of the dry ingredients (table 5) including the textures (fibrous wheat TVP and textured wheat protein TVP flake) and the methylcellulose are blended (in Thermomix TM6 (Vorwerk Wuppertal. Germany) reverse function speed 3=500 rpm during 5 min.). The canola oil is add and blended in the dry mix (in Thermomix TM6 (Vorwerk Wuppertal. Germany) reverse function speed 3=500 rpm during 5 min.). Cold water below <5° C., is and all (132.7 gram) is hand force mixed. Half of the paste is immediately shaped and cooked in a pan on an induction cooker. The cooked food product does not have a cooked meat appeal based on springiness, tenderness, chewiness and juiciness. It results in a patty with unpleasant bite. The other half of the wet ready-to-cook food product is incubated for 2 hours in a refrigerator (<4° C.)) and thereafter instantly shaped and cooked in a pan on an induction cooker. This patty does not have the springiness, tenderness, chewiness that provides a mouthfeel of a flesh like structure.

2) Half of the dry ingredients (table 5) are blended except for the textures (fibrous wheat TVP and textured wheat protein TVP flake). The canola oil and methylcellulose are blended. The canola methylcellulose blend with the dry ingredients, except for the textures is high shear mixed (Thermomix TM6 (Vorwerk Wuppertal. Germany) speed 5=2,000 rpm) with cold water below <5° C., the TVP is add and all (132.7 gram) including the TVP is hand force mixed. ⅓ of the paste is immediately shaped and cooked in a pan on an induction cooker. The cooked food product does not have a cooked meat mouthfeel based on springiness, tenderness, chewiness and juiciness. It resulted in a patty with unpleasant bite. Another ⅓ of the wet ready-to-cook food product is incubated for 2 hours in a refrigerator (<4° C.)) and thereafter shaped and cooked in a pan on an induction cooker. It yet have the structure of a patty without springiness, tenderness, chewiness or flesh structure bite. Another ⅓ of the wet ready-to-cook food product is incubated for 24 hours in a refrigerator (<4° C.)) and thereafter shaped and cooked in a pan on an induction cooker. The cooked fleshy textured food product has a cooked meat appeal based on springiness, tenderness, chewiness and juiciness.

### Example 8

Complex formulation with TVP of ready-to-moist dry premix (I) to mix and hydrate this premix (I) into a ready-to-cook paste (II) and cook this into a ready-to-use end product foodstuff (III).

A dry foodstuff mixture (I) is prepared based on a ready-to-moist food composition (table 6) comprising 1) 25.7 gram (17.5% of the ready-to-moist food composition, being 9% of the ready-to-cook food product) fibrous wheat TVP (Lory® Tex Fibres SCM 110 of Crespel & Deiters GmbH & Co. KG), 2) 25.7 gram (17.5% of the ready-to-moist food composition, being 9% of the hydrated ready-to-cook food product) textured wheat protein TVP flakes (BeneoPro W-Tex of Beneo-Orafti S. A.), 3) 51.4 gram of the methylcellulose encapsulated powder (MC encapsulated in palm fat & soy protein isolate) prepared according to Example 4a (35.1% of the ready-to-moist food composition, being 18% of the hydrated ready-to-cook food product). The cheese powder is rasped hard cheese from Fallini Formaggi Srl (Italy). & the nutritional yeast (Saccharomyces cerevisiae) from Wessanen Benelux BV (The Netherlands). The total of the complex powder mix (146.5 gram) outlined in Table 6 is further tested in a moistening and cooking process.

TABLE 6

| With MC encapsulated in | | | | |
|---|---|---|---|---|
| a powdered palm fat - | gram | gram | % of the | % of the |
| soy protein isolate | in dry | in wet | dry premix | wet paste |
| matrix (Example 4a) | premix | paste | composition | composition |
| Protein/oil encapsulated | 51.4 | 51.4 | 35.1 | 17.9 |
| MC | | | | |
| brewer's yeast on malt | 0.8 | 0.8 | 0.5 | 0.3 |
| nutritional yeast | 0.8 | 0.8 | 0.5 | 0.3 |
| shitake powder | 1.6 | 1.6 | 1.1 | 0.6 |
| tomato powder | 2.0 | 2.0 | 1.4 | 0.7 |
| unripe grape | 0.5 | 0.5 | 0.3 | 0.2 |
| sumac | 0.5 | 0.5 | 0.3 | 0.2 |
| wild garlic | 0.5 | 0.5 | 0.3 | 0.2 |
| onion powder | 2.5 | 2.5 | 1.7 | 0.9 |
| kitchen salt | 3.2 | 3.2 | 2.2 | 1.1 |
| psyllium | 0.5 | 0.5 | 0.3 | 0.2 |
| oat fibre | 3.5 | 3.5 | 2.4 | 1.2 |
| pepper | 0.3 | 0.3 | 0.2 | 0.1 |
| miso powder | 0.5 | 0.5 | 0.3 | 0.2 |
| aroma | 2.7 | 2.7 | 1.8 | 0.9 |
| asafoetida | 0.3 | 0.3 | 0.2 | 0.1 |
| cheese powder | 1.3 | 1.3 | 0.9 | 0.5 |
| soy protein isolate | 8.0 | 8.0 | 5.5 | 2.8 |
| wheat germ | 1.0 | 1.0 | 0.7 | 0.3 |
| teff seed | 1.0 | 1.0 | 0.7 | 0.3 |
| cashew meal | 2.0 | 2.0 | 1.4 | 0.7 |
| pea starch | 7.2 | 7.2 | 4.9 | 2.5 |
| tapioca starch | 2.4 | 2.4 | 1.6 | 0.8 |
| spices | 0.6 | 0.6 | 0.4 | 0.2 |
| fibrous wheat TVP | 25.7 | 25.7 | 17.5 | 9.0 |
| textured wheat protein | 25.7 | 25.7 | 17.5 | 9.0 |
| TVP flakes | | | | |
| water | 0.0 | 140.0 | 0.0 | 48.9 |
| TOTAL | 146.5 | 286.5 | 100.0 | 100.0 |

146.5 gram of the dry premix (table 6) with the MC protein/oil encapsulated (dry powder premix (I)) is hand force mixed with 140 ml cold water (>0° C.<5° C.) into a ready-to-cook paste (II) foodstuff mixtures. This wet product (II) has the appeal of a fleshy textured food product. This wet food product is instantly (without incubation at a low temperature (for instance <4° C.)) cooked in a pan on an induction cooker. The cooked fleshy textured food product have a cooked meat mouthfeel based on springiness, tenderness, chewiness and juiciness.

### Example 9

Simple food product formulation of dry premix with freeze thaw alginate cured curd solid from soybean as a ready-to-moist food product (I) to wet mix, hydrate food product (I) into a ready-to-cook paste (II), and cook this paste (II) into a ready-to-use end product foodstuff (III).

TABLE 7

| with MC encapsulation | | | | |
|---|---|---|---|---|
| (Example 4a) and | gram | gram | % of the | % of the |
| freeze thaw alginate | in dry | in wet | dry premix | wet paste |
| cured curd solid | premix | paste | composition | composition |
| freeze thaw alginate | 28 | 28 | 53.1 | 21.1 |
| cured curd solid | | | | |
| Protein/oil encapsulated | 16 | 16 | 30.4 | 12.1 |
| MC | | | | |
| Potato fibre | 5 | 5 | 9.5 | 3.8 |
| Shitake powder | 0.5 | 0.5 | 0.9 | 0.4 |
| Yeast extract powder | 0.3 | 0.3 | 0.6 | 0.2 |
| Fat powder Vana-Crema | 2.7 | 2.7 | 5.1 | 2.0 |
| 65D | | | | |
| Butter Buds | 0.2 | 0.2 | 0.4 | 0.2 |
| water | 0 | 80 | 0.0 | 60.3 |
| TOTAL | 52.7 | 132.7 | 100 | 100 |

A dry foodstuff mixture (table 7), the ready-to-moist food composition (I) is prepared based on the following different feedstock, 1) 28 gram (53.1% of the ready-to-moist food composition, being 21.1% of the hydrated ready-to-cook food product) freeze thaw alginate cured soybean curd solid, 2) 16 gram of the methylcellulose encapsulated in an oil-protein matrix prepared in a powder according to Example 4a (30.4% of the ready-to-moist food composition, being 12.1% of the hydrated ready-to-cook food product), 3) 5 gram (9.5% of the ready-to-moist food composition, being 3.8% of the hydrated ready-to-cook food product) potato fibre (Emfibre KF 200 of Emsland Group (Emsland-Stärke GmbH)), 4) 0.5 gram (0.9% of the ready-to-moist food composition, being 0.4% of the hydrated ready-to-cook food product) shitake powder, 5) 0.3 gram (0.6% of the ready-to-moist food composition, being 0.2% of the hydrated ready-to-cook food product) yeast extract (Biospringer umami of Lesaffre) and 6) 0.2 gram (0.4% of the ready-to-moist food composition, being 0.2% of the hydrated ready-to-cook food product) Butter Buds (non-dairy concentrated dairy flavours (non-dairy Asia & non-dairy parmesan of Butter Buds Inc.) and fat powder (Fat powder Vana-Crema 65D).

52.7 gram of the premix (table 7) of the fibrous wheat TVP, the textured wheat protein TVP flakes, potato fibre, fat powder, shitake powder, yeast extract (Biopringer Umami of Lesaffre) and Butter Buds. MC protein/oil encapsulated dry powder premix (I) is hand force mixed with 80 cold water (>0)° C.<5° C.) into a ready-to-cook paste (II) foodstuff mixtures. This wet product has the appeal of a fleshy textured food product.

One-half of the wet food product is instantly (without incubation at a low temperature (for instance <4° C.)) cooked in a pan on an induction cooker. The cooked fleshy textured food product has a cooked flesh like mouthfeel, based on springiness, tenderness, chewiness and juiciness. The other half of the wet ready-to-cook food product is incubated for 2 hours in a refrigerator (<4° C.)) and thereafter cooked in a pan on an induction cooker. This slightly improved the cooked flesh like mouthfeel appeal based on springiness, tenderness, chewiness.

### Example 10: The Methylcellulose in Canola Oil, Refined Coconut Fat & Pea Protein Isolate Encapsulated Premix with Natural Anti-Oxidant

The encapsulated methylcellulose: Mixture A: 149.2 gram of refined odourless coconut fat (de Smaakspecialist, the Netherlands) with 270.8 gram of canola oil (Vandemoortele NV. Belgium) is melted at 65° C., into a liquid mixture and 104 gram of methylcellulose (25% MC 100TS (Shinetsu) & 75% MC 4,000 (Shinetsu) is mixed in therein (Thermomix TM6 (Vorwerk Wuppertal. Germany) at speed 2,200 rotations per minute). Mixture B: 100 gram of pea protein isolate (Holland & Barrett) is mixed in 600 gam water with pH 7 at 65° C. (Thermomix TM6 (Vorwerk Wuppertal. Germany) Speed 5=2,000 rotations per minute) and kept while mixing for 120 min. at 65° C. (Thermomix TM6 (Vorwerk Wuppertal. Germany) at speed 2=200 rotations per minute). Mixture A and Mixture B and 1 g of hydro-ethanoic extract of oregano and Ig of hydro-ethanoic extract of rosemary are joined and mixed at 90° C., for 20 min. This mixture is frozen, freeze dried (Freeze dryer HarvestRight. U.S.A.) and dry grinded in a Thermomix TM6 (Vorwerk Wuppertal. Germany) speed 10 (10,200 rotations per minute).

### Example 11

A food product formulation of dry premix comprising 1) methylcellulose encapsulated in a matrix of pea protein isolate, canola oil and coconut fat (Example 10) and comprising 2) pea protein texture (pea TVP) and 3) other foodstuff, as a ready-to-moist food product (I) to wet mix and hydrate food product (I) into a ready-to-cook paste (II) and cook this paste (II) into a ready-to-use end product foodstuff (III).

TABLE 8

| With MC encapsulation | | | | |
|---|---|---|---|---|
| in a dry powdered | | | | |
| coconut oil/canola oil - | gram | gram | % of the | % of the |
| pea protein matrix | in dry | in wet | dry premix | wet paste |
| with anti-oxidants | premix | paste | composition | composition |
| Textured pea protein | 15 | 15 | 24.7 | 10.0 |
| (crushed Nutralys T70S) | | | | |
| Textured pea protein | 15 | 15 | 24.7 | 10.0 |
| (Nutralys TP-C) | | | | |
| Protein/oil encapsulated | 20 | 20 | 32.9 | 13.3 |
| MC | | | | |
| Rice protein | 1 | 1 | 1.6 | 0.7 |
| Potato starch | 1 | 1 | 1.6 | 0.7 |
| Nutritional yeast | 0.3 | 0.3 | 0.5 | 0.2 |
| Palm stearin | 3 | 3 | 4.9 | 2.0 |
| Natural aromas | 2.2 | 2.2 | 3.7 | 1.5 |
| Sodium chloride | 0.5 | 0.5 | 0.8 | 0.3 |
| Potassium chloride | 0.5 | 0.5 | 0.8 | 0.3 |
| Beetroot colour | 0.3 | 0.3 | 0.5 | 0.2 |
| Apple extract | 0.3 | 0.3 | 0.5 | 0.2 |
| Pomegranate concentrate | 0.3 | 0.3 | 0.5 | 0.2 |
| powder | | | | |
| Sunflower lecithin | 0.7 | 0.7 | 1.2 | 0.5 |
| Buffered vinegar powder | 0.3 | 0.3 | 0.5 | 0.2 |
| Lemon powder | 0.3 | 0.3 | 0.5 | 0.2 |
| water | 0 | 90 | 0.0 | 59.7 |
| TOTAL | 60.7 | 150.7 | 100 | 100 |

A dry foodstuff mixture (I) is prepared based on a ready-to-moist food composition (table 8) comprising 1) 15 gram (24.7% of the ready-to-moist food composition, being 10.0% of the ready-to-cook food product) fibrous pea TVP (Textured pea protein (crushed Nutralys T70S. Roquette. France)), 2) 15 gram (24.7% of the ready-to-moist food composition, being 10% of the hydrated ready-to-cook food product) textured pea protein TVP flakes (Textured pea protein (Nutralys TP-C). Roquette. France). 3) 20 gram of the methylcellulose encapsulated powder prepared according to Example 10 (32.9% of the ready-to-moist food composition, being 13.3% of the hydrated ready-to-cook food product) and rice protein, potato starch, nutritional yeast, palm stearin, natural aromas, sodium chloride, potassium chloride, beetroot colour, apple extract, pomegranate concentrate powder, sunflower lecithin, buffered vinegar powder (Ingrizo), lemon powder n the composition and proportions outlined in Table 8. The total of the dry mix (60.7 gram) is further tested in a moistening and cooking process.

60.7 gram of the dry premix (table 8) with the MC protein/oil encapsulated (dry powder premix (I)) is hand force mixed with 90 ml cold water (>0° C.)<5° C.) into a ready-to-cook paste (II) foodstuff mixtures. This wet product (II) has the appeal of a fleshy textured food product. This wet food product is instantly (without incubation at a low temperature (for instance <4° C.)) cooked in a pan on an induction cooker. The cooked fleshy textured food product have a cooked meat mouthfeel based on springiness, tenderness, chewiness and juiciness.

### Example 12: The Methylcellulose in a Coconut Oil, Sunflower Oil Mix & Protein (Soy Protein Isolate) Encapsulated Premix with Natural Anti-Oxidant

The encapsulated methylcellulose: Mixture A: 210 gram of coconut (Upfield Europe BV) with 210 gram of sunflower oil (Vandemoortele NV) is melted at 65° C., into a liquid mixture and 104 gram of methylcellulose (25% MC 100TS (Shinetsu) & 75% MC 4,000 (Shinetsu) is mixed in therein (Thermomix TM6 (Vorwerk Wuppertal, Germany) at speed 2,200 rotations per minute). Mixture B: 100 gram of soy protein isolate (Holland & Barrett) is mixed in 600 gram water with pH 7 at 65° C. (Thermomix TM6 (Vorwerk Wuppertal. Germany) Speed 5=2,000 rotations per minute) and kept while mixing for 120 min. at 65° C. (Thermomix TM6 (Vorwerk Wuppertal. Germany) at speed 2=200 rotations per minute). Mixture A and Mixture B and 153 mg of hydro-ethanoic extract of oregano and 153 mg of hydro-ethanoic extract of rosemary are joined and mixed at 90° C., for 20 min. This mixture is frozen, freeze dried (Freeze dryer HarvestRight. U.S.A.) and dry grinded in a Thermomix TM6 (Vorwerk Wuppertal. Germany) speed 10 (10,200 rotations per minute).

### Example 13

Food product formulation of dry premix with soybean concentrate based TVP and a powder of MC encapsulated in coconut oil, sunflowers oil and soybean protein isolate (of Example 12) as a ready-to-moist food product (I) to wet mix and hydrate food product (I) into a ready-to-cook paste (II) and cook this paste (II) into a ready-to-use end product foodstuff (III).

A well-mixed ready-to-moist dry foodstuff mixture: The ready-to-moist food composition (I) is prepared based on the following different feedstock. 1) 40 gram (48.3% of the ready-to-moist food composition, being 21.9% of the hydrated ready-to-cook food product) soy concentrate texture (SOPROTEX-N), 2) 25 gram of the methylcellulose encapsulated in an oil-protein matrix powder (based on sunflower oil, coconut fat & soy protein isolate) prepared according to Example 12 (30.2% of the ready-to-moist food composition, being 13.7% of the hydrated ready-to-cook food product). 3) 5 gram (6% of the ready-to-moist food composition, being 2.7% of the hydrated ready-to-cook food product) soy protein isolate. 4) 1 gram tapioca starch (1.2% of the ready-to-moist food composition, being 0.5% of the hydrated ready-to-cook food product), 5) 0.5 gram (0.6% of the ready-to-moist food composition, being 0.3% of the hydrated ready-to-cook food product) hydroalcoholic herb extract (rosemary & oregano. 7) 0.3 gram (0.4% of the ready-to-moist food composition, being 0.2% of the hydrated ready-to-cook food product) yeast extract powder (Biospringer, Lesaffre), 8) 0.8 gram (1.0% of the ready-to-moist food composition, being 0.4% of the hydrated ready-to-cook food product) malt extract. 9) 2.23 gram natural flavour (Firmenich) (2.7% of the ready-to-moist food composition, being 1.2% of the hydrated ready-to-cook food product), 10) 1.0 gram (1.2% of the ready-to-moist food composition, being 0.5% of the hydrated ready-to-cook food product) potato protein. 11) 1.0 gram (1.2% of the ready-to-moist food composition, being 0.5% of the hydrated ready-to-cook food product) salt. 6 gram (7.2% of the ready-to-moist food composition, being 3.3% of the hydrated ready-to-cook food product) palm stearin. 10), 0.007 gram (0.0085% of the ready-to-moist food composition, being 0.0038% of the hydrated ready-to-cook food product) ferric pyrophosphate. See Table 9.

TABLE 9

| Ready to moist | | | | |
|---|---|---|---|---|
| food product with | | | | |
| methylcellulose | | | | |
| encapsulated in a soy | gram | gram | % of the | % of the |
| protein - coconut oil/ | in dry | in wet | dry premix | wet paste |
| sunflower oil matrix | premix | paste | composition | composition |
| Crushed soy concentrate | 40 | 40 | 48.3 | 21.9 |
| texturate | | | | |
| (SOPROTEX-N)* | | | | |
| Soy protein isolate | 5 | 5 | 6.0 | 2.7 |
| Protein/oil encapsulated | 25 | 25 | 30.2 | 13.7 |
| MC (Example 12) | | | | |
| Tapioca starch | 1 | 1 | 1.2 | 0.5 |
| Hydro-alcoholic herb | 0.5 | 0.5 | 0.6 | 0.3 |
| extract (rosemary, | | | | |
| oregano) | | | | |
| Yeast extract powder | 0.3 | 0.3 | 0.4 | 0.2 |
| Malt extract | 0.8 | 0.8 | 1.0 | 0.4 |
| Potato protein** | 1 | 1 | 1.2 | 0.5 |
| Natural flavour | 2.23 | 2.23 | 2.7 | 1.2 |
| Salt | 1 | 1 | 1.2 | 0.5 |
| Palm stearin | 6 | 6 | 7.2 | 3.3 |
| Ferric pyrophosphate | 0.007 | 0.007 | 0.0085 | 0.0038 |
| (4.2 mg) | | | | |
| Vitamin B12 (0.76 μg) | | | | |
| Water | 0 | 100 | 0.0 | 54.7 |
| TOTAL | 82.84 | 182.84 | 100 | 100 |

*SOPROTEX-N (Barrentz)
**Vegangastronomy

82.84 gram of the premix comprising the crushed soy concentrate texture (Soprotex-N), the soy concentrate texture, soy protein isolate, tapioca starch, hydro-alcoholic herb extract (rosemary, oregano), yeast extract powder, malt extract, potato protein, natural flavour, salt, palm stearin particles, iron (4.2 mg), vitamin B12 (0.76 μg), MC protein/oil encapsulated dry powder premix, palm stearin+0.05 gram of a fifty-fifty lycopene/carotene mix (Beta-carotene red BF10 WDP & lycopene BF5 WDP of San-Ei Gen) is hand force mixed with 100 gram cold water (>0° C.<5° C.) into a ready-to-cook paste (II) foodstuff mixtures. This wet product has the appeal of a fleshy textured food product.

The wet food product (is instantly (without incubation at a low temperature (for instance <4° C.)) cooked in a pan on an induction cooker. The cooked fleshy textured food product have a cooked meat appeal based on springiness, tenderness and chewiness.

### Example 14: Methylcellulose with Acids (Malic Acid, Citric Acid & Ascorbic Acid) Encapsulated in a Dry Matrix of Sunflower Oil & Soy Protein Isolate

The encapsulated methylcellulose: Mixture A: 420 gram of sunflower oil (Vandemoortele NV) I heated to 65° C. 104 gram of methylcellulose (25% MC 100TS (Shinetsu) & 75% MC 4,000 (Shinetsu) is mixed in therein (Thermomix TM6 (Vorwerk Wuppertal. Germany) at speed 2,200 rotations per minute). Mixture B: 100 gram of soy protein isolate (Holland & Barrett) is mixed in 600 gram water with pH 7 at 65° C. (Thermomix TM6 (Vorwerk Wuppertal. Germany) Speed 5=2,000 rotations per minute) and kept while mixing for 120 min. at 65° C. (Thermomix TM6 (Vorwerk Wuppertal. Germany) at speed 2=200 rotations per minute). Mixture A and Mixture B and 4.68 gram malic acid. 1.04 gram ascorbic acid and 7.8 gram citric acid are joined and mixed at 90° C., for 20 min. This mixture is frozen, freeze dried (Freeze dryer HarvestRight. U.S.A.) and dry grinded in a Thermomix TM6 (Vorwerk Wuppertal. Germany) speed 10 (10,200 rotations per minute).

### Example 15

Food product formulation of dry premix with soybean concentrate & wheat protein based TVP and a powder of MC encapsulated in sunflowers oil and soybean protein isolate (Example 14) as a ready-to-moist food product (I) to wet mix and hydrate food product (I) into a ready-to-cook paste (II) and cook this paste (II) into a ready-to-use end product foodstuff (III).

A well-mixed ready-to-moist dry foodstuff mixture: The ready-to-moist food composition (I) is prepared based on the following different feedstock. 1) 17 gram (28.4% of the ready-to-moist food composition, being 12.15% of the hydrated ready-to-cook food product) soy wheat protein texture (Unitex-S-2010). 2) 20 gram of the methylcellulose encapsulated in sunflower oil-soy isolate protein matrix powder prepared according to Example 14 (33.4% of the ready-to-moist food composition, being 14.29% of the hydrated ready-to-cook food product). 3) 8 gram (13.4% of the ready-to-moist food composition, being 5.72% of the hydrated ready-to-cook food product) potato protein. 4) 6 gram (10) % of the ready-to-moist food composition, being 4.29% of the hydrated ready-to-cook food product) palm stearin. 5) 3.1 gram (5.2% of the ready-to-moist food composition, being 2.22% of the hydrated ready-to-cook food product) aroma (Firmenich). 6) 1.3 gram tapioca starch gram (2.2% of the ready-to-moist food composition, being 0.93% of the hydrated ready-to-cook food product). 7) 0.9 gram (1.5% of the ready-to-moist food composition, being 0.64% of the hydrated ready-to-cook food product) salt. 8) 0.7 gram (1.2% of the ready-to-moist food composition, being 0.5% of the hydrated ready-to-cook food product) soybean lecithin. 9) 0.5 gram (0.8% of the ready-to-moist food composition, being 0.36% of the hydrated ready-to-cook food product) buffered vinegar powder (Ingrizo). 10) 0.5 gram (0.8% of the ready-to-moist food composition, being 0.36% of the hydrated ready-to-cook food product) beetroot colour powder. 11) 0.3 gram (0.5% of the ready-to-moist food composition, being 0.21% of the hydrated ready-to-cook food product) psyllium. 12). 0.14 gram (0.2% of the ready-to-moist food composition, being 0.10% of the hydrated ready-to-cook food product) white pepper, 13) 0.14 gram (0.2% of the ready-to-moist food composition, being 0.10% of the hydrated ready-to-cook food product) black pepper, 14) 0.26 gram (0.4% of the ready-to-moist food composition, being 0.19% of the hydrated ready-to-cook food product) barley malt extract, 15) 0.3 gram maltodextrin (0.5% of the ready-to-moist food composition, being 0.21% of the hydrated ready-to-cook food product), 16) 0.2 gram (0.3% of the ready-to-moist food composition, being 0.14% of the hydrated ready-to-cook food product) citrus fibre 17) 0.06 gram (0.1% of the ready-to-moist food composition, being 0.04% of the hydrated ready-to-cook food product) beta-carotene, lycopene powder, 18) 0.18 gram malic acid (0.3% of the ready-to-moist food composition, being 0.13% of the hydrated ready-to-cook food product), 18) 0.3 gram malic acid (0.5% of the ready-to-moist food composition, being 0.21% of the hydrated ready-to-cook food product)+5.1 mg ferric pyrophosphate and 0.9 μg vitamin B12. See Table 10.

TABLE 10

| methylcellulose | | | | |
|---|---|---|---|---|
| with acids (malic | | | | |
| acid, citric acid | | | | |
| & ascorbic acid) | | | | |
| encapsulated in a dry | gram | gram | % of the | % of the |
| matrix of sunflower & | in dry | in wet | dry premix | wet paste |
| soy protein isolate. | premix | paste | composition | composition |
| fibrous wheat - soy TVP | 17 | 17 | 28.4 | 12.15 |
| (Unitex-S-2010) | | | | |
| protein/oil encapsulated | 20 | 20 | 33.4 | 14.29 |
| MC | | | | |
| potato protein | 8 | 8 | 13.4 | 5.72 |
| palm stearin | 6 | 6 | 10.0 | 4.29 |
| aroma | 3.1 | 3.1 | 5.2 | 2.22 |
| tapioca starch | 1.3 | 1.3 | 2.2 | 0.93 |
| salt | 0.9 | 0.9 | 1.5 | 0.64 |
| soybean lecithin | 0.7 | 0.7 | 1.2 | 0.50 |
| Buffered vinegar powder | 0.5 | 0.5 | 0.8 | 0.36 |
| beetroot colour * | 0.5 | 0.5 | 0.8 | 0.36 |
| malic acid | 0.18 | 0.18 | 0.3 | 0.13 |
| citric acid | 0.3 | 0.3 | 0.5 | 0.21 |
| psyllium | 0.3 | 0.3 | 0.5 | 0.21 |
| white pepper | 0.14 | 0.14 | 0.2 | 0.10 |
| black pepper | 0.14 | 0.14 | 0.2 | 0.10 |
| barley malt extract | 0.26 | 0.26 | 0.4 | 0.19 |
| maltodextrin | 0.3 | 0.3 | 0.5 | 0.21 |
| citrus fibre | 0.2 | 0.2 | 0.3 | 0.14 |
| beta-carotene and | 0.06 | 0.06 | 0.1 | 0.04 |
| lycopene** | | | | |
| ascorbic acid | 0.04 | 0.04 | 0.1 | 0.03 |
| water | 0 | 80 | 0.0 | 57.18 |
| TOTAL | 59.92 | 139.92 | 100 | 100 |

* vegetable red 5, Aromoss, Germany
**Beta-carotene red BF10 WDP & lycopene BF5 WDP of San-Ei Gen
5.1 mg ferric pyrophosphate
0.92 μg Vitamin B12

60 gram of the premix comprising the fibrous soy-wheat protein TVP, fifty-fifty lycopene/carotene mix (beta-carotene red BF10 WDP & lycopene BF5 WDP of San-Ei Gen), potato protein (Vegan Gastronomy, Spain), MC sunflower-soybean protein isolate/oil encapsulated dry powder premix prepared according to example 14, palm stearin, aroma (Firmenich), tapioca starch, salt, soybean lecithin, buffered vinegar powder, beetroot colour, psyllium, with pepper, black pepper, barley malt extract, maltodextrin, citrus fibre (Nutrava Citrus Fiber-CP Kelco) (I) is hand force mixed with 80 gram cold water (>0° C.<5° C.) into a ready-to-cook paste (II) foodstuff mixtures. This wet product has the appeal of a fleshy textured food product.

The wet food product (is instantly (without incubation at a low temperature (for instance <4° C.)) cooked in a pan on an induction cooker. The cooked fleshy textured food product have a cooked meat appeal based on springiness, tenderness and chewiness.

A cooked end product with dimensions of 4 cm diameter and 2 cm thickness by the a Lloyd Instruments/Ametek LS1 is used with 116 mm diameter aluminium compression plate fixed on the load cell and a base table with processing of the variable parameters measured by the Nexygen+4.1. software package (the texture analyser).

As for the other test by the texture analyser parameters measures are of the groups consisting of Hardness1. Hardness2. Cohesiveness, Chewiness, Resilience and Springiness.

The average texture analyser parameters, measured on eleven (11) instantly moistened and instantly cooked samples are Hardness1 (232.72±14.82). Hardness2 (192.15±13.63), Cohesiveness (0.351±0.032), Chewiness (45.04±9.18). Resilience (0.446±0.025) and Springiness (−3.052±0.367).

### Example 16: The Methylcellulose in Canola Oil & Pea Protein Isolate Encapsulated Premix with Natural Anti-Oxidant

The encapsulated methylcellulose: Mixture A: 420 gram of canola oil (Vandemoortele NV. Belgium) is melted at 65° C., into a liquid mixture and 104 gram of methylcellulose (25% MC 100TS (Shinetsu) & 75% MC 4,000 (Shinetsu) is mixed in therein (Thermomix TM6 (Vorwerk Wuppertal. Germany) at speed 2,200 rotations per minute). Mixture B: 100 gram of pea protein isolate (Holland & Barrett) is mixed in 600 gam water with pH 7 at 65° C. (Thermomix TM6 (Vorwerk Wuppertal. Germany) Speed 5=2,000 rotations per minute) and kept while mixing for 120 min. at 65° C. (Thermomix TM6 (Vorwerk Wuppertal, Germany) at speed 2=200 rotations per minute). Mixture A and Mixture B and 1 g of hydro-ethanoic extract of oregano and 1 g of hydro-ethanoic extract of rosemary are joined and mixed at 90° C., for 20 min. This mixture is frozen, freeze dried (Freeze dryer HarvestRight. U.S.A.) and dry grinded in a Thermomix TM6 (Vorwerk Wuppertal, Germany) speed 10 (10,200 rotations per minute).

### Example 17

Food product formulation of dry premix with pea protein based TVP and a powder of MC encapsulated in canola oil and pea protein isolate (Example 16) as a ready-to-moist food product (I) to wet mix and hydrate food product (I) into a ready-to-cook paste (II) and cook this paste (II) into a ready-to-use end product foodstuff (III).

TABLE 11

| with MC | | | | |
|---|---|---|---|---|
| encapsulation in a | | | | |
| dry matrix of canola | | | | |
| oil, pea protein | | | | |
| isolate and natural | gram | gram | % of the | % of the |
| antioxidants | in dry | in wet | dry premix | wet paste |
| (Example 16) | premix | paste | composition | composition |
| pea protein (crushed | 17 | 17 | 20.3 | 9.3 |
| Nutralys T70S) | | | | |
| pea protein (Nutralys | 17 | 17 | 20.3 | 9.3 |
| TP-C) | | | | |
| palm stearin | 6 | 6 | 7.2 | 3.3 |
| Pea protein isolate | 1 | 1 | 1.2 | 0.5 |
| Protein/oil encapsulated | 25 | 25 | 29.9 | 13.6 |
| MC (Example 16) | | | | |
| Apple Fibre (Herbacel | 0.4 | 0.4 | 0.5 | 0.2 |
| AQ Plus) | | | | |
| Grinded oat bran | 3 | 3 | 3.6 | 1.6 |
| Shitake powder | 0.6 | 0.6 | 0.7 | 0.3 |
| potato starch | 2 | 2 | 2.4 | 1.1 |
| Buffered vinegar powder | 0.4 | 0.4 | 0.5 | 0.2 |
| Tomato powder | 0.3 | 0.3 | 0.4 | 0.2 |
| Tomato paste powder | 0.24 | 0.24 | 0.3 | 0.1 |
| herbal mixture (oregano, | 0.4 | 0.4 | 0.5 | 0.2 |
| paprika, basilica, | | | | |
| ransom) | | | | |
| salt | 2 | 2 | 2.4 | 1.1 |
| Onion powder | 4 | 4 | 4.8 | 2.2 |
| barley malt extract | 0.6 | 0.6 | 0.7 | 0.3 |
| psyllium | 0.4 | 0.4 | 0.5 | 0.2 |
| aroma | 3.2 | 3.2 | 3.8 | 1.7 |
| water | 0 | 100 | 0.0 | 54.5 |
| TOTAL | 83.5 | 183.5 | 100 | 100 |

83.5 gram of the premix (according to the proportions explained in table 11), comprising the pea protein (crushed Nutralys T70S), pea protein (Nutralys TP-C) TVP, palm stearin, pea protein isolate, protein/oil encapsulated MC in accordance to Example 16, apple fibre (Herbacel AQ Plus), micronized oat bran, shitake powder, potato starch, buffered vinegar powder, tomato powder, tomato paste powder, herbal mixture (oregano, paprika, basilica, ransom), salt, onion powder, barley malt extract, psyllium and aroma (I) is hand force mixed with 100 gram cold water (>0° C.<5° C.) into a ready-to-cook paste (II) foodstuff mixtures. This wet product has the appeal of a fleshy textured food product.

The wet food product (is instantly (without incubation at a low temperature (for instance <4° C.)) cooked in a pan on an induction cooker. The cooked fleshy textured food product have a cooked meat appeal based on springiness, tenderness and chewiness.

### Example 18: The Methylcellulose in a Coconut Oil, Canola Oil Mix & Protein (Soy Protein Isolated) Encapsulating Premix with Natural Anti-Oxidant and Antibacterial

The encapsulated methylcellulose: Mixture A: 210 gram of coconut (Upfield Europe BV) with 210 gram of canola oil (Vandemoortele NV) is melted at 65° C., into a liquid mixture and 104 gram of methylcellulose (25% MC 100TS (Shinetsu) & 75% MC 4,000 (Shinetsu) is mixed in therein (Thermomix TM6 (Vorwerk Wuppertal, Germany) at speed 2,200 rotations per minute). Mixture B: 100 gram of soy protein isolate (Holland & Barrett) is mixed in 600 gram water with pH 7 at 65° C. (Thermomix TM6 (Vorwerk Wuppertal, Germany) Speed 5=2,000 rotations per minute) and kept while mixing for 120 min. at 65° C. (Thermomix TM6 (Vorwerk Wuppertal, Germany) at speed 2=200 rotations per minute). Mixture A and Mixture B and with hydro-alcoholic extract prepared from pomegranate (anar dana ((TRS Wholesale Co. LTD))) at 1 gram, grape seed (Holland & Barret) at 1 gram, hibiscus flower (Simon Lévelt) at 2 gram, apple peel (Boskoop) at 6 gram and unripe grape extract (Namazi Trading) at 1 gram are joined and mixed at 90° C., for 20 min. This mixture is frozen, freeze dried (Freeze dryer HarvestRight. U.S.A.) and dry grinded in a Thermomix TM6 (Vorwerk Wuppertal. Germany) speed 10 (10,200 rotations per minute).

### Example 19

Food product formulation of dry premix with soy concentrate based TVP and a powder of MC encapsulated in coconut oil, canola oil mix and soy protein isolate (Example 18) as a ready-to-moist food product (I) to wet mix and hydrate food product (I) into a ready-to-cook paste (II) and cook this paste (II) into a ready-to-use end product foodstuff (III).

TABLE 12

| with MC | | | | |
|---|---|---|---|---|
| encapsulation in a dry | | | | |
| encapsulated of coconut | gram | gram | % of the | % of the |
| oil, canola oil & soy | in dry | in wet | dry premix | wet paste |
| protein isolate matrix | premix | paste | composition | composition |
| soy concentrate texturate | 40 | 40 | 51.4 | 21.29 |
| (Soprotex-N, Barrentz) | | | | |
| protein/oil encapsulated | 25 | 25 | 32.1 | 13.31 |
| MC (example 18) | | | | |
| corn starch | 2 | 2 | 2.6 | 1.06 |
| Buffered vinegar powder | 0.5 | 0.5 | 0.6 | 0.27 |
| (Keyser & Mackay) | | | | |
| barley malt extract | 0.3 | 0.3 | 0.4 | 0.16 |
| powder | | | | |
| beetroot ( Aromoss) | 0.4 | 0.4 | 0.5 | 0.21 |
| aroma (Firmenich) | 4 | 4 | 5.1 | 2.13 |
| citrus fibre (Kelco) | 0.3 | 0.3 | 0.4 | 0.16 |
| beta-carotene and | 0.08 | 0.08 | 0.1 | 0.04 |
| lycopene (San-Ei Gen) | | | | |
| salt | 1.3 | 1.3 | 1.7 | 0.69 |
| palm stearin | 4 | 4 | 5.1 | 2.13 |
| water | 0 | 110 | 0.0 | 58.55 |
| TOTAL | 77.88 | 187.88 | 100 | 100 |

77.38 gram of the premix (according to the proportions explained in table 12), comprising soy concentrate texture (Soprotex-N, Barrentz), protein/oil encapsulated MC, corn starch, vinegar powder (Keyser & Mackay), barley malt extract powder, beetroot (Aromoss), aroma (Firmenich), citrus fibre (Kelco), beta-carotene and lycopene (San-Ei Gen), salt and palm stearin, protein/oil encapsulated MC with natural antioxidant and preservative in accordance to Example 18, (I) is hand force mixed with 110 gram cold water (>0° C.<5° C.) into a ready-to-cook paste (II) foodstuff mixtures. This wet product has the appeal of a fleshy textured food product.

The wet food product (is instantly (without incubation at a low temperature (for instance <4° C.)) cooked in a pan on an induction cooker. The cooked fleshy textured food product have a cooked meat appeal based on springiness, tenderness and chewiness.

### Example 20: The Methylcellulose in a Palm Oil (BioToday-Upfield Europe BV) & Pea Protein Encapsulated Premix with Natural Anti-Oxidant and Antibacterial

The encapsulated methylcellulose: Mixture A: 420 gram of palm oil (Upfield Europe BV) is melted at 65° C., into a liquid mixture and 104 gram of methylcellulose (25% MC 100TS (Shinetsu) & 75% MC 4,000 (Shinetsu) is mixed in therein (Thermomix TM6 (Vorwerk Wuppertal, Germany) at speed 2,200 rotations per minute). Mixture B: 100 gram of pea protein isolate (Holland & Barrett) is mixed in 600 gram water with pH 7 at 65° C. (Thermomix TM6 (Vorwerk Wuppertal, Germany) Speed 5=2,000 rotations per minute) and kept while mixing for 120 min. at 65° C. (Thermomix TM6 (Vorwerk Wuppertal, Germany) at speed 2=200 rotations per minute). Mixture A and Mixture B and with hydro-alcoholic extract prepared from pomegranate (anar dana ((TRS Wholesale Co. LTD))) at 1 gram, from rosemary at 1 gram and from apple peel (Pink Lady) at 6 gram are joined and mixed at 90° C., for 20 min. This mixture is frozen, freeze dried (Freeze dryer HarvestRight. U.S.A.) and dry grinded in a Thermomix TM6 (Vorwerk Wuppertal, Germany) speed 10 (10,200 rotations per minute).

### Example 21

Food product formulation of dry premix with grounded freeze dried steamed Atlantic and baked Atlantic salmon and a powder of MC encapsulated in palm oil and pea protein isolate with natural antioxidants and antibacterial (Example 20) (as a ready-to-moist food product (I) to wet mix and hydrate food product (I) into a ready-to-cook paste (II) and cook this paste (II) into a ready-to-use end product foodstuff (III).

TABLE 12

| with MC encapsulation | | | | |
|---|---|---|---|---|
| in a dry matrix of palm | | | | |
| oil, pea protein isolate & | | | | |
| comprising antioxidants | gram | gram | % of the | % of the |
| and antibacterial | in dry | in wet | dry premix | wet paste |
| (Example 20) | premix | paste | composition | composition |
| Dried steamed salmon | 20 | 20 | 26.8 | 10.3 |
| (Salmo salar) | | | | |
| Dried baked salmon | 25 | 25 | 33.5 | 12.8 |
| (Salmo salar) | | | | |
| Protein/oil encapsulated | 25 | 25 | 33.5 | 12.8 |
| MC (Example 20) | | | | |
| beta-carotene and | 0.08 | 0.08 | 0.1 | 0.04 |
| lycopene (San-Ei Gen) | | | | |
| dried citrus juice | 0.25 | 0.25 | 0.3 | 0.13 |
| vesicles | | | | |
| pea fibre | 1.5 | 1.5 | 2.0 | 0.8 |
| ascorbic acid | 0.04 | 0.04 | 0.1 | 0.02 |
| salt | 0.9 | 0.9 | 1.2 | 0.5 |
| dille | 0.3 | 0.3 | 0.4 | 0.2 |
| pea starch | 1 | 1 | 1.3 | 0.5 |
| psyllium | 0.44 | 0.44 | 0.6 | 0.2 |
| citrus fibre | 0.22 | 0.22 | 0.3 | 0.1 |
| water | 0 | 120 | 0.0 | 61.6 |
| TOTAL | 74.73 | 194.73 | 100 | 100 |

Atlantic salmon (Salmo salar) each time two steaks are in placed a Varoma dish base of a Thermomix® TM6 (Vorwerk Wuppertal. Germany) and steamed during 20 minutes by the Thermomix with 500 grams of water in its bowl on Varoma temp for 20 minutes speed 3-4 and Atlantic salmon (Salmo salar) each time 4 fillets are baked in a pan on an induction heat plate at moderate heating during 8 minutes b. The produce is consequently frozen and freeze-dried in a freeze dryer (HarvestRight. U.S.A.). 74.73 gram of the premix (according to the proportions explained in table 12), comprising shredded freeze dried baked salmon, shredded freeze chopped freeze dried steamed salmon, beta-carotene and lycopene (San-Ei Gen), dried citrus juice vesicles, pea fibre, ascorbic acid, salt, dill, pea starch, psyllium, citrus fibre and protein/oil encapsulated MC with natural antioxidant and preservative in accordance to Example 20. (I) is hand force mixed with 110 gram cold water (>0° C.<5° C.) into a ready-to-cook paste (II) foodstuff mixtures. This wet product has the appeal of a fleshy textured food product.

The wet food product is instantly (without incubation at a low temperature (for instance <4° C.)) cooked in a pan on an induction cooker. The cooked fleshy textured food product have a cooked produce with a springiness, tenderness and chewiness that provides the mouth feel of a fish like textured food.

### Example 22: Powder of Natural (Spice or her Extracts) Anti-Oxidants and Preservatives

Hydro-ethanoic extract from spice, herb and fruit parts are obtained by extraction methods adapted from the state of the art.

In some of the examples of present application hydro-ethanoic extract from air-dried and powdered (by a high-speed household blender) oregano. Origanum vulgare ssp. Hirtum, and rosemary, Rosmarinus officinalis, (food herbal oregano and rosemary (Rosmarinus officinalis) from a local commercial (retail, Belgium, Leuven) is used. Firstly, the essential oils and a hydrolate fraction (hydrosol or floral water) is removed from food herbal source dried oregano (Origanum vulgare ssp. hirtum) and from dried rosemary (Rosmarinus officinalis). Therefor each of this dry matters (dry leaves) is subjected to water-steam distillation for 6 h. so as to remove the essential oil (in lab essential oil steam distillation borosilicate glassware with Graham condenser. 2 neck boiling flask on an heating plate and filling Flask). The wet herbal residue is dried in a ventilated oven at 35° C., for 24 h and ground into a powder (<500 μm particles) by an high-speed household blender. A sample (Sample A) of dry material of each oregano and rosemary is packed in the thimble of a Soxhlet and extracted at 60° C. during 100 min with the solvent (ethanol:distilled water:60:40, v/v) and at a solid to solid-to-liquid ratio of 1:10. The isolate is filtered through large Whatman filter paper No. 41. Then another filtration through Whatman filter paper No. 42 is accomplished for removing any particles and the solvent is removed by reduced pressure rotary evaporator at 40-45° C. The aqueous extract is freeze dried (Freeze dryer HarvestRight. U.S.A.). These dry extracts are used in the methylcellulose in an oil—protein matrix encapsulation process.

In some of the examples of present application extract from cloves (Syzygium aromaticum) grounded by a high-speed household coffee bean grinder are used. The clove applied in this study are from a regional commercial source (retail. Belgium. Leuven). The powders are added to distilled water keeping at 1:5 (w/v) ratio and shifted at 90° C., for 6 h to be extraction of clove. Moreover, the residual extractions are carried out using distilled water in the proportion of 1:5 at 90° C., for 12 h. These two parts of extraction are merged after cooling at ambient temperature, and the aquatic solution is filtered filtered through large Whatman filter paper No. 41. Then another filtration through Whatman filter paper No. 42 is accomplished for removing any particles. Then, the filtered solution is concentrated utilizing a vacuity-rotated evaporator at 90° C. The concentrated cloves extract freeze-dried. An extraction solvent (25% v/v ethanol/water) is poured into the solvent reservoir of an espresso machine and the machine is warmed to its operating temperature (90-95° C.). The mixture of ground cloves and sand is packed into the portafilter using a coffee tamper. The portafilter is fitted to the espresso machine, and the solvent is passed through the sample (˜100 mL) and collected in a 250 ml beaker. After 0.5 min, more solvent is passed through the sample (˜100 mL) and collected (˜200 mL total extract volume). The ethanol is reduced by pressure rotary evaporator at 50° C. (Jeremy Just, et al. J. Chem. Educ. 2016, 93, 213 216). This dry extract is used in a methylcellulose in an oil-protein matrix encapsulation process at a dose of about 50 ppm.

In some of the examples of present application extract from dried apple peel are used in the food forms. These, are from (Boskoop (goudrenet) or Pink Lady from bioculture, a local commercial source (retail. Leuven. Belgium). Apple peel is first removed manually and immediately boiled for 30 s to inactivate polyphenol oxidase activity. The apple peels are freeze dried (Freeze dryer HarvestRight. U.S.A.) and ground in a high-speed household blender. The apple peel powder is set in the maceration at a 1:10 ratio of aqueous ethanol (70%) and distilled water for 3×24 hours (the second and the third time the residue soaked again with the same liquid) with and the extraction process stirring 3 times a day, through large Whatman filter paper No. 41. Then another filtration through Whatman filter paper No. 42 is accomplished for removing any particles and the solvent is removed by reduced pressure rotary evaporator at 40-45° C. The concentrated extract is evaporated under vacuum at 50° C., in order to dry completely. This dry extract is used in the methylcellulose in an oil-protein matrix encapsulation process.

In some of the examples of present application hydroalcoholic extract from ground anardana, pomegranate seeds (TRS Wholesale Co. LTD) or from ground grape seeds (Holland & Barrett grape seed flour or from ground unripe grape flour (NamaziTrading) are used in the food forms. The ground product are each macerated in 70% ethanol for 72 hours at room temperature. The prepared extract is filtered through large Whatman paper No. 41. Then another filtration through Whatman paper NO. 42 is accomplished for removing any particles. The ethanol extract is removed by pressure rotary evaporator at 50° C. until a dry powder is obtained. This dry extract is used in the methylcellulose in an oil-protein matrix encapsulation process.

In some of the examples of present application hydroalcoholic extract from hibiscus-dried flowers (Simon Lévelt) used in the food forms. Dried flowers (Simon Lévelt) are macerated a 1:10 ratio overnight in 95% alcohol at room temperature. The prepared extract is filtered through large Whatman paper No. 41. Then another filtration through Whatman paper NO. 42 is accomplished for removing any particles. The residue soaked again with the same liquid. The ethanol extract is removed by pressure rotary evaporator at 50° C. yielding a reddish brown semi-solid. This dry extract is used in the methylcellulose in an oil-protein matrix encapsulation process.

### Example 23: Encapsulated Blend of Methylcellulose with Different Viscosity (mPas)—Comparative Examples

Methylcellulose encapsulation: Mixture A: The encapsulated methylcellulose: 420 gram of canola oil (Vandemoortele NV. Belgium) is heated 65° C., with 104 gram of methylcellulose (for test 11 (25% MC 100TS (Shinetsu) & 75% MC 4,000 (Shinetsu), for test 12,100% MC 100TS and for test 13,100% MC 4,000 (Shinetsu)) is mixed in therein (Thermomix TM6 (Vorwerk Wuppertal. Germany) at speed 2,200 rotations per minute). Mixture B: 100 gram of soy protein isolate (Holland & Barrett) is mixed in 600 gram water with pH 7 at 65° C. (Thermomix TM6 (Vorwerk Wuppertal. Germany) Speed 5=2,000 rotations per minute) and kept while mixing for 120 min. at 65° C. (Thermomix TM6 (Vorwerk Wuppertal. Germany) at speed 2=200 rotations per minute). Mixture A and Mixture B are joined and mixed at 90° C., for 20 min. This mixture is frozen, freeze dried (Freeze dryer HarvestRight. U.S.A.) and dry grinded in a Thermomix TM6 (Vorwerk Wuppertal. Germany) speed 10 (10,200 rotations per minute).

The microcapsules of each test group are blended each in a dry end formulation mixtures composed of 23.1% microcapsules, 5.8% soy protein isolate, 3.8% potato starch, 1.9% tapioca starch, 1.9% apple fibre and a dry mixture of each test group 36.5% is mixed with 63.5% water (of 5° C.) to be cooked after 30 minutes incubation in a kitchen refrigerator.

For the texture testing of the cooked end product with dimensions of 4 cm diameter and 2 cm thickness a Lloyd Instruments/Ametek LS1 is used with 116 mm diameter aluminium compression plate fixed on the load cell and a base table. The to be tested sample is pressed between the compression plate and the base table and variable parameters are measured and analysed using the Nexygen+4.1. software package.

The results are demonstrated in the FIGS. 5a to 5f and explained in the legend to the figures. Briefly the blend of methylcellulose with different 2% aqueous viscosity at 20° C. (mPas) more particularly of methylcellulose with a 2% aqueous viscosity at 20° C. of 82,500-154,000 mPas with another methylcellulose with a 2% aqueous viscosity at 20° C. of 3,000-5,600 mPas provided the best texture in terms of Hardness1. Hardness2. Chewiness. Cohesiveness. Resilience and Springiness.

### Example 24: Comparison of Encapsulated and not Encapsulated Methylcellulose

The methylcellulose encapsulation protocol and the dry nutrient mixture for mixing with water. 30 minutes cool (refrigerator) incubation and instant cooking used in this example is described in example 23. This example 24 compares the encapsulated 25% MC 100TS/75% MC 4,000 methylcellulose mixture with a not encapsulated 25% MC 100TS/75% MC 4,000 methylcellulose mixture. The results are demonstrated in the FIGS. 6a to 6f and explained in the legend to the figures. Briefly encapsulated methylcellulose provided the best Hardness1. Hardness2. Chewiness resembling a better flesh like texture when the nutrient mixture after mixing in water of 5° C., and 30 minutes cooled incubated (refrigerated) were instantly cooked.

### Example 25: Comparison of Encapsulated and not Encapsulated Methylcellulose, but without 30 Minutes Cooled Incubation of the Wetted Mixture and Instantly Cooked after Mixing with Water

The methylcellulose encapsulation protocol and the dry nutrient mixture for mixing with water were that of example 23. But after mixing with water there is no cooled incubation step. Instant the wet mixture is instantly cooked and analysed for texture. This example compares the encapsulated 25% MC 100TS/75% MC 4,000 methylcellulose mixture with a not encapsulated 25% MC 100TS/75% MC 4,000 methylcellulose mixture. The results are demonstrated in the FIGS. 7a to 7f and explained in the legend to the figures. Briefly encapsulated methylcellulose provided the best Hardness1. Hardness2. Chewiness resembling a better flesh like texture when the nutrient mixture after mixing in water and were instantly cooked without incubating of the wet mass.

### Example 26: Instant Dry Meat for Instant Moist Reconstitution and Cooking in a Flesh Like Food

A dry food composition, for instance a dry food mix, comprising capsule particles encapsulating a composition containing methylcellulose (encapsulated methylcellulose) and dried or dry meat particulate solid matter (in mixed dry powder or lager dry solid in subdivided state) is made for reconstitution into a flesh like textured food characterised in that the dry food composition comprises. The dry meat particulate solid matter is made by freeze drying beef (Belgian Blue Steak (Carrefour) and grinding the solid dry mass in a dry mass in subdivided state. The encapsulated methylcellulose is made by the following procedure: Methylcellulose encapsulation: Mixture A: The encapsulated methylcellulose: 420 gram of canola oil (Vandemoortele NV. Belgium) heated 65° C., with 104 gram of methylcellulose (25% MC 100TS (Shinetsu) & 75% MC 4,000 (Shinetsu)) is mixed in therein (Thermomix TM6 (Vorwerk Wuppertal. Germany) at speed 2,200 rotations per minute). Mixture B: 100 gram of soy protein isolate (Holland & Barrett) is mixed in 600 gram water with pH 7 at 65° C. (Thermomix TM6 (Vorwerk Wuppertal. Germany) Speed 5=2,000 rotations per minute) and kept while mixing for 120 min. at 65° C. (Thermomix TM6 (Vorwerk Wuppertal. Germany) at speed 2=200 rotations per minute). Mixture A and Mixture B are joined and mixed at 90° C., for 20 min. This mixture is frozen, freeze dried (Freeze dryer HarvestRight. U.S.A.) and dry grinded in a Thermomix TM6 (Vorwerk Wuppertal. Germany) speed 10 (10,200 rotations per minute).

The dry food composition comprises 32.4% encapsulated methylcellulose (25% MC 100TS (Shinetsu) & 75% MC 4,000 (Shinetsu)). 63.3% of the dry meat particulate solid matter. 1.27% kitchen salt (NaCl). 1.27% pea starch. 0.51% psyllium. 0.25% citrus fibres. 1% pea fibres. A 30.5% dry matter is mixed with 69.5% cold water (>0° C.<5° C.). The wet food product is instantly (without pre-incubation at a low temperature (for instance <4° C.)) cooked in a pan on an induction cooker. The cooked fleshy textured food product have a cooked meat appeal as confirmed by human panel testing and a flesh like texture, in terms of Hardness1. Hardness2. Cohesiveness, Chewiness. Resilience and Springiness as confirmed by texture analysis (e.g. Lloyd Instruments/Ametek LS1 Texture Analyser & Nexygen+4.1. software package).

A cooked end product with dimensions of 4 cm diameter and 2 cm thickness by the a Lloyd Instruments/Ametek LS1 is used with 116 mm diameter aluminium compression plate fixed on the load cell and a base table with processing of the variable parameters measured by the Nexygen+4.1. software package (the texture analyser).

As for the other test by the texture analyser parameters measures are of the groups consisting of Hardness1, Hardness2, Cohesiveness, Chewiness, Resilience and Springiness.

The average texture analyser parameters, measured on twelve (12) instantly moistened and instantly cooked samples are Hardness1 (186±21). Hardness2 (156±20). Cohesiveness (0.416±0.027). Chewiness (44.1±10.1). Resilience (0.502±0.029) and Springiness (˜3.21±0.358).

### Example 27: Instant Dry Fish for Instant Moist Reconstitution and Cooking in a Flesh Like Food

A dry food mix is prepared the dry food mix comprises 1) capsule particles encapsulating a composition containing methylcellulose (encapsulated methylcellulose) and 2) a dry fish particulate solid matter (in both dry powder and lager dry solid in subdivided state). It is tested for reconstitution into a flesh like textured food by mixing it with cold water (>0° C.<5° C.). The dry fish particulate solid matter is made by freeze drying steelhead salmon fillet and grinding the solid dry mass in a dry mass in the mixed subdivided state and powder state.

The encapsulated methylcellulose is made by the following procedure: Methylcellulose encapsulation: Mixture A: The encapsulated methylcellulose: 420 gram of canola oil (Vandemoortele NV, Belgium) is heated 65° C., with 106 gram of methylcellulose (25% MC 100TS (Shinetsu) & 75% MC 4,000 (Shinetsu)) is mixed in therein (Thermomix TM6 (Vorwerk Wuppertal. Germany) at speed 2,200 rotations per minute). Mixture B: 105 gram of soy protein isolate (Holland & Barrett) is mixed in 600 gram water with pH 7 at 65° C. (Thermomix TM6 (Vonverk Wuppertal. Germany) Speed 5=2,000 rotations per minute) and kept while mixing for 120 min. at 65° C. (Thermomix TM6 (Vorwerk Wuppertal. Germany) at speed 2=200 rotations per minute). Mixture A and Mixture B are joined and mixed at 90° C., for 20 min. This mixture is frozen, freeze dried (Freeze dryer HarvestRight. U.S.A.) and dry grinded in a Thermomix TM6 (Vorwerk Wuppertal. Germany) speed 10 (10,200 rotations per minute).

The dry food composition comprises 32.2% encapsulated methylcellulose. 63% of the dry fish particulate solid matter, 1.26% kitchen salt (NaCl), 1.26% astaxanthin powder, 0.5% dille, 0.5% psyllium, 0.25% citrus fibres, 1% pea fibres, 1.26% pea starch. A 25% dry matter is mixed with 75% cold water (>0° C.<5° C.). The wet food product (is instantly (without incubation at a low temperature (for instance <4° C.)) cooked in a pan on an induction cooker. The cooked fleshy textured food product have a cooked fish appeal as confirmed by human panel testing and a flesh like texture, in terms of Hardness1. Hardness2, Cohesiveness, Chewiness. Resilience and Springiness as confirmed by texture analysis (e.g. Lloyd Instruments/Ametek LS1 Texture Analyser & Nexygen+4.1. software package).

A cooked end product with dimensions of 4 cm diameter and 2 cm thickness by the a Lloyd Instruments/Ametek LS1 is used with 116 mm diameter aluminium compression plate fixed on the load cell and a base table with processing of the variable parameters measured by the Nexygen+4.1. software package (the texture analyser).

As for the other test by the texture analyser parameters measures are of the groups consisting of Hardness1. Hardness2, Cohesiveness, Chewiness. Resilience and Springiness.

The average texture analyser parameters, measured on eleven (11) instantly moistened and instantly cooked samples are Hardness1 (138.70±10.79), Hardness2 (115.43±8.69), Cohesiveness (0.384±0.016). Chewiness (24.658±3.481), Resilience (0.417±0.024) and Springiness (−3.360±0.248).

### Example 28: Statistical Analysis of the Data

All data is analyzed in R. Using an ANOVA test it is shown there are significant differences between the means of the measured parameters (hardness 1, hardness 2, cohesiveness, springiness, chewiness and resilience) in the products analyzed. Subsequently a Tuckey multiple comparison test determined which means differ. The differences between means are indicated in the figures by a letter. Means with different letters are significantly different.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 provides photos of the wet food product prepared by the dry foodstuff mixture of example 5

FIG. 2. provides photos of the wet food product prepared by the dry foodstuff mixture of example 5 cooked into a flesh like textured food. One-half of the wet food product (FIG. 1) is instantly (without incubation at a low temperature (for instance <4° C.)) cooked in a pan on an induction cooker. (FIGS. 2a & b). The cooked fleshy textured food product have a cooked meat appeal based on springiness, tenderness and chewiness. The other half of the wet ready-to-cook food product is incubated for 2 hours in a refrigerator (<4° C.)) and thereafter cooked in a pan on an induction cooker. This slightly improved the cooked meat appeal based on springiness, tenderness, chewiness and juiciness. This simple composition of protein, oil, water had surprisingly a remarkable cohesion and stability during the baking process, After baking, a proteinaceous flesh like textured food was obtained with a flesh like texture in terms of springiness, tenderness, chewiness and juiciness.

FIG. 3 provides photos with images of an hopper assembly FIG. 3A is a side view and FIG. 3B is a side view with the sealing lid [15], the auger element on axle member [9] and the output funnel [13] removed from the hopper assembly. FIG. 3C shows a top view and FIG. 3E a bottom view with the housing for the auger element on axle member [9]. FIG. 3D shows the coupling member. Date of the invention it became clear that a hopper assembly can host or store the instant dry food of present invention and if functionally connected by the coupling member of the axle member [9] to a motor or motor unit can delivery measured portion of the instant dry food of present invention to a target unit. Preferably such hopper if filled with instant dry food of present invention is functionally integrated in a vending machine and kept under cooling for instance at 4° C. An additionally hopper assembly can also be used to host or store particles, chunks or bits of dry curd solid and if functionally connected by the coupling member of the axle member [9] to a motor or motor unit can delivery measured portion of such curd solids to the target unit. An additionally hopper assembly can also be used to host or store other dry foodstuff in the form of powder, particles, chunks or bits and if functionally connected by the coupling member of the axle member [9] to a motor or motor unit can delivery measured portion of such curd solids to the target unit. The exemplary hopper assembly shown in FIG. 3, comprises a scalable opening on top that is scalable by a lit [15]. It has a back (on picture) wall and a front (on picture-wall [14]. The left (on picture) side wall [2] and right (on picture) sidewall [3] forms a lower funnel shaped portion on the hopper assembly. Of the left (on picture) side wall [2] and right (on picture) side wall [3], the lower section of the left (on picture) side wall [2b] and right (on picture) side wall [3b] slope inwards so that hopper assembly container funnels into the housing [10]. One end of each auger element is secured to an axle member [9] seated for rotary motion within a bushing [7]. A bushing [7] is positioned within an opening in end wall [6a] of housing [10]. A coupling member [8] attached to the end of axle member [9] is adapted to be operatively connected to a motor.

FIG. 4 provides a schema with photos that displays the operation of instantly moistening, hand force mixing and cooking a dry premix for extended fish products, the foodstuff composition of the examples 20 and 21. In addition, it displays the cooking thereof with oil in pan baking process at a mild heat and a sandwiching double grill in a microwave (for 3.5 minutes at 900 Watt).

FIG. 5(a-f) is a graphic display which compares texture parameters (Hardness1 (FIG. 5a). Hardness2 (FIG. 5b). Chewiness (FIG. 5c). Cohesiveness (FIG. 5d). Resilience (FIG. 5e) and Springiness (FIG. 5f) of a cooked end product with dimensions of 4 cm diameter and 2 cm thickness by the a Lloyd Instruments/Ametek LS1 is used with 116 mm diameter aluminium compression plate fixed on the load cell and a base table with processing of the variable parameters measured by the Nexygen+4.1. software package. All dry samples were after moistening by the same amount of cold water (<5° C.) and mixing (Example 23) incubated for 30 minutes in a kitchen refrigerator and consequently cooked before texture analysing. The comparative samples concerns the formulated samples in accordance with Example 23, whereby the only difference is that for test 11 an encapsulated methylcellulose mixture of 25% methylcellulose with a 2% aqueous viscosity at 20° C. of 82,500-154,000 mPas (MC 100TS (Shinetsu)) & 75% methylcellulose with a 2% aqueous viscosity at 20° C. of 3,000-5,600 mPas (MC 4,000) (Shinetsu)) has been used, for test 12,100% MC 100TS (Shinetsu) has been used and for test 13,100% of MC 4,000 (Shinetsu)) has been used. In the comparison of the 3 methylcellulose test groups, when mixed with the same food ingredient mixture and water amount, cooled for 30 minutes and cooked, the encapsulated mixture of methylcellulose with different level of aqueous viscosity. 25% MC 100TS/75% MC 4,000. (Test 11) provided a significant better hardness 1 (FIG. 5a), hardness 2 (FIG. 5b) than the encapsulated MC 4,000 or encapsulated MC 100TS. The encapsulated mixture of methylcellulose with different level of aqueous viscosity. 25% MC 100TS/75% MC 4,000. (Test 11) provided a significant better chewiness, cohesiveness and resilience than encapsulated MC 100TS. Overall encapsulating a mixture of high aqueous viscosity methylcellulose with low aqueous viscosity methylcellulose in a dry nutrients mixture for instant mixing with water and cooking provided the best flesh like food.

FIG. 6(a-c) is a graphic display which compares texture parameters (Hardness1 (FIG. 6a). Hardness2 (FIG. 6a). Chewiness (FIG. 6c). Cohesiveness (FIG. 6d). Resilience (FIG. 6e) and Springiness (FIG. 6f) of a cooked end product with dimensions of 4 cm diameter and 2 cm thickness a Lloyd Instruments/Ametek LS1 is used with 116 mm diameter aluminium compression plate fixed on the load cell and a base table with processing of the variable parameters measured by the Nexygen+4.1. software package. It demonstrates differences between of encapsulated methylcellulose mixture (25% MC 100TS/75% MC 4,000), and not encapsulated methylcellulose mixture (25% MC 100TS/75% MC 4,000) integrated in a dry nutrient mixture (that of example 23) for mixing with water, cooled (refrigerator at <4° C.) incubation for 30 minutes and consequently instant cooking. The encapsulated (example 23 protocol) methylcellulose mixture (test 11) resembled a better flesh like texture and provided a significant better (Hardness1 (FIG. 6a), Hardness2 (FIG. 6a), Chewiness (FIG. 6c) than the not encapsulated methylcellulose mixture (test 15).

FIG. 7(a-e) is a graphic display which compares texture parameters (Hardness1 (FIG. 7a), Hardness2 (FIG. 7a), Chewiness (FIG. 7c), Cohesiveness (FIG. 7d), Resilience (FIG. 7e) and Springiness (FIG. 7f) of a cooked end product with dimensions of 4 cm diameter and 2 cm thickness by the a Lloyd Instruments/Ametek LS1 is used with 116 mm diameter aluminium compression plate fixed on the load cell and a base table with processing of the variable parameters measured by the Nexygen+4.1. software package. It demonstrates differences between of encapsulated methylcellulose mixture (25% MC 100TS/75% MC 4,000), and not encapsulated methylcellulose mixture (25% MC 100TS/75% MC 4,000) integrated in a dry nutrient mixture (that of example 23) for mixing with water, and instant cooking, without any wet mass incubation phase. The encapsulated (example 23 protocol) methylcellulose mixture (test 11) resembled a better flesh like texture and provided a significant better (Hardness1 (FIG. 7a), Hardness2 (FIG. 7a), Chewiness (FIG. 7c), Cohesiveness (FIG. 7d) and Resilience (FIG. 7e) than the not encapsulated methylcellulose mixture (test 15).

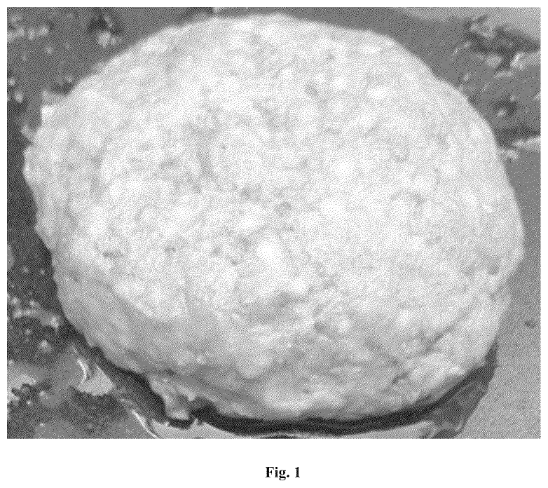

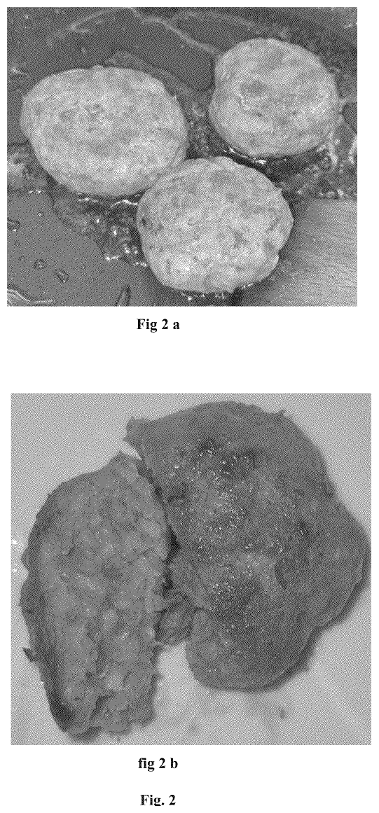

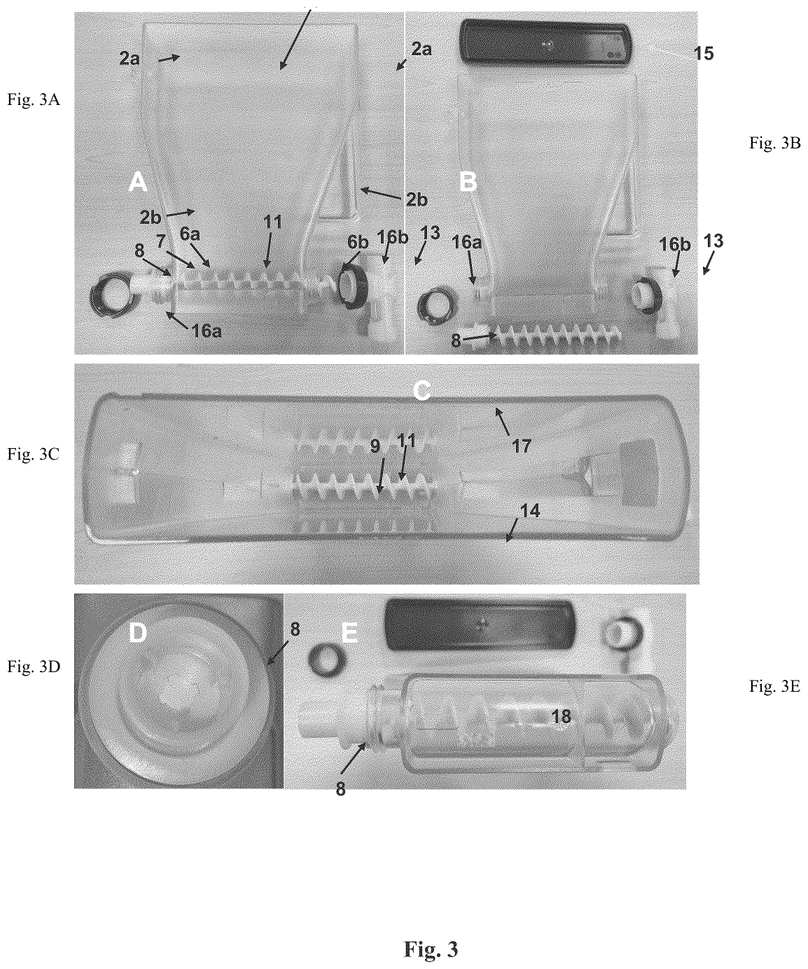

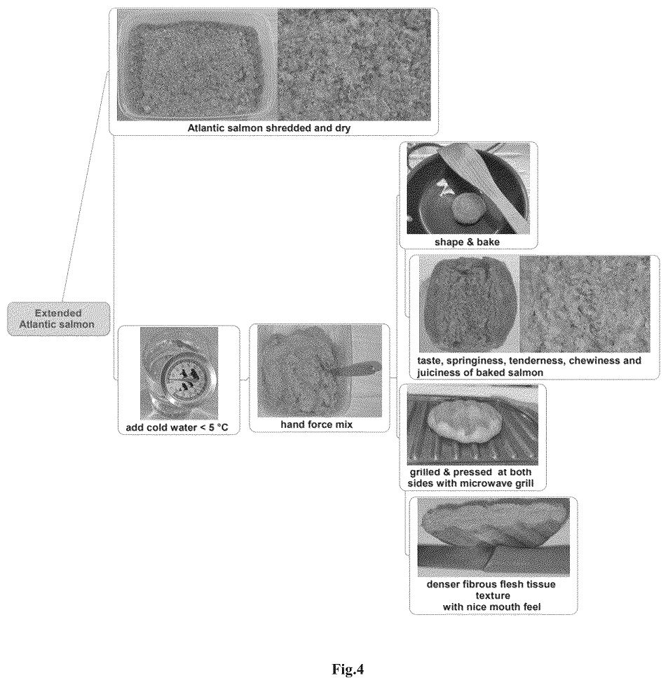

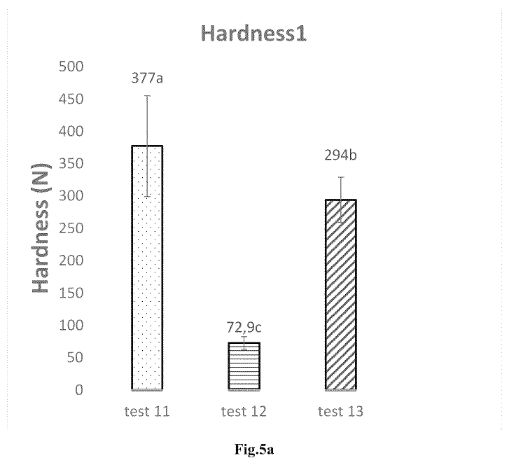

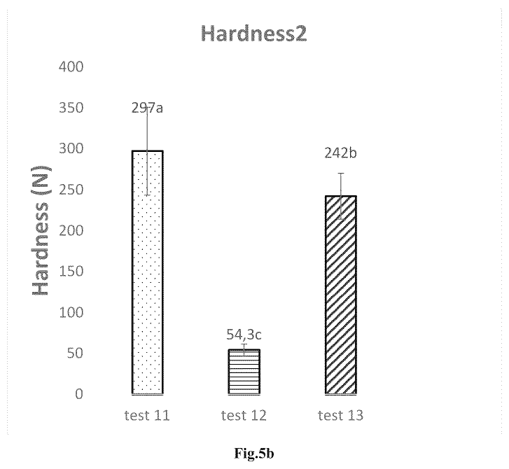

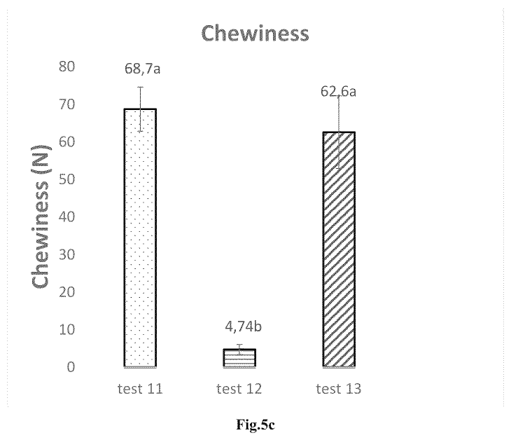

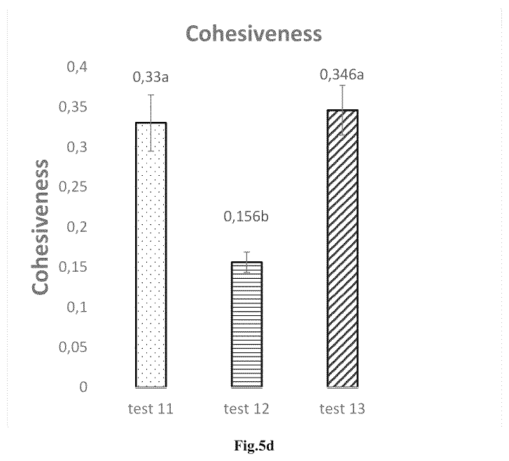

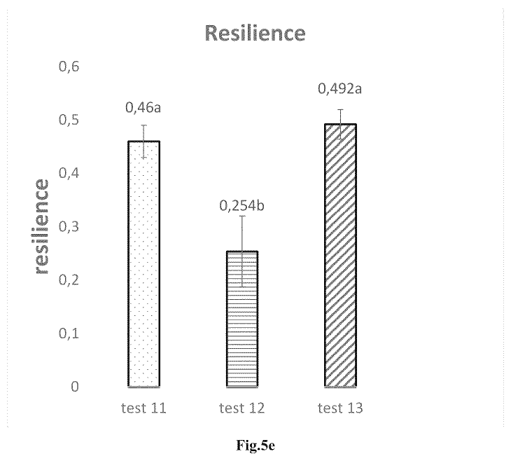

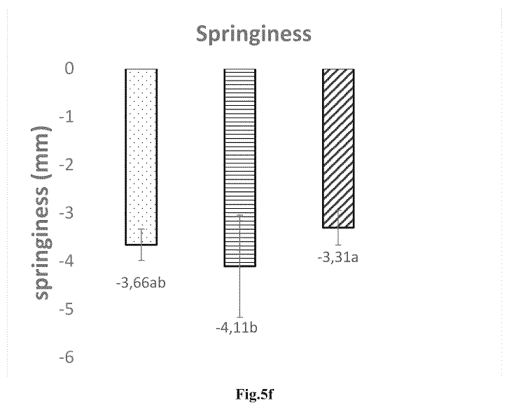

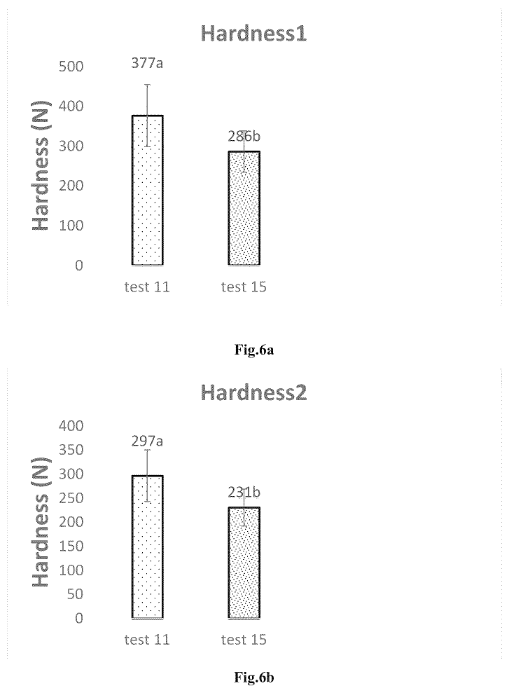

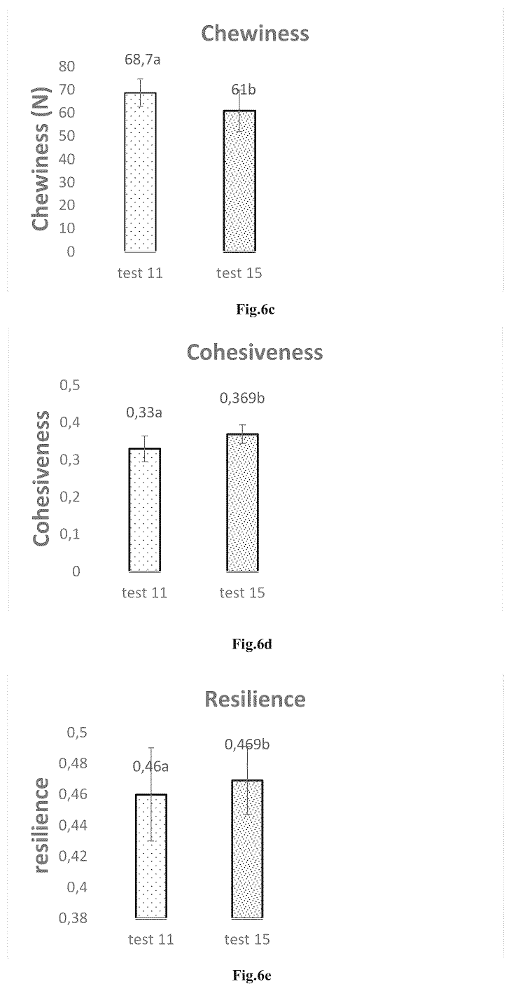

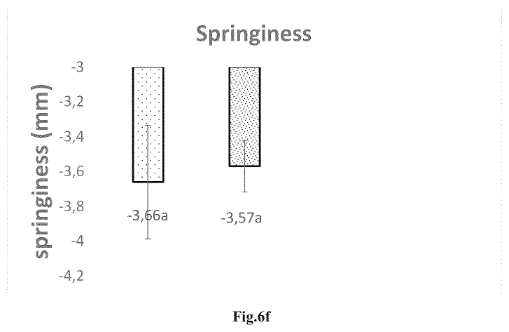

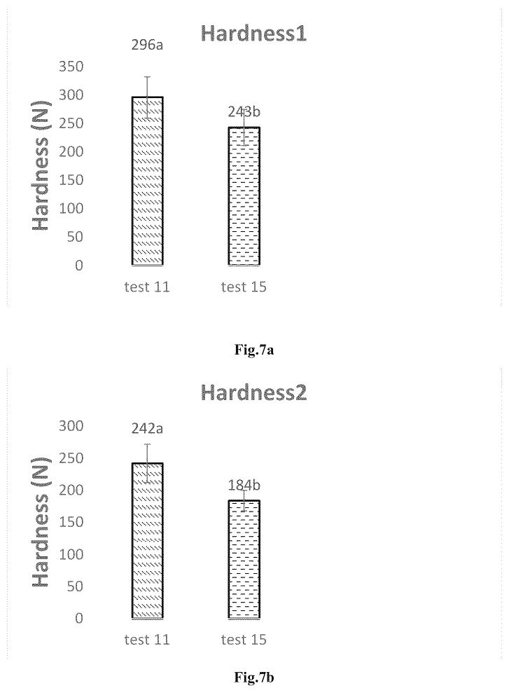

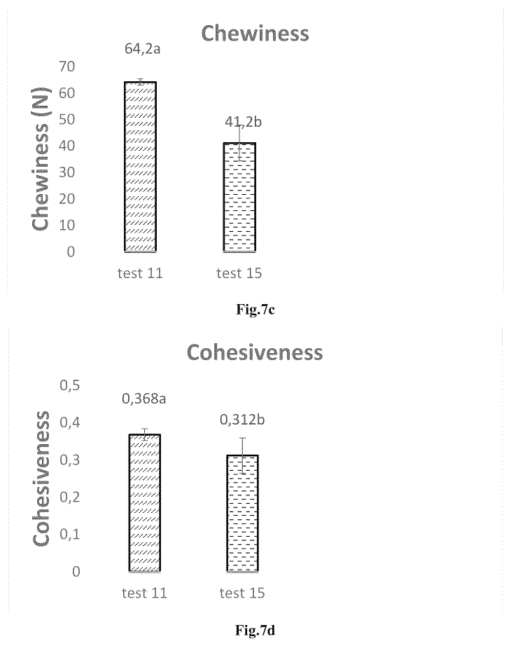

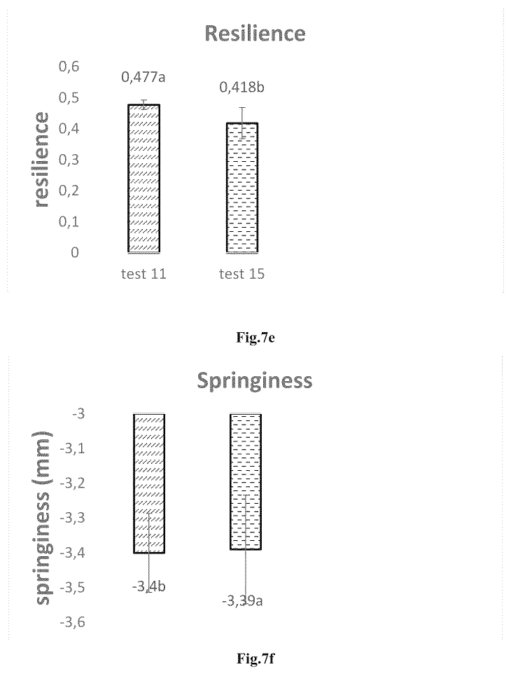

1.-62. (canceled)

63. A dry food composition for producing a flesh like textured food, said composition comprising:
1) food and
2) from 10% wt, to 30% wt. of methylcellulose loaded particles, said particles being in the form of a dry powder that encapsulate a composition containing methylcellulose,
wherein
i) the methylcellulose in said particles is of 10 to 30 weight percent,
ii) in said particles, a substance of the group consisting of a fat, oil and butter or a mixture thereof is of 50 to 75 weight percent and
iii) in said particles a protein or a mixture of proteins is of 10-33 weight percent, wherein said food comprises any one of the groups consisting of dried grinded meat or dried grinded fish, textured vegetable protein (TVP), dry freeze thaw curd solid, dry freeze thaw alginate cured curd solid, and a dry alginate cured respiratory produce, and
wherein the food composition comprises less than 15 mass % water content.

64. The food composition according to claim 63, wherein the food composition is at least in part in powder mass form.

65. The food composition according to claim 63, wherein it is an instant food composition for producing flesh like textured food by rehydrating with cold liquid or mixed with ice particles and then cooking to create a ready-to-eat food with a texture similar to flesh.

66. The food composition according to claim 63, wherein the methylcellulose is a blend of a) a first methylcellulose with a 2% aqueous viscosity at 20° C. of 82,500-154,000 mPas and of b) a second methylcellulose with a 2% aqueous viscosity at 20° C. of 3,000-5,600 mPas.

67. The food composition according to claim 63, wherein the methylcellulose is a blend of a) a first methylcellulose with a methoxyl content in the range of 27.5-31.5% and a 2% aqueous viscosity at 20° C. of 82,500-154,000 mPas and of b) a second methylcellulose with a methoxyl content in the range of 27.5-31.5% and a 2% aqueous viscosity at 20° C. of 3,000-5,600 mPas.

68. The food composition according to claim 63, wherein the methylcellulose is a blend of a) a first methylcellulose with a hydration temperature of 0-15° C., and of b) a second methylcellulose with a hydration temperature of 15-25° C.

69. The food composition according to claim 63, wherein the methylcellulose is a blend of a) a first methylcellulose with a hydration temperature of 0-15° C., and of b) a second methylcellulose with a hydration temperature of 15-25° C.

70. The food composition according to claim 63, wherein the methylcellulose is a blend of a) a first methylcellulose with a 2% aqueous viscosity at 20° C. of 82,500-154,000 mPas and of b) a second methylcellulose with a 2% aqueous viscosity at 20° C. of 3,000-5,600 mPas, wherein in the blend the first methylcellulose is in the range of 10 to 35%, and the second methylcellulose is in the range of 65 to 85%.

71. The food composition according to claim 63, wherein the methylcellulose is a blend of a) a first methylcellulose with a methoxyl content in the range of 27.5-31.5% and a 2% aqueous viscosity at 20° C. of 82,500-154,000 mPas and of b) a second methylcellulose with a methoxyl content in the range of 27.5-31.5% and a 2% aqueous viscosity at 20° C. of 3,000-5,600 mPas, and yeh second methylcellulose is in the range of 65 to 85%.

72. The food composition according to claim 63, wherein the particles encapsulating methylcellulose further comprise an acid.

73. The food composition according to claim 63, wherein the particles encapsulating methylcellulose comprise an antioxidant.

74. The food composition according to claim 63, wherein the particles encapsulating methylcellulose comprise an antibacterial.

75. The food composition according to claim 63, wherein the particles encapsulating methylcellulose comprise an herbal extract.

76. The food composition according to claim 63, wherein the particles encapsulating methylcellulose comprise a spice extract.

77. The food composition according to claim 63, wherein the particles encapsulating methylcellulose comprise a fruit extract.

78. The food composition according to claim 63, wherein the fat, oil or butter comprises an agent selected from the list consisting of phospholipids, lecithin, monoglyceride, amphiphilic peptides, sorbitan monostearate, mono-, di- and/or triacyglycerols, fatty acids, fatty alcohol, wax, phytosterol, and/or combinations thereof.
